(19) United States
(12) Patent Application Publication
(10) Pub. No.: US 2002/0041377 A1
(43) Pub. Date: Apr. 11, 2002

(54) Aerial image measurement method and unit, optical properties measurement method and unit, adjustment method of projection optical system, exposure method and apparatus, making method of exposure apparatus, and device manufacturing method

(75) Inventors: Tsuneyuki Hagiwara, Tokyo (JP); Naoto Kondo, Tokyo (JP); Eiji Takane, Tokyo (JP); Hiromi Kuwata, Fukaya-shi (JP); Kousuke Suzuki, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Nikon Corporation, Tokyo (JP)

(21) Appl. No.: 09/841,044

(22) Filed: Apr. 25, 2001

(30) Foreign Application Priority Data
Apr. 25, 2000 (JP) 2000-123553
Jul. 18, 2000 (JP) 2000-216868
Dec. 27, 2000 (JP) 2000-398444

(51) Int. Cl. G01B 11/26

(52) U.S. Cl. 356/399

(57) ABSTRACT

The exposure apparatus comprises a mark plate on which a plurality of types of measurement marks each used for self-measurement are formed, a reticle stage on which the mark plate is mounted, and an aerial image measurement unit. On a slit plate of the aerial image measurement unit, a slit is formed extending in the non-scanning direction which width in the measurement direction is equal to and under (wavelength λ/numerical aperture N.A of the projection optical system). Therefore, in a state where a predetermined pattern is illuminated with the illumination light to form an aerial image of the pattern via the projection optical system, and when the slit plate is scanned in the measurement direction with respect to the aerial image, the light having passed through the slit during the scanning is photo-electrically converted with the photoelectric conversion element. And, based on the photoelectric conversion signal, the control unit measures the light intensity corresponding to the aerial image with a sufficiently high accuracy in practical usage. In addition, various self-measurements become possible, by moving the reticle stage so as to position the plurality of types of measurement marks respectively in the vicinity of a focal position on the object side of the projection optical system.

### BACKGROUND OF THE INVENTION

1. Field of the Invention

The present invention relates to an aerial image measurement method and unit, an optical properties measurement method and unit, an adjustment method of a projection optical system, an exposure method and apparatus, a making method of the exposure apparatus, and a device manufacturing method. More particularly, the present invention relates to an aerial image measurement method and an aerial image measurement unit that measure an aerial image formed on an image plane by a projection optical system, an optical properties measurement method and an optical properties measurement unit that measure the optical properties of the projection optical system utilizing the aerial image measurement method, an adjustment method to adjust the projection optical system based on the measurement results of the optical properties measured by the optical properties measurement method, an exposure apparatus that comprises the aerial image measurement unit and an exposure method that uses the projection optical system which optical properties is adjusted by the adjustment method, a making method of the exposure apparatus that include the process of measuring the optical properties of the projection optical system by the optical properties measurement method, and a device manufacturing method that uses the exposure apparatus.

2. Description of the Related Art

When devices such as a semiconductor device or a liquid crystal display device are conventionally manufactured in a photolithographic process, a projection exposure apparatus that transfers a pattern of a photomask or a reticle (hereinafter generally referred to as a “reticle”) onto a substrate such as a wafer on which a photosensitive agent such as a photoresist is coated on the surface via a projection optical system is used. The reduction projection exposure apparatus (generally referred to as a stepper) based on the step-and-repeat method, or the scanning projection exposure apparatus (generally referred to as a scanning stepper) based on the step-and-scan method are examples of such a projection exposure apparatus.

In the case of manufacturing devices such as a semiconductor, it is necessary to overlay and form many layers of different circuit patterns on a substrate. Therefore, it is important to precisely overlay the reticle on which the circuit pattern is drawn with the pattern already formed on each shot area of the substrate. In order to perform such a precise overlay, it is a mandatory for the image forming characteristics of the projection optical system to be adjusted to a desired state.

As a premise of adjusting the image forming characteristics of the projection optical system, the image forming characteristics have to be precisely measured. And as the measurement method of the image forming characteristics, the method is mainly used (hereinafter referred to as the “exposing method”) where exposure is performed using a reticle for measurement on which marks (mark patterns) for a predetermined measurement are formed, and the image forming characteristics is calculated based on measurement results of measuring a resist image, which is obtained by developing the substrate on which the projected image of the measurement marks is transferred and formed. Other than this method, the method to calculate the image forming characteristics based on measurement results of measuring an aerial image (projection image) of the measurement marks formed by the projection optical system by illuminating the reticle for measurement with the illumination light (hereinafter referred to as the “aerial image measurement method”) is also used.

The conventional aerial image measurement was generally performed in the following manner. That is, for example, as is shown in FIG. 45A, an opening plate 123 on which a square opening 122 is formed, is arranged on a substrate stage. The opening plate 123 is scanned via the substrate stage in the direction indicated by the arrow A, with respect to the aerial image MP′ of the measurement marks of the reticle for measurement formed by the projection optical system (not shown in FIGS.), and the illumination light which has passed through the opening 122 is photo-detected and photo-electrically converted by a photoelectric conversion element. With this photoelectric conversion, a photoelectric conversion signal (light intensity signal corresponding to the aerial image) as is shown in FIG. 45B, can be obtained. Next, by differentiating the waveform of the photoelectric conversion signal shown in FIG. 45B, a differential waveform as is shown in FIG. 45C is obtained. And, based on the differential waveform, as is shown in FIG. 45C, a well-known predetermined signal processing such as the Fourier Transform Method is performed, and the optical image (aerial image) of the projected measurement marks is obtained.

Details of such measurement of the aerial image and the detection of distortion and the like of the projection optical system based on this measurement are disclosed, for example, in Japanese Patent Laid Open (Unexamined) No. 10-209031.

With the conventional aerial image measurement method described above, however, since the aerial image intensity was measured by scanning a large opening as is shown in FIG. 45B, it turned out that a large scale of a low-frequency component was mixed with the aerial frequency component that characterizes the profile of the aerial image. On the other hand, the dynamic range of the signal processing system arranged on the latter stage of the photoelectric conversion element is limited, and since the resolution of the signal processing system to the dynamic range is also limited (for example, around 16 bit at the current level), the S/N ratio of the signal component which reflects the profile of the aerial image turned out to be small. Therefore, the conventional aerial image measurement method was sensitive to noise, and the deterioration of the image profile was large when the aerial image was converted to the aerial image intensity signal, thus, it was difficult to measure the aerial image with a sufficient accuracy.

Besides this method, conventionally, mainly for the purpose of detecting the image forming position of a pattern, details of a unit having a slit scanned with respect to the aerial image of the pattern is disclosed, for example, in Japanese Patent Laid Open No. 58-7823, and the like. With the unit disclosed in the publication, however, the width of the slit was set in correspondence with the shape of the reticle pattern (reference pattern). Therefore, it was difficult to accurately measure the aerial image of patterns having various shapes (including sizes).

In addition, when the optical properties of the projection optical system is measured by the aerial image measurement, there are cases when the position of the aerial image within the plane perpendicular to the optical axis of the projection optical system is measured, and the optical properties of the projection optical system is calculated based on the measurement results. In such a case, however, measurement errors caused by the drift of the laser interferometer measuring the position of the aerial image measurement unit and the like sometimes occurred, during the measurement.

With the conventional exposure apparatus, when the so-called self-measurement of the optical properties of the projection optical system and the like was performed using its own aerial image measurement unit or other units, a reticle used solely for measurement (hereinafter referred to as a “measurement reticle”) on which measurement marks are formed was mainly used.

In the case self-measurement was performed using the measurement reticle, however, the measurement reticle had to be installed each time the measurement was performed. And particularly with the recent exposure apparatus performing various self-measurements, for example, when various self-measurements were successively performed, the measurement reticle had to be exchanged to a different reticle each time a different measurement was performed, which made the exchanging operation and the measurement reticle management complicated.

In addition, the posture of the measurement reticle changed each time the measurement reticle was installed in the apparatus, which sometimes caused measurement errors. In addition, when measurement reticles were used, since the exchanging time of the measurement reticle and the reticle used for manufacturing devices under normal operation such as during continuous operation led to reducing the throughput of the exposure apparatus, it was difficult to frequently perform the self-measurement described above.

### SUMMARY OF THE INVENTION

The present invention has been made in consideration of the circumstances described above, and has as its first object to provide an aerial image measurement method and an aerial image measurement unit that are capable of measuring an aerial image with a sufficient accuracy.

The second object of the present invention is to provide an optical properties measurement method and an optical properties measurement unit that can accurately measure the optical properties of the projection optical system.

The third object of the present invention is to provide an adjustment method of a projection optical system that can adjust the optical properties of the projection optical system with high precision.

The fourth object of the present invention is to provide an exposure method and an exposure apparatus that contribute to improving the productivity of a device.

The fifth object of the present invention is to provide a making method of an exposure apparatus that is capable of accurately transferring a pattern onto a substrate.

And, the sixth object of the present invention is to provide a device manufacturing method that can improve the productivity of a device.

In general, the resolution (resolving power) R of a projection optical system in an exposure apparatus is expressed, well known as the Rayleigh criterion, as R=k×λ/N.A. (λ is the wavelength of the illumination light, N.A. is the numerical aperture of the projection optical system, and k is a constant determined by the photoresist process (the process coefficient) besides the resolution of the resist). The inventor (Hagiwara) focused on this point, and from the results of performing various experiments and the like, discovered that when the width of aperture used in aerial image measurement in the scanning direction was set considering at least either the illumination light wavelength λ or the numerical aperture N.A. a favorable result could be obtained in aerial image measurement. The aerial image measurement method related to the present invention is devised based on such new information by the inventor (Hagiwara).

According to the first aspect of this invention, there is provided an aerial image measurement method to measure an aerial image of a predetermined mark formed by a projection optical system, the measurement method including: the step of illuminating the mark with an illumination light and forming an aerial image of the mark on an image plane via the projection optical system; and the step of scanning a pattern forming member, which has at least one slit-shaped aperture pattern extending in a first direction within a two dimensional plane perpendicular to an optical axis of the projection optical system which width perpendicular to the first direction within the two dimensional plane serving as a second direction is set in consideration of at least one of a wavelength λ of the illumination light and a numerical aperture N.A. of the projection optical system, in the second direction within a surface close to the image plane parallel to the two dimensional plane, and photo-electrically converting the illumination light having passed through the aperture pattern and obtaining a photoelectric conversion signal which corresponds to an intensity of the illumination light having passed through the aperture pattern.

With this method, the predetermined mark is illuminated with the illumination light, and the aerial image of the mark is formed on the image plane via the projection optical system. And, with respect to this aerial image, the pattern forming member is scanned in the second direction within a surface parallel to the two dimensional plane in the vicinity of the image plane. The pattern forming member, in this case, has at least one slit-shaped aperture pattern extending in the first direction within the two dimensional plane perpendicular to the optical axis of the projection optical system which width perpendicular to the first direction within the two dimensional plane serving as the second direction is set in consideration of at least either the wavelength λ of the illumination light or the numerical aperture N.A. of the projection optical system. Also, the illumination light having passed through the aperture pattern is photo-electrically converted and the photoconversion signal corresponding to the intensity of the illumination light that has passed through the aperture pattern is obtained. And, by performing a predetermined process on the photoconversion signal, the aerial image (image intensity distribution) can be obtained.

That is, an aerial image of a predetermined pattern can be obtained based on the slit-scan method. In this case, since the width of the slit-shaped aperture pattern in the scanning direction is set with consideration of at least either the wavelength of the illumination light or the numerical aperture N.A of the projection optical system, it becomes possible to measure the aerial image with sufficient accuracy.

In this case, the width of the aperture pattern in the second direction may be set only in consideration of either the wavelength λ of the illumination light or the numerical aperture N.A of the projection optical system, or it may be set in consideration of both the wavelength λ of the illumination light and the numerical aperture N.A. of the projection optical system. In the latter case, since the width of the aperture pattern in the scanning direction is set in consideration of both the wavelength λ and the numerical aperture N.A. that are the 2 parameters affecting the resolution, it becomes possible to measure the aerial image with more accuracy, compared with the former case.

With the aerial image measurement method according to the present invention, it is preferable for the width of the aperture pattern in the second direction to be greater than zero, and equal to and under the wavelength of the illumination light divided by the numerical aperture N.A. of the projection optical system (λ/N.A.). The reason for setting the width of the aperture pattern in the scanning direction equal to and under (λ/N.A.), first of all, is because when the inventor (Hagiwara) repeatedly performed simulations and experiments under the conditions of the width of the aperture pattern in the scanning direction (referred to as 2D) as 2D=f(λ/N.A.)=n·(λ/N.A.), favorable results (sufficiently practical results) were obtained in the case when the coefficient was n=1. And, secondly, as will be referred to later on, since the photoelectric conversion signal above is to become a convolution of the aperture pattern and the intensity distribution of the aerial image, from the aspect of measurement accuracy, the width of the aperture pattern in the scanning direction 2D is better when narrower.

In this case, it is further preferable for the width of the aperture pattern in the second direction to be equal to and under the (λ/N.A.) multiplied by 0.8. As is mentioned above, from the aspect of measurement accuracy, the width of the aperture pattern in the scanning direction 2D is better when narrower, and according to the simulations and experiments performed by the inventor (Hagiwara), it has been confirmed that the results are further practical when the width of the aperture pattern in the scanning direction 2D is equal to and under 80% of the (λ/N.A.).

When considering the limitations from the aspect of throughput, however, if the width 2D is too narrow, the light intensity of the light having passed through the aperture pattern becomes too weak, and difficult to measure, therefore, a width of a certain range is necessary.

With the aerial image measurement method according to the present invention, the width of the aperture pattern in the second direction may be half a minimum pitch multiplied by an odd number, the minimum pitch being a pitch of a line and space pattern in a limit of resolution set by illumination conditions including properties of the illumination light and the type of the pattern.

In the case of a normal pattern without using the phase-shifting method, under the conditions of conventional illumination, the minimum pitch referred to above is almost equal to λ/N.A. Whereas, in the case of a phase-shifting pattern, that is, in the case of a phase-shifting mask (phase-shifting reticle) pattern employing the phase-shifting method, it is confirmed that the minimum pitch becomes almost λ/(2N.A.). As the phase-shifting mask, the half-tone type, or the Levenson type, can be listed.

With the aerial image measurement method according to the present invention, when a wavelength of the illumination light is expressed as λand a numerical aperture of the projection optical system is expressed as N.A, the width of the aperture pattern in the second direction may be set as {λ/(2N.A.)} multiplied by an odd number.

With the aerial image measurement method according to the present invention, the measurement method can further include the steps of: obtaining a spacial frequency distribution by performing a Fourier Transform on the photoelectric conversion signal; converting the spacial frequency distribution into a spectrum distribution of its original aerial image by dividing the spacial frequency distribution with a frequency spectrum of the aperture pattern that is already known; and recovering the original aerial image by performing an inverse Fourier Transform on the spectrum distribution.

According to the second aspect of this invention, there is provided a first optical properties measurement method to measure optical properties of a projection optical system, the measurement method including: the step of illuminating a predetermined mark with an illumination light and forming an aerial image of the mark on an image plane via the projection optical system; the step of scanning a pattern forming member, which has at least one slit-shaped aperture pattern with a predetermined slit width extending in a first direction within a two dimensional plane perpendicular to an optical axis of the projection optical system, within a surface close to the image plane parallel to the two dimensional plane in a second direction which is perpendicular to the first direction, and photo-electrically converting the illumination light having passed through the aperture pattern and obtaining a photoelectric conversion signal which corresponds to an intensity of the illumination light having passed through the aperture pattern; and the step of obtaining optical properties of the projection optical system based on the photoelectric conversion signal.

With this method, the predetermined mark is illuminated with the illumination light, and the aerial image of the mark is formed on the image plane via the projection optical system. In this state, the pattern forming member is scanned within a surface close to the image plane parallel to the two dimensional plane in the second direction which is perpendicular to the first direction, and the illumination light having passed through the aperture pattern is photo-electrically converted and the photoelectric conversion signal which corresponds to the intensity of the illumination light having passed through the aperture pattern is obtained. In this case, the pattern forming member has at least one slit-shaped aperture pattern with a predetermined slit width extending in a first direction within a two dimensional plane perpendicular to an optical axis of the projection optical system. And, based on the photodetection signal, the optical properties of the projection optical system are obtained.

That is, by the slit-scan method, the aerial image of the predetermined mark can be obtained, and since the optical properties of the projection optical system are obtained based on the obtained photodetection signal, it becomes possible to measure the optical properties of the projection optical system with high precision.

In this case, the mark can consist of a line and space mark that has a periodicity in a direction corresponding to the second direction, detection of the photoelectric conversion signal can be repeated a plurality of times while changing a position of the pattern forming member in a direction of the optical axis, and a predetermined evaluation amount that changes in accordance with a position of the pattern forming member in a direction of the optical axis can be obtained, based respectively on a plurality of photoelectric conversion signals obtained in the detection repeated, and a best focal position of the projection optical system can be obtained based on the largeness of the evaluation amount. Since the evaluation amount changes depending on the position of the pattern forming member in the optical axis direction, according to the present invention, the best focal position of the projection optical system can be accurately, and easily measured (set).

In this case, the evaluation amount can be a contrast which is an amplitude ratio of a first order frequency component and a zero order frequency component of respective signals obtained by performing Fourier Transform respectively on the plurality of photoelectric conversion signals, and a best focal position can be a position of the pattern forming member in a direction of the optical axis which corresponds to a photoelectric conversion signal with the contrast maximized.

With the first optical properties measurement method according to the present invention, the method can further include the step of detecting an image plane shape of the projection optical system by repeatedly performing detection of the best focal position on a plurality of points distanced differently from an optical axis of the projection optical system. The image plane, or in other words, the best image forming plane, is a plane made up of a group of best focal points from innumerable points (that is, innumerable points that have different so-called image heights) which distance from the optical axis differs. Therefore, by repeatedly performing detection of the best focal position on a plurality of points having a different distance from the optical axis of the projection optical system, and performing statistical processing based on the detection results, it becomes possible to obtain the image plane both easily and accurately.

With the first optical properties measurement method according to the present invention, the measurement method can further include the step of: performing detection of the best focal position along an optical axis of the projection optical system repeatedly on a plurality of line and space patterns having a different pitch, and obtaining a spherical aberration of the projection optical system based on a difference of the best focal position corresponding to each of the line and space patterns. The spherical aberration is a type of aperture aberration of the optical system, and is a phenomenon when lights from object points on the optical axis having various apertures enter the optical system the corresponding image point is not formed at one point. Accordingly, by repeatedly performing detection of the best focal position in the optical axis of the projection optical system on a plurality of line and space patterns having a different pitch, and based on the difference of the best focal position corresponding to each pattern obtained, the spherical aberration can be easily obtained by calculation.

With the first optical properties measurement method according to the present invention, forming of the aerial image and detection of the photoelectric conversion signal can be repeatedly performed on an aerial image of the mark projected at different positions within an image field of the projection optical system, and based on a plurality of photoelectric conversion signals obtained in the detection repeated, a position of an aerial image individually corresponding to the plurality of photoelectric conversion signals can be respectively calculated, and at least one of a distortion and a magnification of the projection optical system can be obtained based on the calculation results.

Distortion, here, is an aberration of the projection optical system, and when distortion occurs a line originally straight turns out to be a curved image in the periphery within the image field and the aerial image of the mark is formed deviated (laterally shifted) from the predetermined position on the image plane, as is with the case when magnification error occurs. Accordingly, by respectively calculating the positional deviation of the aerial image, as a consequence, at least either the distortion or magnification can be measured with high precision.

In this case, the mark can include at least one rectangular pattern which width in the second direction is larger than a width of the aperture pattern in the second direction. The reason for the mark to include at least one rectangular pattern which width in the second direction is larger than that of the aperture pattern, is because if the width of the mark in the second direction is narrower than the aperture pattern, it becomes difficult to accurately measure the distortion due to the influence of other aberrations, such as coma aberration.

In this case, a phase detection may be performed so as to respectively detect a phase of the plurality of photoelectric conversion signals, and a position of each of the aerial images may be calculated based on a result of the phase detection, or a position of each of the aerial images may be calculated based on an intersection point of each of the plurality of photoelectric conversion signals and a predetermined slice level. In the former case, the positional deviation of the aerial image of the mark projected at different positions within the image field of the projection optical system can be respectively obtained with high precision by the phase detection method. Whereas, in the latter case, the position of the aerial image of the mark projected at different positions within the image field of the projection optical system can be respectively obtained with high precision by the edge detection method using the slice method.

With the first optical properties measurement method according to the present invention, in the case of obtaining at least either the distortion or the magnification of the projection optical system, the mark can have a rectangular shape as a whole, and can consist of a line and space pattern having a periodicity in the first direction. In such a case, for example, when measuring the distortion or the magnification of the projection optical system, on performing detection of the aerial image of the mark by the slit-scan method the aperture pattern is relatively scanned in the direction perpendicular to the periodic direction of the mark. As a consequence, when a rectangular pattern that has the same shape as the entire shape of the mark is slit-scanned, a signal of a similar aerial image can be obtained. This, for example, allows aerial image measurement equal to when a BOX mark pattern of 10 square μm (an inner BOX mark) is used, without actually forming such a mark pattern, since such a mark pattern is difficult to form due to dishing occurring in the recent CMP process.

In this case, a position of each of the aerial images can be calculated based on an intersection point of the plurality of photoelectric conversion signals respectively and a predetermined slice level.

With the first optical properties measurement method according to the present invention, the mark can consist of a line and space pattern having a periodicity in a direction corresponding to the second direction, and a coma of the projection optical system can be obtained based on the photoelectric conversion signals.

The coma is an aberration of the lens due to different magnifications in various zones of the lens, and occurs at the image portions far from the main axis of the projection optical system. Accordingly, at the position far from the optical axis, the line width of each line pattern becomes different depending on the coma in the aerial image of the line and space pattern. Therefore, based on the photoelectric conversion signals corresponding to the aerial image of the line and space pattern, the coma can be measured in a simple manner, with high accuracy.

In this case, the coma can be calculated based on a calculation result, the calculation result on an abnormal line width value of each line pattern based on an intersection point of the photoelectric conversion signals and a predetermined slice level. In such a case, the abnormal line width value of each line pattern is detected based on the edge detection method using the slice method, thus, it becomes possible to measure the coma in a simple manner, with high accuracy.

With the first optical properties measurement method according to the present invention, in the case of obtaining the coma of the projection optical system based on the aerial image of the line and space pattern, the coma can be calculated based on a calculation result, the calculation result on a phase difference between a first fundamental frequency component of the photoelectric conversion signals corresponding to a pitch of each line and space pattern and a second fundamental frequency component of the photoelectric conversion signals corresponding to an entire width of the line and space pattern. The narrower the width of the pattern subject to aerial image measurement is, the more it is affected by the coma. Therefore, the influence of the coma on the aerial image of each line pattern of the line and space pattern and the influence of the coma in the case when the entire line and space pattern is considered as a single pattern naturally differs. Accordingly, by calculating the phase difference between the first fundamental frequency component of the photoelectric conversion signals corresponding to the pitch of each line and space pattern and the second fundamental frequency component of the photoelectric conversion signals corresponding to the entire width of the line and space pattern, and obtaining the coma of the projection optical system based on the calculation results, the coma of the optical projection system can be obtained with high precision by the phase detection method.

With the first optical properties measurement method according to the present invention, the mark can be a symmetric mark having at least two types of a line pattern with a different line width arranged in a predetermined interval in a direction corresponding to the second direction, and a coma of the projection optical system can be obtained based on a calculation result, the calculation result on a deviation of symmetry of an aerial image of the mark calculated based on an intersection point of the photoelectric conversion signals and a predetermined slice level. The narrower the width of the line pattern of the aerial image is in the scanning direction, the more the aerial image deviates by the influence of the coma. As a consequence, the symmetry of the aerial image of the symmetric mark pattern having a plurality of line pattern types with a different line width arranged in a predetermined interval in a direction corresponding to the scanning direction deviates greatly, the larger the coma is. Accordingly, by the edge detection method using the slice method, the deviation in symmetry of the symmetric mark pattern can be calculated, and based on the calculation results the coma of the projection optical system can be obtained, thus the coma of the projection optical system can be obtained with good accuracy.

With the first optical properties measurement method according to the present invention, a width of the aperture pattern in the second direction can be set in consideration of at least one of a wavelength λ of the illumination light and a numerical aperture N.A of the projection optical system.

According to the third aspect of this invention, there is provided a second optical properties measurement method to measure optical properties of a projection optical system, the measurement method including: the step of illuminating a first mark in a state where the first mark is positioned at a first detection point within an effective field of the optical projection system to form an aerial image of the first mark, and measuring a light intensity distribution corresponding to the aerial image by relatively scanning a measurement pattern with respect to the aerial image of the first mark at a first position related to an optical axis direction of the projection optical system and photo-electrically converting light via the measurement pattern; the step of illuminating a second mark in a state where the second mark is positioned at a second detection point within an effective field of the optical projection system to form an aerial image of the second mark, and measuring a light intensity distribution corresponding to the aerial image by relatively scanning the measurement pattern with respect to the aerial image of the second mark at second position related to an optical axis direction of the projection optical system and photo-electrically converting light via the measurement pattern; and the step of obtaining a positional relationship between a first image forming position of the aerial image of the first mark within a plane perpendicular to the optical axis obtained by a result of the measurement of the aerial image of the first mark when the measurement pattern is at the first position of the optical axis and a second image forming position of the aerial image of the second mark within a plane perpendicular to the optical axis obtained by a result of the measurement of the aerial image of the second mark when the measurement pattern is at the second position of the optical axis, and calculating a telecentricity of the projection optical system based on the positional relationship.

With this method, the telecentricity of the projection optical system is calculated based on the positional relationship between the image forming position within a plane perpendicular to said optical axis (hereinafter referred to as the first image forming position) of the aerial image obtained from the results of measuring the aerial image of the first mark positioned at the first detection point in the effective image field of the projection optical system at the surface corresponding to the first position in the optical axis direction and the image forming position within a plane perpendicular to said optical axis (hereinafter referred to as the second image forming position) of the aerial image obtained from the results of measuring the aerial image of the second mark positioned at the second detection point in the effective image field of the projection optical system at the surface corresponding to the second position in the optical axis direction. That is, the telecentricity of the projection optical system is calculated based on the relative distance between the first image forming position and the second image forming position within the plane perpendicular to the optical axis and the distance between the first image forming position and the second image forming position in the optical axis direction. So, for example, on measuring the first image forming position and the second image forming position, when the measurement values of the laser interferometer and the like are used, even if a drift or the like occurs in the laser interferometer, the measurement results of the first image forming position and the second image forming position both contain an equivalent error. Therefore, it becomes possible to perform telecentricity measurement, which is hardly affected by measurement errors due to interferometer drift and the like with high precision.

In this case, the first mark and the second mark may be different marks, or, the first mark and the second mark may be the same.

With the second optical properties measurement method according to the present invention, the measurement pattern can be an aperture pattern which width in the scanning direction is set in consideration of at least one of a wavelength λ of the illumination light and a numerical aperture N.A of the projection optical system.

According to the fourth aspect of this invention, there is provided an aerial image measurement unit that measures an aerial image of a predetermined mark formed by a projection optical system, the measurement unit comprising: an illumination unit which illuminates the mark to form an aerial image of the mark onto an image plane via the projection optical system; a pattern forming member, which has at least one slit-shaped aperture pattern extending in a first direction within a two dimensional plane perpendicular to an optical axis of the projection optical system which width in a second direction being perpendicular to the first direction is greater than zero, and equal to and under the wavelength λ of the illumination light divided by the numerical aperture N.A. of the projection optical system (λ/N.A.); a photoelectric conversion element which photo-electrically converts the illumination light having passed through the aperture pattern, and outputs a photoelectric conversion signal corresponding to an intensity of the illumination light; and a processing unit which scans the pattern forming member in the second direction within a surface parallel to the two dimensional plane in the vicinity of the image plane in a state where the mark is illuminated by the illumination unit and the aerial image is formed on the image plane, and measures a light intensity distribution corresponding to the aerial image based on the photoelectric conversion signal output from the photoelectric conversion element.

With this unit, the illumination unit illuminates the predetermined mark, and the aerial image of the mark is formed on the image plane via the projection optical system. The processing unit then scans the pattern forming member that has at least one slit-shaped aperture pattern extending in the first direction within the two dimensional plane perpendicular to the optical axis of the projection optical system in the second direction within the surface parallel to the two dimensional plane in the vicinity of the image plane with respect to the aerial image formed. And, the processing unit also measures the light intensity distribution corresponding to the aerial image based on the photoelectric conversion signal (electric signals of the illumination light having passed through the aperture pattern during scanning and photo-electrically converted) output from the photoelectric conversion element. That is, the aerial image of the predetermined mark is measured in this manner, by the slit-scan method. In addition, in this case, since the width of the aperture pattern in the scanning direction formed on the pattern forming member is equal to and under (λ/N.A.), the measurement of the aerial image can be performed with sufficiently practical high precision.

According to the fifth aspect of this invention, there is provided an optical properties measurement unit that measures optical properties of a projection optical system, which projects a pattern on a first surface onto a second surface, the unit comprising; an aerial image measurement unit according to the present invention; and a calculation unit which calculates the optical properties of the projection optical system based on a photodetection conversion signal obtained upon measurement of a light intensity distribution by the aerial image measurement unit.

With this unit, the aerial image of the mark, that is, the light intensity distribution is accurately measured with the aerial image measurement unit in the present invention, and based on the photodetection conversion signal obtained on this measurement, the calculation unit calculates the optical properties of the projection optical system. Therefore, it becomes possible to obtain the optical properties of the projection optical system with high precision.

According to the sixth aspect of this invention, there is provided a first exposure apparatus that transfers a circuit pattern formed on a mask onto a substrate via a projection optical system, the exposure apparatus comprising: a substrate stage which holds the substrate; and an aerial image measurement unit according to the present invention which has an arrangement of the pattern forming member being integrally movable with the substrate stage.

With this apparatus, since it comprises the aerial image measurement unit in the present invention that has an arrangement of the pattern forming member being integrally movable with the substrate stage, it becomes possible, for example, to form various measurement marks on the mask and to measure the aerial image of the various measurement marks with high precision by the aerial image measurement unit while moving the pattern forming member integrally with the substrate stage. Accordingly, it becomes possible to improve the exposure accuracy in the long run, by using the measurement results and performing, for example, initial adjustment of the optical properties of the projection optical system and the like. As a consequence, this can lead to improving the yield of the device as an end item, and this can contribute to improving the productivity of the device.

In this case, the exposure apparatus can further comprise a control unit which measures a light intensity distribution corresponding to aerial images of various mark patterns using the aerial image measurement unit and obtains optical properties of the projection optical system based on data of the light intensity distribution measured. In such a case, the control unit measures the light intensity distribution corresponding to the aerial images of various mark patterns, and based on the data of the light intensity distribution measured, the optical properties of the projection optical system are obtained. Thus, it becomes possible to obtain the optical properties of the projection optical system when necessary, and this allows adjustment of the optical properties of the projection optical system prior to the beginning of exposure based on the obtained optical properties. Accordingly, improving the exposure accuracy becomes possible.

With the first exposure apparatus according to the present invention, the exposure apparatus can further comprise: a mark detection system which detects a position of a mark on the substrate stage; and a control unit which detects a positional relationship between a projected position of the mask pattern by the projection optical system and the mark detection system using the aerial image measurement unit. In such a case, the control unit detects the positional relationship between the projected position of the mask pattern by the projection optical system, or in other words, the image forming position of the aerial image of the pattern and the mark detection system (that is, the so-called baseline amount of the mark detection system) using the aerial image measurement unit. In this case, on measuring the baseline amount, since the projection position of the mask pattern can be measured directly by the aerial image measurement unit, a baseline amount measurement with high accuracy is possible compared with the case when the projection position of the mask pattern is measured indirectly using the fiducial mark plate and the reticle microscope. Accordingly, by controlling the position of the substrate during exposure and the like using this baseline amount, the exposure accuracy can be improved due to improvement in the overlay accuracy of the mask and the substrate.

According to the seventh aspect of this invention, there is provided a second exposure apparatus that illuminates a predetermined pattern with an illumination light to transfer the pattern onto a substrate via a projection optical system, the exposure apparatus comprising: a self-measurement master on which a plurality of types of measurement marks used for self-measurement are formed; and a self-measurement master mounting stage on which the self measurement master is mounted, and which can move the self-measurement master close to a focal position on an object side of the projection optical system where the illumination light can illuminate.

With this apparatus, the self-measurement master mounting stage can position all the plurality of types of measurement marks used for self-measurement formed on the self-measurement master close to the focal position on the object side of the projection optical system where the illumination light can illuminate. This allows various self-measurements by irradiating the illumination light on the measurement marks, forming the image of the measurement marks close to the focal plane of the image side of the projection optical system, and detecting the image, without preparing an exclusive measurement master separately. Accordingly, the operation of exchanging the master for manufacturing the device and the master solely for measurement is not required, thus allowing reduction of downtime of the apparatus on various self-measurements, which consequently leads to improving the operation rate of the exposure apparatus. As a result, this can contribute to improving the productivity of the device as an end item.

With the second exposure apparatus according to the present invention, the exposure apparatus can further comprise: an aerial measurement unit that includes a pattern forming member arranged within a two dimensional plane perpendicular to an optical axis of the projection optical system on which a measurement pattern is formed and a photoelectric conversion element which photo-electrically converts the illumination light via the measurement pattern; and a driving unit which drives at least one of the self-measurement master mounting stage and the pattern forming member when at least a part of the self-measurement master is illuminated by the illumination light and an aerial image of the measurement mark illuminated by the illumination light is formed in a vicinity of a focal position on an image side of the projection optical system by the projection optical system, so that the aerial image and the measurement pattern are relatively scanned.

In this case, the measurement pattern can include at least one slit-shaped aperture pattern which width in a direction of the relative scanning is greater than zero, and equal to and under the wavelength λ of the illumination light divided by the numerical aperture N.A. of the projection optical system (λ/N.A.).

With the second exposure apparatus according to the present invention, the self-measurement master mounting stage can be a mask stage on which a mask having the predetermined pattern formed is mounted.

In this case, the exposure apparatus can further comprise: a substrate stage where the substrate is mounted and a reference mark is provided; an observation microscope to observe a mark located on the mask stage; and a control unit which performs aerial image measurement of a measurement mark on the self-measurement master using the self-measurement master, the aerial image measurement unit, and the driving unit and calculates a magnification of the projection optical system based on the aerial image measurement on exposing a first substrate of each lot, whereas on exposing a substrate besides the first substrate of each lot, the control unit observes a mark on one of the self-measurement master and the mask and an image of a reference mark on the substrate stage via the projection optical system using the observation microscope and calculates a magnification of the projection optical system based on a result of the observation, when the substrate is exposed by lot.

With the second exposure apparatus according to the present invention, the self-measurement master can be a mask on which the predetermined pattern is formed.

With the second exposure apparatus according to the present invention, measurement marks formed on the self-measurement master can include at least one of a distortion measurement mark of the projection optical system, a repetition mark for best focus measurement, an artificial isolated line mark for best focus measurement, an alignment mark for overlay error measurement with the substrate.

With the second exposure apparatus according to the present invention, measurement marks formed on the self-measurement master can include an isolated line mark and a line and space mark having a predetermined pitch.

According to the eighth aspect of this invention, there is provided an adjustment method of a projection optical system that projects a pattern on a first surface onto a second surface, the adjustment method including: the step of measuring optical properties of the projection optical system by the first optical properties measurement method according to the present invention; and the step of adjusting the projection optical system based on a result of the measurement.

With this method, by the first optical properties measurement method according to the present invention the optical properties of the projection optical system can be measured with good accuracy. And, by adjusting the projection optical system based on the measurement results, it becomes possible to adjust the optical properties of eth projection optical system with high precision.

According to the ninth aspect of this invention, there is provided an exposure method to transfer a pattern formed on a mask onto a substrate via a projection optical system, the exposure method including: the step of adjusting the projection optical system by an adjustment method of a projection optical system according to the present invention; and the step of transferring the pattern onto the substrate using the projection optical system which optical properties have been adjusted.

With this exposure method, since the pattern of the mask is transferred onto the substrate using the projection optical system which optical properties have been adjusted with high precision by the adjustment method in the present invention, the pattern can be transferred with good accuracy. As a consequence, it becomes possible to improve the yield of the device as an end item, and this allows contribution to improving the productivity of the device.

According to the tenth aspect of this invention, there is provided a making method of an exposure apparatus that transfers a pattern formed on a mask onto a substrate via a projection optical system, the making method including: the step of measuring optical properties of the projection optical system by the first optical properties measurement method according to the present invention; and the step of adjusting the projection optical system based on a result of the measurement.

With this making method, since the optical properties of the projection optical system is measured with good accuracy by the first optical properties measurement method according to the present invention and the projection optical system is adjusted based on the measurement results, the optical properties of the projection optical system can be adjusted with good accuracy. Accordingly, it becomes possible to transfer the pattern formed on the mask onto the substrate with good accuracy via the projection optical system which optical properties are adjusted with good accuracy.

In addition, in the lithographic process, by performing exposure using the first exposure apparatus according to the present invention, the pattern can be transferred on the substrate with good accuracy, which leads to an improvement in yield of the device as an end item. Also, in the lithographic process, by performing exposure using the second exposure apparatus in the present invention, the operation rate of the exposure apparatus is improved, which leads to an improvement in productivity of the device as an end item. Accordingly, further from another aspect of the present invention, there is provided a device manufacturing method that uses either the first exposure apparatus or the second exposure apparatus of the present invention.

### BRIEF DESCRIPTION OF THE DRAWINGS

In the accompanying drawings:

FIG. 1 is a schematic view showing the arrangement of an exposure apparatus related to the first embodiment according to the present invention;

FIG. 2 is view showing an internal arrangement of the alignment system and the aerial image measurement unit in FIG. 1;

FIG. 3 is a view showing a modified example of the aerial image measurement unit that has an arrangement of the optical sensor arranged external to the wafer stage;

FIG. 4 is a view showing a modified example of the aerial image measurement unit that has an arrangement of the optical sensor arranged internal to the wafer stage;

FIG. 5 is a view showing the state when the alignment system is detecting the alignment mark on the wafer;

FIG. 6 is a view showing the state when the alignment system is detecting the slit of the aerial image measurement unit on baseline measurement by the alignment system;

FIG. 7 is a bottom surface view showing the reticle mark plate in FIG. 1;

FIG. 8 is a view showing an example of a mark arrangement on the reticle mark plate;

FIG. 9A is a planar view showing the aerial image measurement unit in a state when an aerial image PM′ is formed on the slit plate on aerial image measurement;

FIG. 9B is a linear graph showing an example of the photodetection conversion signal (light intensity signal) P obtained upon the aerial image measurement;

FIG. 10 is a planar view showing an arrangement of the slits on the slit plate;

FIG. 11 is a linear graph showing the results of simulation at the best focal position, and shows the results of image forming simulation corresponding to the case when an aerial image of a L/S mark having a line width of 0.2 μm and a duty ratio of 50%;

FIG. 12 is a linear graph showing the spacial frequency component when Fourier Transform is performed on the intensity signal P3 in FIG. 11, along with the original intensity signal P3;

FIG. 13 is a linear graph showing the results of simulation at the position defocused by 0.2 μm from the best focal position;

FIG. 14 is a linear graph showing the spacial frequency component when Fourier Transform is performed on the intensity signal P3 in FIG. 13, along with the original intensity signal P3;

FIG. 15 is a linear graph showing the results of simulation at the position defocused by 0.3 μm from the best focal position;

FIG. 16 is a linear graph showing the spacial frequency component when Fourier Transform is performed on the intensity signal P3 in FIG. 15, along with the original intensity signal P3;

FIG. 17 is a planar view showing an example of a measurement reticle used on detection of the shape of the image plane;

FIG. 18 is a planar view showing an example of a measurement reticle used on detection of the spherical aberration;

FIG. 19 is a planar view showing the slit plate 90 used upon magnification and distortion measurement;

FIG. 20 is a planar view showing an example of a measurement reticle used upon magnification and distortion measurement;

FIG. 21 is a planar view showing the aerial image measurement unit in a state when an aerial image of the measurement mark is formed on the slit plate upon aerial image measurement using a reticle on which measurement marks consisting of a large L/S pattern is formed;

FIG. 22 is a view showing an example of a mark block on which an artificial box mark and other measurement marks are formed;

FIG. 23 is a view for explaining the first measurement method of coma, and shows an example of a resist image;

FIG. 24 is a planar view showing an example of a measurement reticle used in the first measurement method of coma;

FIG. 25 is a planar view showing the slit plate on which an aerial image is formed in the case of using a combined mark pattern that has an arrangement of a plurality of L/S patterns with five lines combined in a predetermined period as each measurement mark;

FIG. 26 is a view for explaining that the aerial image indicated in FIG. 25 has two fundamental frequency components;

FIG. 27 is an enlarged view showing a measurement mark used in the second measurement method of coma;

FIG. 28 is a planar view showing the slit plate on which an aerial image of the measurement marks consisting of a linear mark laterally symmetric that has a wide line pattern and a narrow line pattern arranged at a predetermined interval in the measurement direction is formed;

FIG. 29 is a planar view showing the slit plate on which an aerial image is formed of the measurement mark indicated in FIG. 28 in the case when the linear marks are repeatedly arranged;

FIG. 30 is a planar view showing an example of a measurement reticle used in the second measurement method of coma;

FIG. 31 is a view showing measurement values of the contrast (the mark x) obtained at 13 points, when the slit plate is changed in the Z-axis direction in 13 stages (steps), with the horizontal axis as the Z-axis;

FIG. 32 is a view showing measurement values of the amplitude of the first order component (the mark x) obtained at 13 points, when the slit plate is changed in the Z-axis direction in 13 stages (steps), with the horizontal axis as the Z-axis;

FIG. 33A and FIG. 33B are graphs showing the S/N ratio related to focus detection in the case of applying the equation (6) when assuming an example of using a photo multiplier tube under the respective predetermined conditions;

FIG. 34A and FIG. 34B are graphs showing the contrast respectively corresponding to FIG. 33A and FIG. 33B;

FIG. 35A and FIG. 35B are graphs showing the first order respectively corresponding to FIG. 33A and FIG. 33B;

FIG. 36A and FIG. 36B are graphs showing the S/N ratio related to focus detection in the case of applying the equation (8) under the same conditions as in FIG. 33A and FIG. 33B;

FIG. 37A and FIG. 37B are views respectively showing the simulation data of the intensity signal of the light transmitting the slit, its differential signal, and the aerial image intensity, when the slit width is of equal magnification and is three times the minimum half-pitch;

FIG. 38A and FIG. 38B are views respectively showing the simulation data of the intensity signal of the light transmitting the slit, its differential signal, and the aerial image intensity, when the slit width is five times the minimum half-pitch and is seven times the minimum half-pitch;

FIG. 39 is a view showing the frequency characteristics when the slit width is equal, three times, and five times the half-pitch of the limit of resolution;

FIG. 40 is a view showing an arrangement of an exposure apparatus related to the second embodiment of the present invention with a portion partly omitted;

FIG. 41 is a view showing a state when the exposure apparatus in the second embodiment is using the aerial image measurement unit to measure the position of the laser beam spot upon baseline measurement with the alignment system ALG2;

FIG. 42A and FIG. 42B are views for explaining other arrangement examples of the slit formed on the slit plate of the aerial image measurement unit, and the method of using the aerial image measurement units that have these slits formed;

FIG. 43 is a flow chart for explaining an embodiment of a device manufacturing method according to the present invention;

FIG. 44 is a flow chart showing the processing in step 204 in FIG. 43; and

FIG. 45A to FIG. 45C are views for explaining the conventional aerial image measurement method.

### DESCRIPTION OF THE PREFERRED EMBODIMENTS

The First Embodiment

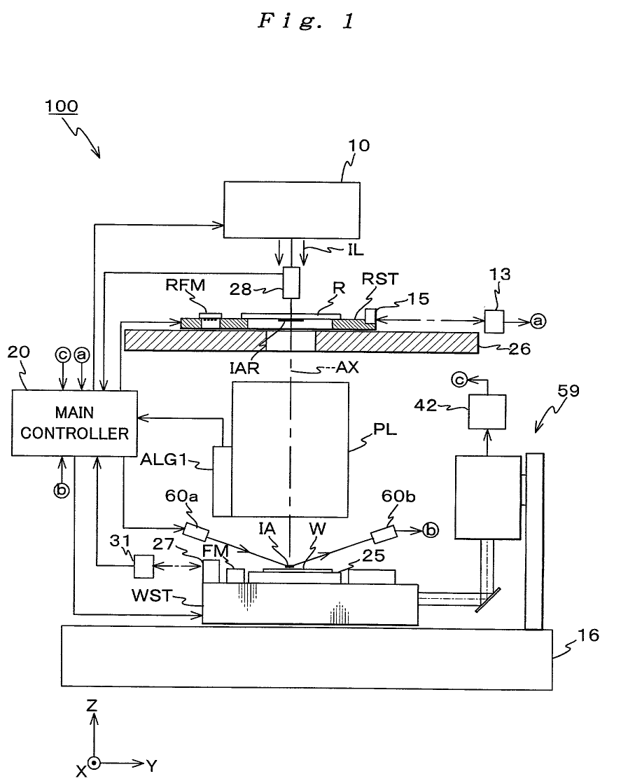

The first embodiment of the present invention will be described below with reference to FIGS. 1 to 39. FIG. 1 shows a schematic arrangement of an exposure apparatus 100 related to the first embodiment. The exposure apparatus 100 is a scanning projection exposure apparatus, that is, the so-called scanning stepper, based on the step-and-scan method.

The exposure apparatus 100 comprises: an illumination system 10, which includes a light source and an illumination optical system; a reticle stage RST, which holds the reticle R serving as a mask; a projection optical system PL; a wafer stage WST, which holds the wafer W serving as a substrate and is capable of moving freely within an XY plane; and a control system and the like to control these parts.

The illumination system 10 has a structure including: a light source; an illuminance uniformity optical system (made up of a collimator lens, a fly-eye lens, and the like); an illumination system aperture stop plate (a circular aperture stop for an ordinary illumination, a small σ aperture stop for a small σ illumination, a ring-shaped aperture stop for a ring-shaped illumination, a quadrupole aperture stop for modified illumination, and the like, are arranged at substantially equal angular intervals); a relay lens system; a reticle blind serving as an illumination aperture stop; a condenser lens system; and the like (all are omitted in FIG.

As the light source, in this embodiment, an excimer laser light source that emits the KrF excimer laser beam (wavelength: 248 nm) or the ArF excimer laser beam (wavelength: 193 nm) is to be used as an example.

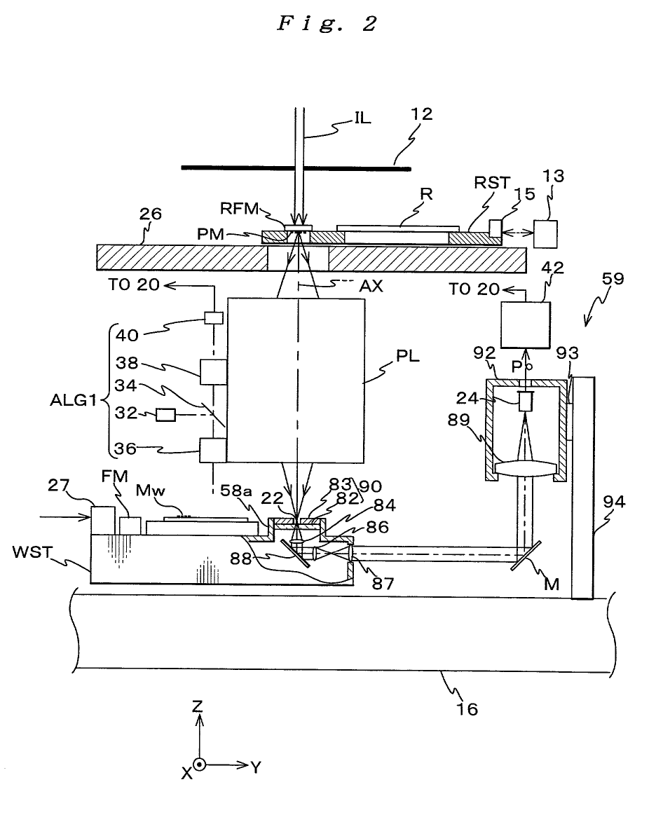

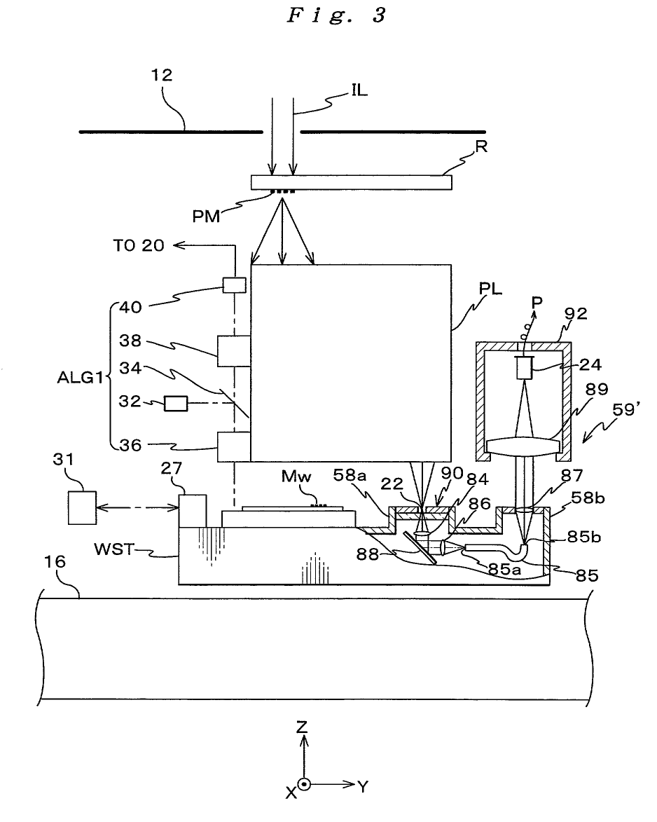

The reticle blind is made up of a fixed reticle blind which opening shape is fixed (not shown in FIGS.) and a movable reticle blind 12 which opening shape is variable (omitted in FIG. 1, refer to FIG. 2). The fixed reticle blind is arranged in the vicinity of the pattern surface of the reticle R or on a surface slightly defocused from the conjugate plane relative to the pattern surface, and a rectangular opening which sets the rectangular slit-shaped illumination area IAR (a rectangular slit-shaped illumination area which is elongated in the X-axis direction, being perpendicular to the surface of FIG. 1, and which width is predetermined in the Y-axis direction, being the horizontal direction in FIG. 1) is formed on the reticle R. In addition, the movable reticle blind 12 is arranged on the conjugate plane relative to the pattern surface of the reticle R, and has an opening that is variable in position, which directions correspond to the scanning direction (in this case, the Y-axis direction) and the non-scanning direction (in this case, the X-axis direction) during scanning exposure, and in width. However, for the sake of simplicity in the explanation, the movable reticle blind 12 is shown as if it is arranged in the vicinity of the illumination system with respect to the reticle R, in FIG. 2 and in FIG. 3.

With the illumination system 10, the illumination light, which is generated at the light source and serves as the exposure light (hereinafter ref erred to as the “illumination light IL”), passes through a shutter (not shown in FIGS.) and then is converted to a beam having an almost unified illumination distribution by the illuminance uniformity optical system. The illumination light IL emitted from the illuminance uniformity optical system passes through an aperture stop on the illumination system aperture stop plate, the relay lens system, and then reaches the reticle blind. After passing through the reticle blind, the illumination light IL passes through the relay lens system, the condenser lens system, and then illuminates the illumination area IAR of the reticle R, on which the circuit pattern is drawn, with a uniform illuminance.

The main controller 20 controls the movable reticle 12 at the beginning and end of scanning exposure, and by further restricting the illumination area IAR, exposure on unnecessary portions is to be avoided. In addition, in this embodiment, the movable reticle blind 12 is also used to set the illumination area when the aerial image is measured with the aerial image measurement unit, which will be described later on in the description.

On the reticle stage RST, the reticle R is fixed by, for example, vacuum chucking (or electrostatic adsorption). The reticle stage RST, in this case, can be finely driven two dimensionally (in the X-axis direction, the Y-axis direction, and the rotational direction (Oz direction) around the Z-axis) within an XY plane that is perpendicular to the optical axis AX of the projection optical system PL (to be described later) by a reticle stage driving system, which includes a linear motor and the like. The reticle stage RST is also movable in the Y-axis direction at a designated scanning velocity on a reticle base 26.

Close to the −Y side edge portion of the reticle stage RST, a reticle fiducial mark plate (hereinafter referred to as a “reticle mark plate”) RFM is arranged along the X-axis direction side by side with the reticle R, and serves as a master for self-measurement. The reticle mark plate RFM is made of the same glass material as of the reticle R, such as, synthetic quartz, fluorite, lithium fluoride, or other fluoride crystals, and the like, and is fixed to the reticle stage RST. The details of the concrete structure of the reticle mark plate RFM will be described later on in the description. The movement stroke of the reticle stage RST in the Y-axis direction can cover, at the least, the range of the entire surface of the reticle R and the entire surface of the reticle mark plate RFM crossing the optical axis AX of the projection optical system PL.

In addition, openings penetrating the reticle stage RST are respectively formed beneath the reticle R and the reticle mark plate RFM, and the illumination light IL passes through these openings. Also, almost directly above the projection optical system PL in the reticle base 26, a rectangular opening larger than the illumination area IAR is formed, where the illumination light IL passes through.

On the reticle stage RST, a movable mirror 15 is fixed to reflect the laser beam emitted from the reticle laser interferometer (hereinafter referred to as “reticle interferometer”) 13. The position of the reticle stage RST within the XY plane (including the rotation in the Oz direction, which is the rotational direction around the Z-axis) is detected at all times by the reticle interferometer 13 at, for example, a resolution of around 0.5 to 1 nm. In actual, on the reticle stage RST, a movable mirror having a reflection surface perpendicular to the scanning direction (the Y-axis direction) during scanning exposure and a movable mirror having a reflection surface perpendicular to the non-scanning direction (the X-axis direction) are arranged, as well as the reticle interferometer 13 being arranged on at least two axes in the Y-axis direction and at least one axis in the X-axis direction. In FIG. 1, however, these are representatively indicated as the movable mirror 15 and the reticle interferometer 13.

The positional information of the reticle stage RST is sent from the reticle interferometer 13 to the main controller 20, which consists of a workstation (or a microcomputer). The main controller 20 then controls and drives the reticle stage RST via the reticle stage driving system, based on the positional information of the reticle stage RST.

In addition, a pair of reticle alignment microscopes (hereinafter referred to as “RA microscopes” for the sake of convenience) 28 is arranged above the reticle R. The RA microscopes 28 serve as an observation microscope, made up of a TTR (Through the Reticle) alignment system that utilizes the exposure wavelength to observe both the marks on the reticle R or the reticle mark plate RFM and the fiducial marks on the fiducial mark plate FM on the wafer stage WST at the same time via the projection optical system PL. The detection signals of these RA microscopes 28 are sent to the main controller 20 via an alignment control unit (not shown in FIGS.). In this case, deflection mirrors (not shown in FIGS.) are arranged freely movable so as to guide the detection light from the reticle R to the respective RA microscopes 28. And when the exposure sequence begins, the mirror driving unit (not shown in FIGS.) withdraws the deflection mirrors, based on instructions from the main controller 20. The arrangement similar to the RA microscopes 28 is disclosed in, for example, Japanese Patent Laid Open No. 07-176468, and in the corresponding U.S. Pat. No. 5,646,413. As long as the national laws in designated states or elected states, to which this international application is applied, permit, the disclosures cited above are fully incorporated herein by reference.

The projection optical system PL is arranged below the reticle stage RST as is shown in FIG. 1, and the direction of the optical axis is the Z-axis direction. The projection optical system is a double telecentric reduction system, and employs a refraction optical system made up of a plurality of lens elements arranged along the direction of the optical axis AX in predetermined intervals. The projection magnification of the projection optical system PL is, for example, ¼ (or ⅕). Therefore, when the illumination light IL from the illumination system 10 illuminates the slit-shaped illumination area IAR on the reticle R, the illumination light IL which passes through the reticle R forms a reduced image (a partial inverted image) of the circuit pattern of the reticle R corresponding to the inner area of the illumination area IAR via the projection optical system PL, on an exposure area IA of the wafer W, which is conjugate to the illumination area IAR and has a photoresist coated on its surface.

The wafer stage WST is driven freely along the upper surface of a stage base 16 within the XY two-dimensional plane (including the Oz rotation) by a wafer stage driving system (not shown in FIGS.) made up of, for example, a two-dimensional magnetically levitated linear actuator. The two-dimensional magnetically levitated linear actuator has a Z driving coil, in addition to the X driving coil and Y driving coil. Therefore, the wafer stage WST can be finely driven in directions of three degrees of freedom, in the Z. θx (rotational direction around the X-axis), and θy (rotational direction around the Y-axis) directions.

On the wafer stage WST, a wafer holder 25 is arranged, and the wafer holder 25 holds the wafer W by, for example, vacuum chucking (or electrostatic adsorption). In addition, a fiducial mark plate FM is fixed on the wafer stage WST. The fiducial mark plate FM contains fiducial marks for baseline measurement, fiducial marks for reticle alignment (these fiducial marks are also used for magnification measurement, which will be described later on), and other fiducial marks. The fiducial mark plate FM is arranged so that its surface is almost at the same height as the wafer W.

In the case of using a two-dimensional moving stage which can be driven only within the XY two-dimensional plane by a driving system such as a linear motor or a planar motor, instead of the wafer stage WST, the wafer holder 25 may be mounted on the two-dimensional moving stage via a Z leveling table. The Z leveling table is capable of being finely driven in directions of three degrees of freedom, in the Z, θx, and θy directions, by for example, a voice coil motor and the like.

On the wafer stage WST, a movable mirror 27, which reflects the laser beam from the wafer laser interferometer (hereinafter referred to as a “wafer interferometer”) 31, is arranged. The wafer interferometer 31, which is arranged external to the wafer stage WST, detects the position of the wafer stage WST at all times in directions of five degrees of freedom (the X, Y, θx, θy, and θz direction), excluding the Z direction, at a resolution of, for example, around 0.5 to 1 nm.

In actual, on the wafer stage WST, a movable mirror having a reflection surface perpendicular to the scanning direction which is the Y-axis direction on scanning exposure and a movable mirror having a reflection surface perpendicular to the non-scanning direction which is the X-axis direction are arranged, in addition to the wafer interferometer 31 being arranged respectively in plurals in the Y-axis direction and the X-axis direction. In FIG. 1, however, these are representatively indicated as the movable mirror 27 and the wafer interferometer 31. The positional information (or the velocity information) of the wafer stage WST is sent to the main controller 20, and the main controller 20 controls the position of the wafer stage WST within the XY plane via the wafer stage driving system (not shown in FIGS.), based on the positional information (or the velocity information).

In addition, an optical system structuring an aerial image measurement unit 59 is partially arranged inside the wafer stage WST. The aerial image measurement unit 59 is used to measure the optical properties of the projection optical system PL, and the structure will now be described in detail. As is shown in FIG. 2, the aerial image measurement unit 59 is made up of two portions; a portion arranged on the stage side within the wafer stage WST, and a portion arranged external to the wafer stage WST. The stage side portion comprises: a slit plate 90 which serves as a pattern forming member; a relay optical system consisting of a lens 84 and a lens 86; a mirror 88 to deflect the optical path; and a light transmittance lens 87, whereas the portion external to the wafer stage WST comprises: a mirror M; a photodetection lens 89; an optical sensor 24 which serves as a photoconversion element; a signal processing circuit 42 which processes the photo-electrically converted signals from the optical sensor 24, and the like.

More particularly, as is shown in FIG. 2, the slit plate 90 is fitted into a projected portion 58a, which is arranged projecting on the upper surface of the wafer stage WST on one end of the stage and has an opening formed on the upper side. The slit plate 90 is fitted into the opening from above, and is made up of a photodetection glass 82 being rectangular in a planar view and a reflection film 83 also serving as a light shielding film, which is formed on the upper surface of the photodetection glass 82. And a slit-shaped opening pattern (hereinafter referred to as a “slit”) 22, which serves as a measurement pattern and has a predetermined width (2D), is patterned on a part of the reflection film 83.

As the material for the photodetection glass 82, in this embodiment, materials such as synthetic quartz or fluorite that have high transmittance to the KrF excimer laser beam or the ArF excimer laser beam, is to be used.

Within the wafer stage WST underneath the slit 22, a relay optical system (84, 86) made up of the lenses 84 and 86, is arranged with the mirror 88 in between to horizontally deflect the optical path of the illumination light (image light) which is vertically incident via the slit 22. And to the sidewall of the wafer stage WST on the +Y side, which is further downstream of the optical path of the relay optical system (84, 86), the light transmittance lens 87, which transmits the illumination light that has been relayed for a predetermined optical path out of the wafer stage WST, is fixed.

On the optical path of the illumination light transmitted outside the wafer stage WST by the light transmittance lens 87, the mirror M having a predetermined length in the X-axis direction is arranged at a tilt angle of 45°. With the mirror M, the optical path of the illumination light transmitted outside the wafer stage WST is deflected vertically upward by 90°. On the optical path bent vertically upward, the photodetection lens 89 that has a larger diameter compared with the light transmittance lens 87 is arranged. And above the photodetection lens 89, the optical sensor 24 is arranged. The photodetection lens 89 and the optical sensor 24 keep a predetermined positional relationship, and are housed within a case 92. The case 92 is fixed via an attachment member 93 to the upper end of a strut 94, which is planted on the upper surface of the base 16.

As the optical sensor 24, a photoconversion element (photodetection element) capable of accurately detecting faint light, such as a photo multiplier tube (PMT) is used. The signal processing circuit 42 processing the output signals of the optical sensor 24 has an arrangement including an amplifier, a sample holder, an A/D converter (normally having a resolution of 16 bits) and the like.

As is referred to earlier, the slit 22 is actually formed on the reflection film 83. For the sake of convenience, however, the description hereinafter will refer to the slit 22 being made on the slit plate 90. The arrangement and the size of the slit 22 will be described later on in the description.

With the aerial image measurement unit 59 that has the arrangement described above, on measuring the projected image (aerial image) of the measurement marks formed on the reticle R or the reticle mark plate RFM via the projection optical system PL (this will be described later), when the illumination light IL having passed through the projection optical system Pl illuminates the slit plate 90, the illumination light IL that has passed through the slit 22 on the slit plate 90 is guided outside the wafer stage WST after passing through the lens 84, the mirror 88, the lens 86, and the light transmittance lens 87. And the optical path of the light that has been guided outside the wafer stage WST is bent vertically upward by the mirror M. The illumination light IL, being bent upward, is photo-detected by the optical sensor 24 via the photodetection lens 89, and the photoelectric conversion signals (light amount signals) from the optical sensor 24 corresponding to the photo-detected amount is sent to the main controller 20 via the signal processing circuit 42.

In the case of this embodiment, measurement of the projected image (aerial image) of the measurement marks is to be performed based on the slit-scan method, therefore, during this operation, the light transmittance lens 87 is to move with respect to the photodetection lens 89 and the optical sensor 24. So, with the aerial image measurement unit 59, the size of each lens and the mirror M is set so that all light that has passed through the light transmittance lens 87 moving within a predetermined range is incident on the photodetection lens 89.

As is described, with the aerial image measurement unit 59, a light guiding portion is structured to guide the light that has passed through the slit 22 out of the wafer stage WST by the slit plate 90, the lenses 84 and 86, mirror 88, and the light transmittance lens 87, and a photodetection portion is structured to receive the light guided out from the wafer stage WST by the photodetection lens 89 and the optical sensor 24. In this case, the light guiding portion and the photodetection portion are mechanically separate. And the light guiding portion and the photodetection portion are optically connected only when the aerial image measurement is performed.

That is, with the aerial image measurement unit 59, since the optical sensor 24 is arranged at a predetermined position external to the wafer stage WST, the heat generated by the optical sensor 24 does not have an adverse effect on the measurement precision and the like of the laser interferometer 31. In addition, since the external portion and the internal portion of the wafer stage WST is not connected with a light guide and the like, the driving accuracy of the wafer stage WST is not adversely affected as in the case when the external portion and the internal portion of the wafer stage WST is connected with a light guide and the like.

The arrangement of the aerial image measurement unit is not limited to the previous description, and it may have an arrangement such as the aerial image measurement unit 59′ indicated in FIG. 3. The arrangement of the aerial image measurement unit 59′ is basically identical with the aerial image measurement unit 59; however, the following points differ with the aerial image measurement unit 59.

That is, as is shown in FIG. 3, on the wafer stage WST, two projected portions 58a and 58b are arranged, with the upper surface of the projected portions 58a and 58b arranged at almost the same surface as the wafer W surface. Likewise with the case in FIG. 2, a slit plate 90 having an identical arrangement is arranged in the projected portion 58a, and underneath the slit plate 90 inside the wafer stage WST, lenses 84 and 86, and a mirror 88 is arranged in an identical positional relationship as in FIG. 2. In this case, however, within the wafer stage WST, a light guide 85 is also housed. The light entering end 85a of the light guide 85 is arranged at a position conjugate to the photo-detecting plane where the slit 22 is formed. In addition, the outgoing end 85b of the light guide 85 is arranged almost directly under the light transmittance lens 87, which is fixed to the upper surface of the projected portion 58b. Above the light transmittance lens 87, a photodetection lens 89 which diameter is larger than that of the light transmittance lens 87 is arranged. And further above the photodetection lens 89 at a position conjugate to the outgoing end 85b, an optical sensor 24 is arranged. The photodetection lens 89 and the optical sensor 24 are housed in a case 92 with the positional relationship described above maintained, and the case 92 is fixed to a fixed member (not shown in FIGS.).

With the aerial image measurement unit 59′ indicated in FIG. 3, on measuring the projected image (aerial image) of the measurement mark PM formed on the reticle R or the reticle mark plate RFM via the projection optical system PL, when the illumination light IL having passed through the projection optical system P1 illuminates the slit plate 90 that structure the aerial image measurement unit 591, the illumination light IL that has passed through the slit 22 on the slit plate 90 is incident on the light entering end 85a of the light guide 85 after passing through the lens 84, the mirror 88, and the lens 86. The light guided by the light guide 85 is guided out of the wafer stage WST via the light transmittance lens 87, after being emitted from the outgoing end 85b of the light guide 85. And the light guided outside the wafer stage WST is photo-detected by the optical sensor 24 via the photodetection lens 89, and the photoelectric conversion signals (light amount signals) from the optical sensor 24 corresponding to the photo-detected amount is sent to the main controller 20.

In this case, measurement of the projected image of the measurement marks is to be performed based on the slit-scan method, therefore, during this operation the photodetection lens 89 and the optical sensor 24 is to move with respect to the light transmittance lens 87. So, with the aerial image measurement unit 59′, the size of each lens is set so that all light having passed through the light transmittance lens 87, which moves within a predetermined range, is incident on the photodetection lens 89.

With the aerial image measurement unit 59′, a light guiding portion is structured to guide the light that has passed through the slit 22 out of the wafer stage WST by the slit plate 90, the lenses 84 and 86, the light guide 85, and the light transmittance lens 87. In this case, as well, the light guiding portion and the photodetection portion referred to earlier are mechanically separate. And the light guiding portion and the photodetection portion are optically connected via the light transmittance lens 87 and the photodetection lens 89 only when the aerial image measurement is performed. Accordingly, the heat generated by the optical sensor 24 does not have an adverse effect on the measurement precision and the like of the laser interferometer 31, and the driving accuracy of the wafer stage WST is also not adversely affected as in the case when the external portion and the internal portion of the wafer stage WST is connected with a light guide and the like.

As a matter of course, when the influence of heat can be excluded, the optical sensor 24 may be arranged within the wafer stage WST, like the aerial image measurement unit 59″ shown in FIG. 4. Incidentally, FIG. 3 and FIG. 4 show the state when the aerial image of the measurement mark PM on the reticle R is measured.

Details on the shape, size and the like of the slit 22 formed on the slit plate 90 structuring the aerial image measurement unit 59 (59′ or 59″), the aerial image measurement method using the aerial image measurement unit 59 (59′ or 59″), and the measurement method of the image forming characteristics will be described later in the description. In addition, the aerial image measurement unit 59, 59′, and 59″ will hereinafter be representatively referred to as the aerial image measurement unit 59, except when further distinction becomes necessary.

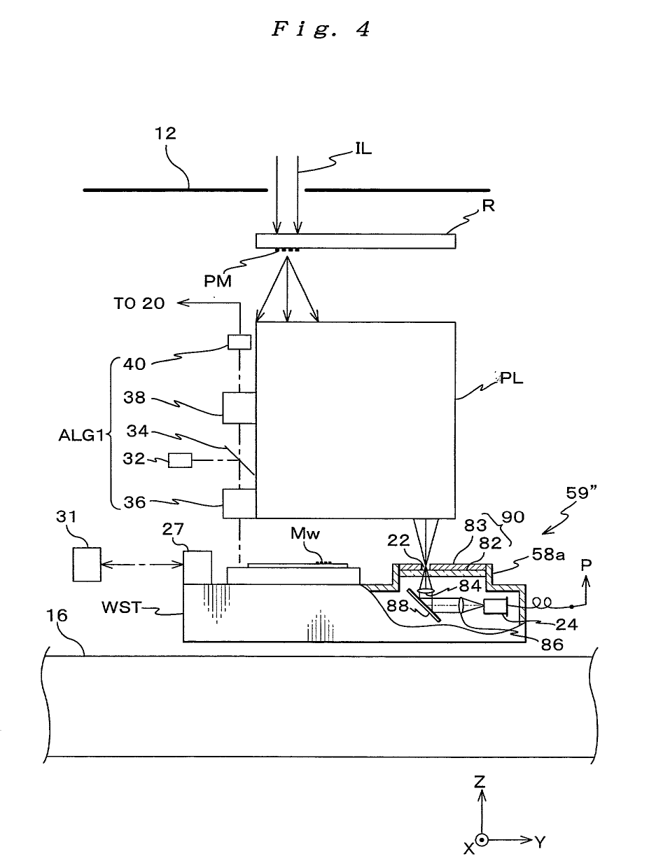

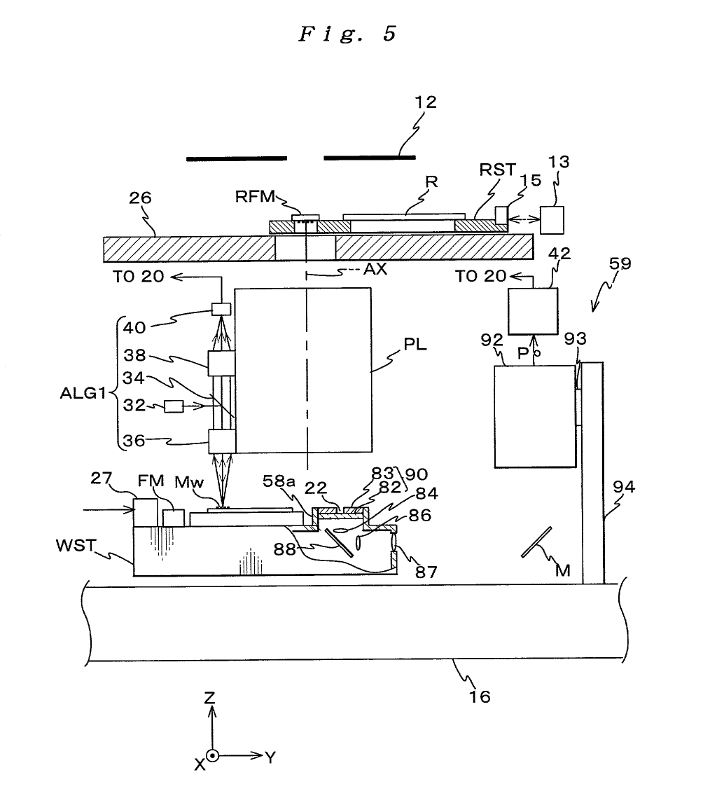

Referring back to FIG. 1, on the side surface of the projection optical system PL, an off-axis alignment system ALG1 serving as a mark detection system to detect the alignment marks on the wafer W is arranged. In this embodiment, as the alignment system ALG1, an alignment sensor based on the image processing method, or the so-called FIA (Field Image Alignment) system is used. As is shown in FIG. 2 to FIG. 4, the structure of the alignment system ALG1 includes an alignment light source 32, a half mirror 34, a first objective lens 36, a second objective lens 38, a pickup device (CCD) 40, and the like. As the alignment light source 32, a light source that emits a broadband illumination light such as a halogen lamp is used. With the alignment system ALG1, as is shown in FIG. 5, the illumination light emitted from the light source 32 illuminates the alignment mark Mw on the wafer W via the half mirror 34 and the first objective lens 36, and the light reflected off the alignment mark portion is photo-detected by the pickup device 40 via the first objective lens 36, half mirror 34, and the second objective lens 38. In this manner, the bright-field image of the alignment mark Mw is formed on the photodetection surface of the pickup device. And the photoelectric conversion signals corresponding to the bright-field image, in other words, the light intensity signals corresponding to the reflection image of the alignment mark Mw are sent to the man controller 20 via an alignment control unit (not shown in FIGS.). The main controller 20 then calculates the position of the alignment mark Mw with the detection center of the alignment system ALG1 as the reference based on the light intensity signals. It also calculates the coordinate position of the alignment mark Mw in the stage coordinate system set by the optical axis of the wafer interferometer 31, based on the calculation results on the position of the alignment mark Mw and the positional information on the wafer stage WST which is output from the wafer interferometer 31.

Furthermore, as is shown in FIG. 1, with the exposure apparatus 100 in this embodiment, it has a light source which on/off is controlled by the main controller 20, and a multiple focal position detection system (a focus sensor) based on the oblique incident method is arranged, consisting of an irradiation optical system 60a which irradiates light from an incident direction with respect to the optical axis AX to form multiple pinhole or slit images toward the image forming plane of the projection optical system PL, and of a photodetection optical system 60b which photo-detects the light reflected off the surface of the wafer W. By controlling the tilt of the plane-parallel plate arranged within the photodetection optical system 60b (not shown in FIGS.) with respect to the optical axis of the reflected light, the main controller 20 provides an offset corresponding to the focal change of the projection optical system PL to the focal detection system (60a, 60b) and performs calibration. Details on the structure of the multiple focal position detection system (a focus sensor) similar to the one used in the embodiment, are disclosed in, for example, Japanese Patent Laid Open No. 06-283403, and in the corresponding U.S. Pat. No. 5,448,332. As long as the national laws in designated states or elected states, to which this international application is applied, permit, the disclosures cited above are fully incorporated herein by reference.

The main controller 20 performs automatic focusing to substantially make the image forming plane of the projection optical system PL coincide with the surface of the wafer W within the illumination area of the illumination light IL (having an image forming relation with the illumination area IAR), in addition to automatic leveling. These are performed, by controlling the movement of the wafer stage WST using the multiple focal position detection system (60a, 60b). The multiple focal position detection system controls the movement of the wafer stage in the Z-axis direction via the wafer stage driving system (not shown in FIGS.) and the tilt in two-dimensional directions (that is, rotation in the θx and θy directions), so that the defocus becomes zero based on defocus signals from the photodetection optical system 60b such as the S-curve signals upon scanning exposure (to be described later).

Following is a brief description of the operations in the exposure process of the exposure apparatus 100 in this embodiment.

First of all, the reticle R is carried by a reticle carriage system (not shown in FIGS.) and is held by adsorption on the reticle stage RST waiting at the loading position. The main controller 20 then controls the position of the wafer stage WST and the reticle stage RST, measures the projected image (aerial image) of the reticle alignment marks (not shown in FIGS.) formed on the reticle R using the aerial image measurement unit 59 in the manner which will be described later on, and obtains the projection position of the reticle pattern image. That is, the reticle alignment is performed. The reticle alignment may also be performed, by observing the image of a pair of reticle alignment marks (not shown in FIGS.) on the reticle R and the image via the projection optical system PL of the fiducial mark for reticle alignment formed on the fiducial mark plate FM on the wafer stage WST at the same time with the pair of RA microscopes 28 previously referred to, and obtaining the projection position of the reticle pattern image based on the positional relationship of both mark images and the measurement values of the reticle interferometer 13 and the wafer interferometer 31 at that stage.

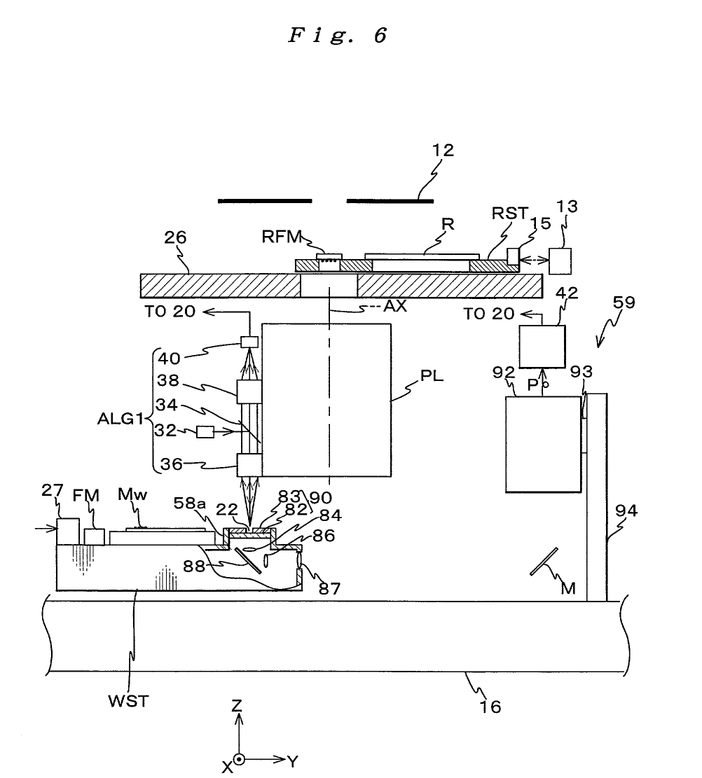

Next, the main controller 20 moves the wafer stage WST so that the slit plate 90 is positioned directly below the alignment system ALG1, where the alignment system ALG1 detects the position of the slit 22 (refer to FIG. 6), which is the positional datum of the aerial image measurement unit 59. The main controller 20 obtains the positional relationship between the projection position of the pattern image of the reticle R and the alignment system ALG1 based on the detection signals of the alignment system ALG1, the measurement values of the wafer interferometer 31 in this state, and the projection position of the reticle pattern image previously obtained. In other words, the baseline amount of the alignment system ALG1 is obtained.

When such baseline measurement is completed, the main controller 20 performs wafer alignment such as EGA (Enhanced Global Alignment), which details are disclosed in, for example, Japanese Patent Laid Open No. 61-44429, and in the corresponding U.S. Pat. No. 4,780,617, and the position of all the shot areas on the wafer W is obtained. Upon this wafer alignment, of the plurality of shot are as on the wafer W, the wafer alignment mark Mw of a predetermined sample shot decided in advance is measured in the manner described earlier (refer to FIG. 5) with the alignment system ALG1. Incidentally, as long as the national laws in designated states or elected states, to which this international application is applied, permit, the disclosures cited above are fully incorporated herein by reference.

The main controller 20 then sets the reticle stage RST to the scanning starting position and also sets the wafer stage WST to the scanning starting position (acceleration starting position) to expose the first shot area, based on the positional information on each shot area on the wafer W and the baseline amount obtained above while monitoring the positional information sent from the interferometers 31 and 13.

That is, the main controller 20 starts the relative scanning in opposite directions between the reticle stage RST and the wafer stage WST along the Y-axis, and when both stages RST and WST respectively reach their target scanning velocities, the illumination light IL starts to illuminate the pattern area of the reticle R, thus scanning exposure begins. Prior to this scanning exposure, the light source starts emitting light, however, since the main controller 20 controls the movement of each blade of the movable reticle blind 12 in synchronous with the movement of the reticle stage RST, irradiation of the exposure light EL on areas other than the pattern area on the reticle R can be prevented likewise with the scanning steppers in general.

The main controller 20 synchronously controls the reticle stage RST and the wafer stage WST so that especially during the scanning exposure described above, the movement velocity Vr in the Y-axis direction of the reticle stage RST and the movement velocity Vw in the Y-axis direction of the wafer stage WST are maintained at a velocity ratio which corresponds to the projection magnification of the projection optical system PL.

Then, different areas in the pattern area of the reticle R are sequentially illuminated with the illumination light IL, and by completing illumination of the entire pattern area, scanning exposure on the first shot area on the wafer W is consequently completed. In this manner, the circuit pattern of the reticle R is reduced and transferred onto the first shot area via the projection optical system PL.

When exposure on the first shot area is completed in this manner, stepping operation is performed to move the wafer stage WST to the scanning starting position (acceleration starting position) for exposure on the second shot area. And scanning exposure is similarly performed as above on the second shot area. From then onward, on and after the third shot area, the same operation is performed.

Thus, the stepping operation in between shot areas and the scanning exposure operation on the shot area are repeatedly performed, and the pattern of the reticle R is transferred onto all the shot areas on the wafer W by the step-and-scan method.

During the scanning exposure described above, automatic focusing and automatic leveling which were referred to earlier is performed, using the focus sensor (60a, 60b) integrally fixed to the projection optical system PL.

In order to accurately overlay the pattern of the reticle R onto the pattern already formed on the shot area on the wafer W during the scanning exposure described above, it is important for the optical properties (including the image forming characteristics) of the projection optical system PL and the baseline amount to be accurately measured, and the optical properties of the projection optical system PL to be adjusted to a desired state.

In this embodiment, the aerial image measurement unit 59 referred to earlier is used to measure the optical properties. The aerial image measurement by the aerial image measurement unit 59 and the measurement of the optical properties of the projection optical system PL will now be described in detail.

FIG. 2 shows a state where the aerial image of the measurement mark PM formed on the reticle mark plate RFM is being measured using the aerial image measurement unit 59. As is shown in FIG. 3 and FIG. 4, instead of using the reticle mark plate RFM, it is possible to use a reticle made solely for aerial image measurement, or a reticle R used for manufacturing a device that has the measurement mark PM only for measurement formed on the reticle.

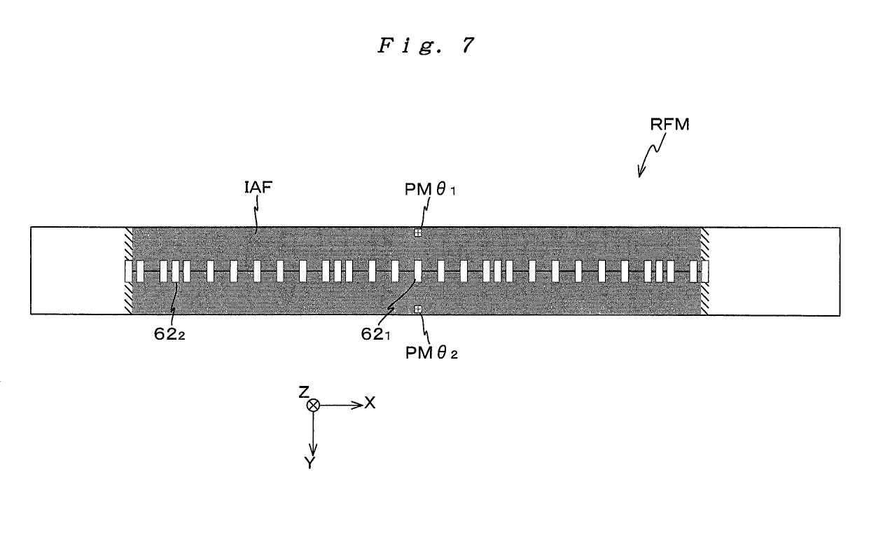

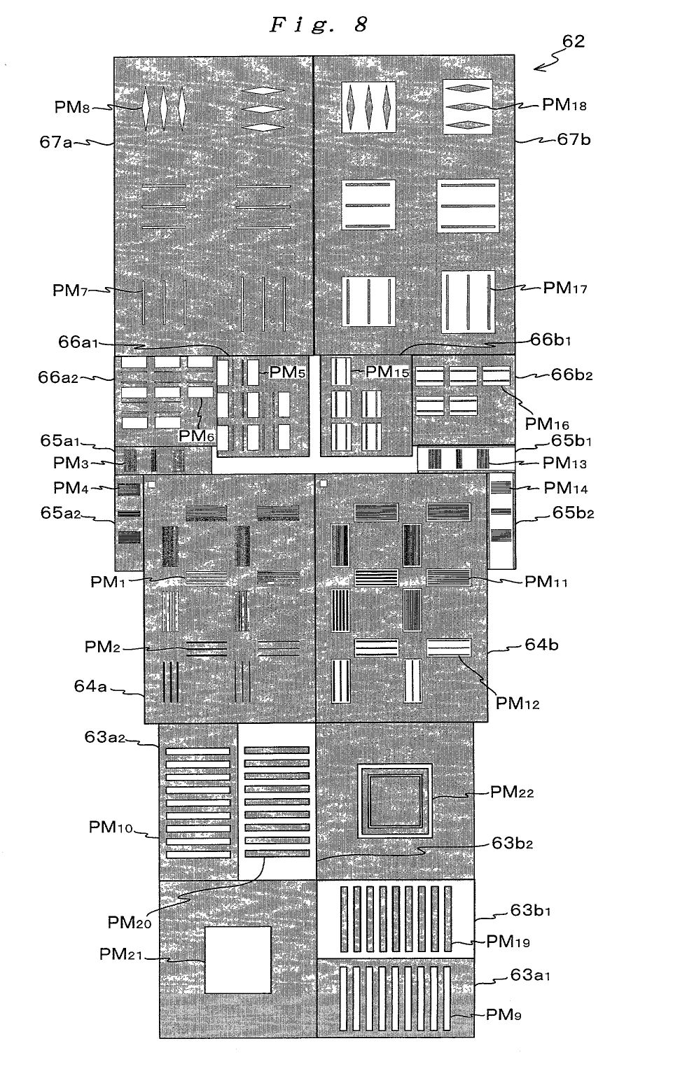

Before going onto the description of aerial image measurement, the reticle mark plate RFM will be described based on FIG. 7 and FIG. 8.

FIG. 7 is an extracted view of the reticle mark plate RFM, which is fixed on the reticle stage RST. FIG. 7 corresponds to a bottom view of FIG. 1.

The length of the reticle mark plate RFM is, for example, approximately 16 mm (4 mm on the wafer, in the case the projection magnification is ¼) in the Y-axis direction (scanning direction) and approximately 150 mm in the X-axis direction (non-scanning direction). The area around 100 mm (25 mm on the wafer, in the case the projection magnification is ¼) in the center of the reticle mark plate RFM in the non-scanning direction, excluding the edges, is the effective irradiation area IAF where the illumination light IL can irradiate. On both edges of the effective irradiation area IAF (the area indicated by the oblique lines) in the X-axis direction, reticle alignment marks (not shown in FIGS.) are formed that can be observed by the pair of RA microscopes 28.

In addition, on both edges in the Y-axis direction in the center of the effective irradiation area IAF in the X-axis direction, a glass portion (removed area) around 1 mm square in size where other marks cannot be formed are arranged, and within the removed areas, rotation adjustment marks PMθ₁ and PMθ₂ are formed of chromium and the like. Also, around the center portion of the Y-axis direction of the effective irradiation area IAF, a plurality of AIS mark blocks 62₁ are arranged along in the X-axis direction at a predetermined interval, for example, of 4 mm (1 mm on the wafer, in the case the projection magnification is ¼). And other than the AIS mark blocks 62₂ arranged at an interval of 4 mm, AIS mark blocks 62₂ are arranged at positions capable of being set as a detection point within the effective field of the projection optical system PL that correspond to the irradiating point of the image forming light of the multiple focal position detection system (60a, 60b). Therefore, in this embodiment, when performing for example, measurement of the image plane shape of the projection optical system PL, or measurement for calibration to set the offset with respect to the output of each sensor of the multiple focal position detection system (60a, 60b) or to re-set the origin position (detection base position) and the like by aerial image measurement, it becomes possible to measure the position in the optical axis direction (Z position) of the projection optical system PL with the center of the slit 22 of the slit plate 90. Accordingly, the plane accuracy of the slit plate 90 can be moderately set. Hereinafter, the AIS mark blocks 62₁ and the AIS mark blocks 622 will be referred to as AIS mark blocks 62 without any distinction, except for cases when necessary.

On the reticle mark plate RFM, only one line of the AIS mark blocks 62 is arranged in the scanning direction (Y-axis direction). In the case of performing aerial image measurement, however, with each point of the projection optical system PL in the scanning direction serving as the detection point, the measurement can be performed by moving the reticle stage RST.

An example of the mark arrangement within each AIS mark block 62 will be described next, based on FIG. 8. FIG. 8 shows an enlarged view of the AIS mark block 62. As is shown in FIG. 8, within the AIS mark block 62, negative type alignment mark sub-blocks 63a₁ and 63a₂, positive type alignment mark sub-blocks 63b₁ and 63b₂, a negative type lines and spaces mark sub-block 64a, a positive type lines and spaces mark sub-block 64b, a negative type sequential coma mark sub-block 65a₁ and 65a₂, a positive type sequential coma mark sub-block 65b₁ and 65b₂, negative type linear box mark sub-blocks 66a₁ and 66a₂, positive type linear box mark sub-blocks 66b₁ and 66b₂, a negative type additional mark sub-block 67a, a positive type additional mark sub-block 67b, and the like are arranged. Hereinafter, lines and spaces will be shortened to L/S.

Within the negative type L/S mark sub-block 64a, a negative mark PM₁ made up of L/S marks with a 1:1 duty ratio having a line width, for example, from 0.4 μm to 4.0 μm, is arranged. A negative mark, here, means a mark consisting of an aperture pattern formed on the chromium layer. Besides the negative mark PM₁, a negative mark PM₂ for measuring abnormal line width serving as an applied measurement mark is arranged within the negative type L/S marks sub-block 64a. The negative mark PM₂ for measuring abnormal line width is a negative mark made up of L/S marks with a 1:1 duty ratio having a line width, for example, from 0.4 μm to 0.8 μm, arranged in a pitch of 80 μm. The period directions of the L/S marks arranged, are the X-axis direction and the Y-axis direction. In this description, when the term “duty ratio” is used when referring to the ratio of the line portion width and the pitch (period) of the L/S patterns, it is to be indicated by percentage (%), whereas in the case of using the term “duty ratio” when referring to the ratio of the line portion width and the space portion width, it is to be indicated by proportion (for example, 1:1).

Within the negative type sequential coma mark sub-block 65a₁, a negative mark PM₃ made up of L/S marks with a 1:1 duty ratio having a different line width which period direction is in the X-axis direction, is arranged at a constant interval. And within the negative type sequential coma mark sub-block 65a₂, a negative mark PM₄ made up of L/S marks with a 1:1 duty ratio having a different line width which period direction is in the Y-axis direction, is arranged at a constant interval.

Within the negative type linear box mark sub-block 66a, a negative mark PM₅ made up of linear marks that have a wide line pattern, for example, with a line width of around 40 μm, and a thin line pattern, for example, with a line width of around 0.4 to 0.56 μm, is arranged at a predetermined interval (for example, around 40 m) in the X-axis direction. In addition, in the negative type linear box mark sub-block 66a₂, a negative mark PM₆ that has an arrangement identical to the negative mark PM₅, except for being arranged in the Y-axis direction, is arranged.

Within the negative type additional mark sub-block 67a, an artificial isolated line mark PM₇ made up of L/S marks with a duty ratio other than 1:1 such as 1:9 having various line widths, a cuneiform mark (SMP mark) PM₈, and negative marks of other isolated lines and the like are arranged. These marks, PM₇ and PM₈, are also respectively arranged in the X-axis direction and the Y-axis direction.

Within the negative type alignment mark sub-block 63a₁, a negative mark (FIA mark) PM₉ made up of, for example, L/S marks with a 1:1 duty ratio having a line width of 24 μm which period direction is in the X-axis direction, is arranged. In addition, within the negative type alignment mark sub-block 63a₂, a negative mark (FIA mark) PM₁₀ made up of, for example, L/S marks with a 1:1 duty ratio having a line width of 24 μm which period direction is in the Y-axis direction, is arranged.

Within the positive type L/S mark sub-block 64b, a positive mark PM₁, made up of L/S marks with a 1:1 duty ratio having a line width, for example, from 0.4 μm to 4.0 μm, is arranged. A positive mark, here, means a mark formed by a pattern made of chromium within the glass portion (removed area) of a predetermined area, where other marks cannot be formed. Besides the positive mark PM₁, a positive mark PM₁₂ for measuring abnormal line width serving as an applied measurement mark is arranged within the positive type L/S mark sub-block 64b. The period directions of the L/S marks arranged, are the X-axis direction and the Y-axis direction.

Within the positive type sequential coma mark sub-block 65b₁, a positive mark PM₁₃ made up of L/S marks with a 1:1 duty ratio having a different line width which period direction is in the X-axis direction, is arranged at a constant interval. And within the positive type sequential coma mark sub-block 65b₂, a positive mark PM₁₄ made up of L/S marks with a 1:1 duty ratio having a different line width which period direction is in the Y-axis direction, is arranged at a constant interval.

Within the positive type linear box mark sub-block 66b₁, a positive mark PM₁₅ made up of linear marks that have a wide line pattern, for example, with a line width of around 40 μm, and a thin line pattern, for example, with a line width of around 0.4 to 0.56 μm, is arranged at a predetermined interval (for example, around 40 μm) in the X-axis direction. In addition, in the positive type linear box mark sub-block 66b₂, a positive mark PM₁₆ that has an arrangement identical to the positive mark PM₁₅, except for being arranged in the Y-axis direction, is arranged.

Within the positive type additional mark sub-block 67b, an artificial isolated line mark PM₁₇ made up of L/S marks with a duty ratio other than 1:1 such as 1:9 having various line widths, a cuneiform mark (SMP mark) PM₁₈, and positive marks of other isolated lines and the like are arranged. These marks, PM₁₇ and PM₁₈, are also respectively arranged in the X-axis direction and the Y-axis direction.

Within the positive type alignment mark sub-block 63b₁, a positive mark (FIA mark) PM₁₉ made up of, for example, L/S marks with a 1:1 duty ratio having a line width of 24 μm which period direction is in the X-axis direction, is arranged. In addition, within the positive type alignment mark sub-block 63b₂, a positive mark (FIA mark) PM₂₀ made up of, for example, L/S marks with a 1:1 duty ratio having a line width of 24 μm which period direction is in the Y-axis direction, is arranged.

Besides these marks, within the AIS mark block 62, marks such as a negative mark (BOX mark) PM₂₁ consisting of a square mark which size is 120 square μm (30 μm on the wafer, in the case the projection magnification is ¼), a Line in Box mark PM₂₂ (this will be referred to later) are also arranged.

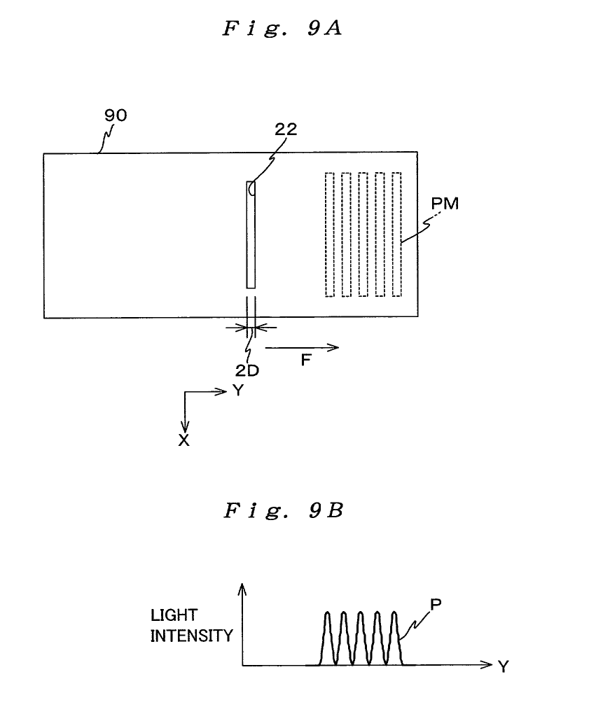

The method of measuring an aerial image using the aerial image measurement unit 59 will now be briefly described. As a premise, as is shown in FIG. 9A, the slit 22 that has a predetermined width 2D and extends in the X-axis direction is to be formed on the slit plate 90.

When the aerial image is measured, the main controller 20 drives the movable reticle blind 12 via the blind driving unit (not shown in FIGS.), and the illumination area IL of the illumination light IL to the reticle mark plate RFM (or the reticle R) is restricted only to the predetermined area including the measurement mark PM, as is shown in FIG. 2. As the measurement mark PM, L/S marks that have a duty ratio of 1:1 cyclical in the Y-axis direction are to be used, such as the mark PM₁ referred to earlier in the description.

In this state, when the illumination light IL is irradiated on the reticle mark plate RFM, the light diffracted and scattered by the measurement mark PM is refracted by the projection optical system PL as is shown in FIG. 2, and the aerial image (projected image) PM′ of the measurement mark PM is formed on the image plane of the projection optical system PL. At this point, the wafer stage WST is to be positioned so that the aerial image PM′ is formed on the +Y side (or the −Y side) of the slit 22 on the slit plate 90 of the aerial image measurement unit 59. FIG. 9A is a planar view of the slit plate 90 in such a state.

And, when the main controller 20 drives the wafer stage WST in the +Y direction via the wafer driving system, as is indicated with the arrow F in FIG. 9A, the slit 22 is scanned in the Y-axis direction with respect to the aerial image PM′. During this scanning, the light (illumination light IL) which passes through the slit 22 is photo-detected by the optical sensor 24 via the light guiding portion within the wafer stage WST, mirror M, and the photodetection lens 89 (in the case of FIG. 4, lens 84 and 86), and the photoelectric conversion signals are sent to the main controller 20 via the signal processing circuit 42. The main controller 20 then measures the light intensity distribution corresponding to the aerial image PM′, based on the photoelectric conversion signals.

FIG. 9B shows and example of a photoelectric conversion signal (light intensity signal) P that can be obtained on the aerial image measurement described above.

In this case, the image of the aerial image PM′ averages, due to the influence of the width (2D) of the slit 22 in the scanning direction (Y-axis direction).

Accordingly, when the slit is expressed as p(y), the intensity distribution of the aerial image as i(y), and the observed light intensity signal as m(y), the intensity distribution i(y) can be expressed as follows, as in equation (1). In equation (1), the unit of the intensity distribution i(y) and the observed light intensity signal m(y) is the intensity per unit length.

$$\begin{matrix}m ( y ) = {\int }_{- ∞}^{∞} p ( y - u ) \cdot i ( u ) ⅆ u & ( 1 ) \\ p ( y ) = \{ \begin{matrix}1 ( \vert y \vert \leq D ) \\ 0 ( \vert y \vert > D )\end{matrix} & ( 2 )\end{matrix}$$

That is, the observed light intensity signal m(y) is a convolution of the slit p (y) and the intensity distribution of the aerial image i(y).

Accordingly, it is better for the width of the slit 2D in the scanning direction (hereinafter simply referred to as “slit width”) to be narrower, from the aspect of measurement precision.

The inventor (Hagiwara) repeatedly performed various simulations and experiments, expressing the slit width 2D using the wavelength λ of the illumination light IL and the function f (λ/N.A.) of the numerical aperture of the projection optical system PL. As a result, it was confirmed that in the case the slit width 2D is 2D=n·(λ/N.A.) and the coefficient also n=<l, the experiment proved to be sufficiently practical, and especially when the coefficient is n=<0.8, proved to be more practical. “Practical”, in this case, means that deterioration of the image profile is small when converting the aerial image into the aerial image intensity signal, therefore, the signal processing system arranged after the optical sensor 24 (photoelectric conversion element) does not require a dynamic range and a sufficient precision can be acquired.

An example of the favorable result described above, is shown, for example, in the following Table 1.

TABLE 1

| Wavelength | Numerical Aperture | (A) Wavelength/N.A | |
|---|---|---|---|
| (nm) | of projection lens | of projection lens | B = A × 0.8 |
| 248 | 0.68 | 364 | 291 |
| 248 | 0.75 | 331 | 264 |
| 193 | 0.65 | 297 | 238 |
| 193 | 0.75 | 257 | 206 |
| 193 | 0.85 | 227 | 182 |

As can be seen from Table 1, the substantial slit width (aperture size: Bin Table 1) differs depending on the numerical aperture and the wavelength, however, the appropriate value is generally 300 nm and under. Silts of this range can be made using the chromium reticle (also called mask blanks) on the market.

A chromium reticle usually has a thick chromium layer of around 100 nm formed on a quartz substrate by vapor deposition. The standard thickness of a quartz substrate is 2.286 mm, 3.048 mm, 4.572 mm, or 6.35 mm.

The slit width 2D is better when narrower, as is described earlier in the description, and in the case when a photo multiplier tube (PMT) is used as the optical sensor 24, it is possible to detect the light amount (light intensity) by decreasing the scanning velocity and taking time for measurement. In actual, however, since the scanning velocity of the aerial image measurement has fixed limitations from the aspect of throughput, if the slit is too narrow the light amount transmitting the slit 22 decreases too much, thus measurement becomes difficult.

From the information the inventor (Hagiwara) acquired by simulations and experiments, the optimum value of the slit width 2D was confirmed to be around half the limit of resolution pitch (pitch of the L/S patterns) of the exposure apparatus. The details on this will be described later.

As is obvious from the description so far, in this embodiment, the aerial image measurement unit is made up of the illumination system 10, the aerial image measurement unit 59 (including the slit plate 90 and the optical sensor 24), the wafer stage WST, and the main controller 20. In addition, the processing unit, which is a part of the aerial image measurement unit, is configured of the main controller 20.

The aerial image measurement unit and the aerial image measurement method is used, for example, on a. detecting the best focal position, b. detecting the image forming position of the pattern image, and c. baseline measurement of the alignment system ALG1.

Hereinafter, on the slit plate 90 structuring the aerial image measurement unit 59, a slit 22a having a predetermined width 2D and a length L that extends in the X-axis direction, and a slit 22b having a predetermined width 2D and a length L that extends in the Y-axis direction are to be formed, as is shown in FIG. 10. The width 2D, for example, is 0.3 μm, and the length L 16 μm. And the slit 22b is arranged around 4 μm apart from the slit 22a on the −X side as well as around 4 μm apart on the +Y side. In addition, the optical sensor 24 is to be capable of photo-detecting the light that passes through the slits 22a and 22b via the light guiding portion within the wafer stage WST, mirror M, and the photodetection lens. The slit 22a and slit 22b are hereinafter to be generally referred to as slit 22 without distinction, except when necessary.

Since item c. baseline measurement of the exposure apparatus 100 in this embodiment has already been explained, following will be a description of item a. detecting the best focal position and item b. detecting the image forming position of the pattern image, referring to working examples.

Detection of the Best Focal Position

This detection of the best focal position is used for purposes such as: A. detecting the best focal position of the projection optical system PL and detecting the best image forming plane (image plane), and B. the spherical aberration measurement.

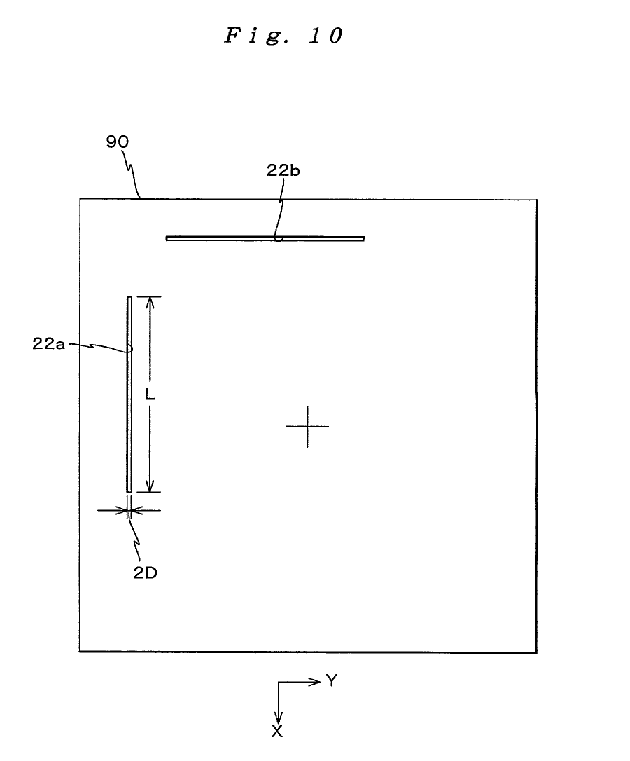

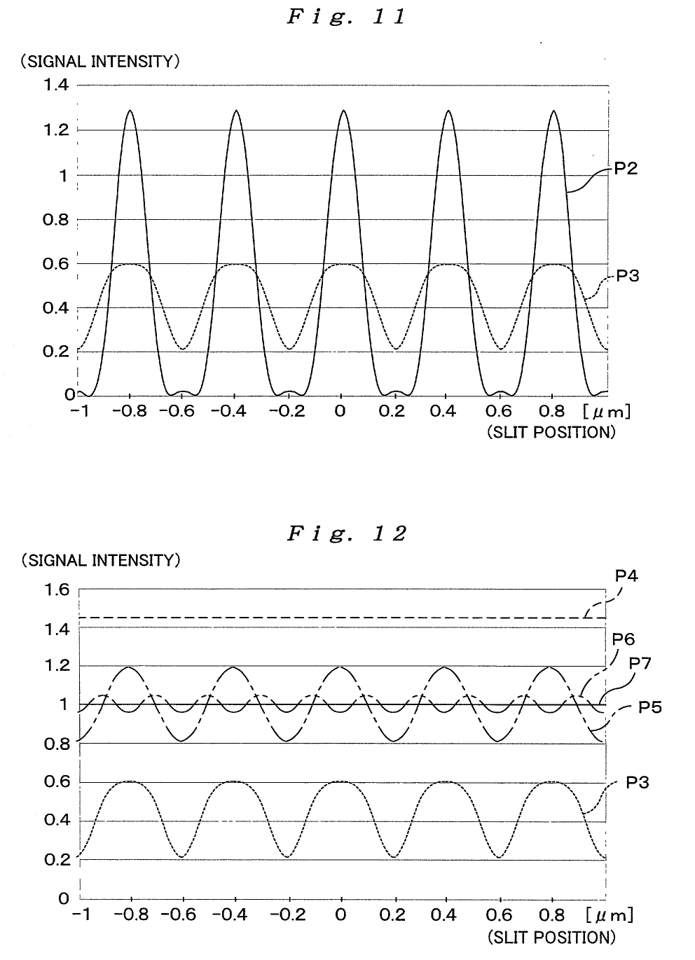

FIG. 11 to FIG. 16 show the image forming simulation results that correspond to the case when an aerial image of a L/S mark having a 50% duty ratio and a line width of 0.2 μm measured with the aerial image measurement method described above. The conditions of this simulation are; illumination light wavelength 248 nm, numerical aperture of the projection optical system 0.68, illumination coherence factor σ=0.85, and the slit width 2D=0.3 μm. These conditions are close to the conditions B in Table 1. In FIG. 11 to FIG. 16, the horizontal axis shows the Y position (μm) of the slit, and the vertical axis shows the light intensity (energy value).

FIG. 11 shows the simulation results at the best focal position. In FIG. 11, the waveform P2 indicated by the solid line is an aerial image of L/S marks with the line width of 0.2 μm, which corresponds to i(y) in equation (1). The waveform P3 indicated by the dotted line is the light intensity signal obtained by scanning the slit (aerial image measurement) that correspond to m(y) in equation (1).

FIG. 12 shows the aerial frequency component when Fourier Transform is performed on the intensity signal P3 in FIG. 11, that is, on m(y), along with the original intensity signal P3. In FIG. 12, the waveform P4 indicated by the broken line is a zero order frequency component, whereas, the waveform P5 indicated by the dashed-dotted line is a first order frequency component, the waveform P6 indicated by the dashed-double-dotted line is a second order frequency component, and the waveform P7 indicated by the solid line is a third order frequency component. In FIG. 12, waveforms P4 to P7 are shown raised by 1.0, so that they are made distinguishable.

FIG. 13 shows the simulation results when the position is defocused by 0.2 μm from the best focal position. In FIG. 13, the waveform P2 indicated by the solid line is an aerial image of L/S marks with the line width of 0.2 μm, which corresponds to i (y) in equation (1), and the waveform P3 indicated by the dotted line is the light intensity signal obtained by scanning the slit (aerial image measurement) that correspond to m(y) in equation (1).

FIG. 14 shows the aerial frequency component when Fourier Transform is performed on the intensity signal P3 in FIG. 13, along with the original intensity signal P3. In FIG. 14, the waveform P4 indicated by the broken line is a zero order frequency component, whereas, the waveform P5 indicated by the dashed-dotted line is a first order frequency component, the waveform P6 indicated by the dashed-double-dotted line is a second order frequency component, and the waveform P7 indicated by the solid line is a third order frequency component. In FIG. 14, waveforms P4 to P7 are shown raised by 1.0, so that they are made distinguishable.

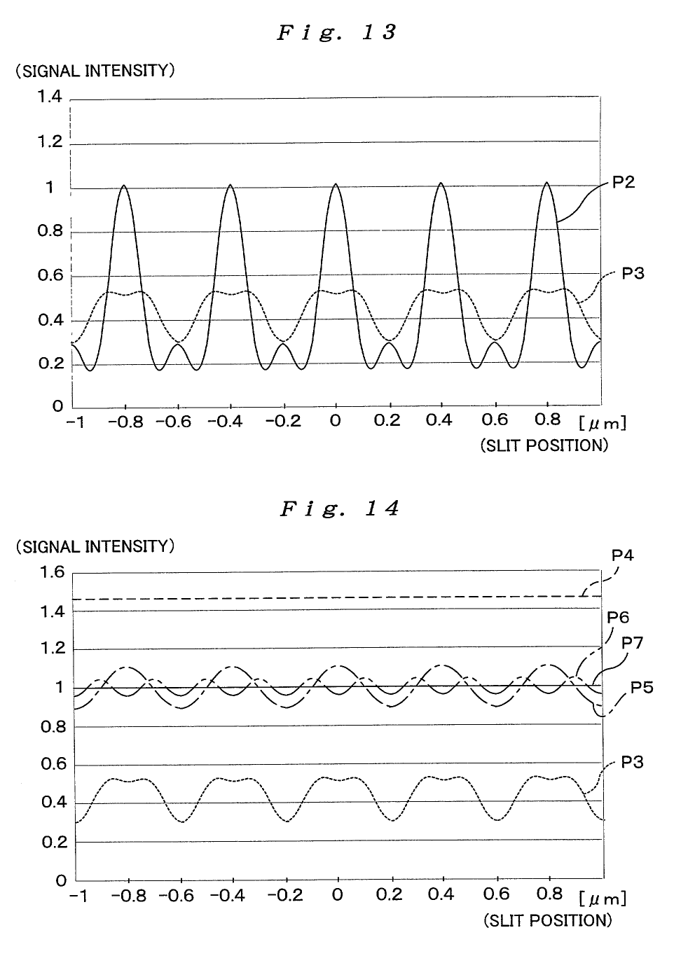

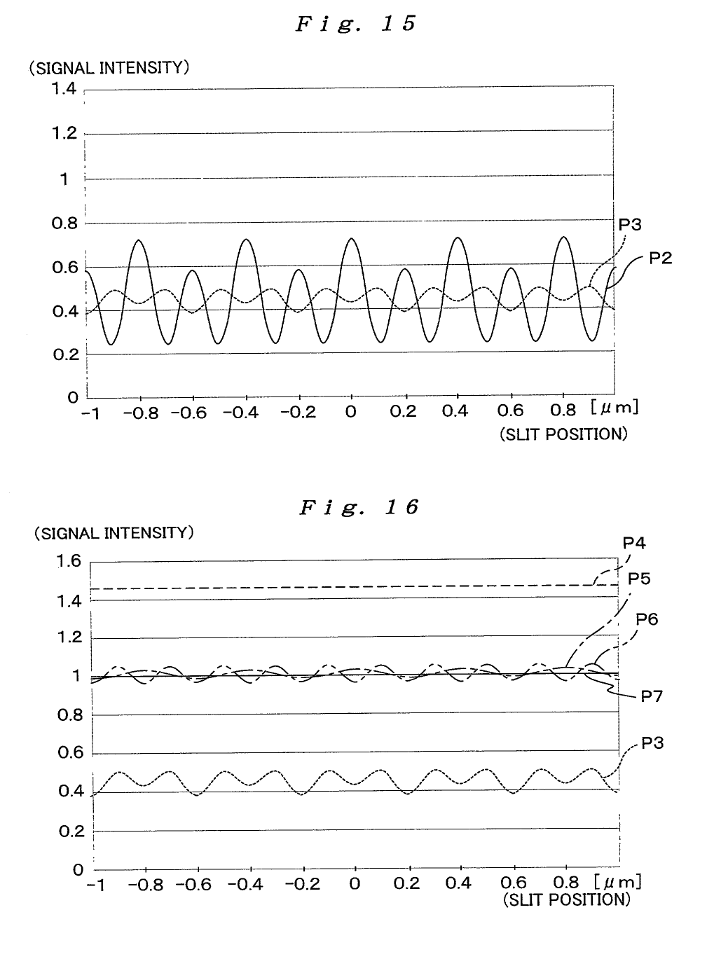

FIG. 15 shows the simulation results when the position is defocused by 0.3 μm from the best focal position. In FIG. 15, the waveform P2 indicated by the solid line is an aerial image of L/S marks with the line width of 0.2 μm, which corresponds to i (y) in equation (1), and the waveform P3 indicated by the dotted line is the light intensity signal obtained by scanning the slit (aerial image measurement) that correspond to m(y) in equation (1).

And, FIG. 16 shows the aerial frequency component when Fourier Transform is performed on the intensity signal P3 in FIG. 15, along with the original intensity signal P3. In FIG. 16, the waveform P4 indicated by the broken line is a zero order frequency component, whereas, the waveform P5 indicated by the dashed-dotted line is a first order frequency component, the waveform P6 indicated by the dashed-double-dotted line is a second order frequency component, and the waveform P7 indicated by the solid line is a third order frequency component. In FIG. 16, waveforms P4 to P7 are shown raised by 1.0, so that they are made distinguishable.

As is obvious when comparing FIG. 11 and FIG. 13, the shape of the image is obviously ruined due to the defocus of 0.2 μm. In addition, when comparing FIG. 13 and FIG. 15, it can be seen that the shape of the image is obviously further ruined when the defocus amount increases.

In addition, when the light intensity signal P3 is divided into a frequency component as is described above, various signal processing can be easily performed. For example, when focusing on contrast, which is the amplitude ratio of the first order frequency component P5 and the zero order frequency component P4, in other words, the first order/zero order amplitude ratio, the contrast in the case of the best focal position as is shown in FIG. 12, is 0.43. Also, the contrast in the case of defocus by 0.2 μm from the best focal position as is shown in FIG. 14, is 0.24. And, the contrast in the case of defocus by 0.3 μm from the best focal position as is shown in FIG. 16, is 0.047.

As can be seen, the contrast, which is the first order/zero order amplitude ratio, changes sensitively depending on the focus position; therefore, it is convenient to set the best focal position from the intensity signal. That is, it is possible to detect the best focal position, by obtaining the focus position where the contrast being the first order/zero order amplitude ratio is at a maximum.

Thus, in this embodiment, the best focal position of the projection optical system PL is detected in the following manner.

On detecting the best focal position, L/S marks with a duty ratio of 1:1 on the reticle mark plate RFM (or on the reticle R), such as the L/S negative mark PM₁ that has a line width of 0.8 μm (line width of 0.2 μm on the wafer) arranged within the AIS mark block 62₁ located in the center along the X-axis direction on the reticle mark plate RFM, are used as the measurement mark PM. The detection of the best focal position, is to be performed under the same conditions as the simulation described above.

First of all, the main controller 20 moves the reticle stage RST so that the measurement mark PM on the reticle mark plate RFM is positioned at a predetermined point to measure the best focal position within the effective field (corresponding to the illumination area IAR) of the projection optical system PL.

In the case of performing aerial image measurement of a mark on the reticle R, to begin with, the reticle loader (not shown in FIGS.) loads the reticle R onto the reticle stage RST. The main controller 20 then moves the reticle stage RST so as to make the measurement mark PM on the reticle R almost coincide with the optical axis of the projection optical system PL.

Next, the main controller 20 controls and drives the movable reticle blind 12 so as to limit the illumination area and the illumination light IL is irradiated only on a predetermined area including the measurement mark PM portion. In this state, the main controller 20 irradiates the illumination light IL onto the measurement mark PM, and as is described earlier, the aerial image measurement of the measurement mark PM is performed similarly as above, based on the slit-scan method while scanning the wafer stage WST in the Y-axis direction.

The main controller 20 repeats the aerial image measurement a plurality of times, while changing the Z-axis position of the slit plate 90 (that is, the Z position of the wafer stage WST) in predetermined steps, and stores the light intensity signal (photoelectric conversion signal) each time in memory.

Then, the main controller 20 calculates a predetermined evaluation amount based respectively on the plurality of light intensity signals (photoelectric conversion signals) obtained by the repeated measurements, such as the contrast, which is the amplitude ratio of the first order frequency component and the zero order frequency component of the plurality of light intensity signals that are respectively Fourier transformed. And, the main controller 20 detects the Z position of the wafer stage WST (that is, the position of the slit plate 90 in the Z-axis direction) that corresponds to the light intensity signal where the contrast becomes maximum, and sets the position as the best focal position of the projection optical system PL. As is previously described, since the contrast changes sensitively according to the focus position, the best focal position of the projection optical system PL can be accurately and easily measured (set).

The amplitude of the frequency component of a high order, in the second order and above, is small in general, therefore, there are some cases when the amplitude with respect to electrical noise and optical noise cannot be sufficiently detected. If there is no problem in the S/N (signal/noise) ratio, however, the best focal position can be obtained also by observing the amplitude ratio of the frequency component of the high order. The L/S mark, which is the measurement mark, is preferably a pattern with an equal line and space width having a duty ratio of 1:1, but it is possible to use other marks that have a duty ratio other than 1:1. According to the information obtained by the inventor (Hagiwara) from the results of experiments and the like, it has become clear that preferable results can be obtained when the arrangement period of the line pattern of the L/S marks, in other words, the mark pitch P_{M} is about the level of the following equation (3).

PM=λ/N.A.×(1˜1.2) (3)

As the evaluation amount referred to above, other than the contrast, the wave height value, the amplitude or area ratio of a sinusoidal wave which period is the mark pitch, or the Z position (focus position) where the differential value of the light intensity signal P (m(y) in equation (1) ) is maximum, can be used. In all cases, the position of the slit plate 90 in the Z-axis direction (Z coordinate) at the peak of these evaluation amounts can be set as the best focal position.

Similar to the contrast described above, since the wave height value, the amplitude or area ratio of a sinusoidal wave which period is the mark pitch, and the like change according to the focus position (defocus amount), the best focal position of the projection optical system PL can be accurately and easily measured (set).

As the measurement marks used for measuring the best focal position, an isolated line or an artificial isolated line having a pitch ten times the line width can be used, for example, the mark PM₇ described earlier, other than the L/S mark having a duty ratio of 1:1 referred to above.

A concrete example on the detection of the best focal position will be referred to later in the description.

In addition, the detection of the image plane shape of the projection optical system PL can be performed in the following manner.

To begin with, the case using the reticle mark plate RFM will be described. In this case, the main controller 20 first of all moves the reticle stage RST, so that measurement marks such as the measurement mark PM₁ arranged within each AIS mark block 62 on the reticle mark plate RFM are arranged at a plurality of points within the effective field of the projection optical system PL.

The main controller 20 then limits the illumination area with the movable reticle blind 12 so that the illumination light IL irradiates only a predetermined area that includes the measurement mark PM₁ at each point. The illumination light IL is sequentially irradiated onto each measurement mark PM₁, and the best focal position is detected at each point in the manner previously described. The detection results are stored in the memory unit.

Then, the main controller 20 moves the reticle stage RST so that measurement marks such as the measurement mark PM₁ arranged within each AIS mark block 62 on the reticle mark plate RFM are arranged at a different plurality of points within the effective field of the projection optical system PL. The best focal position is likewise detected at each point, and the detection results are stored in the memory unit.

And the main controller 20 calculates the image plane shape of the projection optical system PL by performing a predetermined statistical process based on each best focal position obtained. In this case, besides the image plane shape, the field curvature may also be calculated. The plurality of measurement marks do not necessarily have to be used on measuring the image plane shape, and the measurement of the best focal position described above may be repeatedly performed, for example, while sequentially moving a single measurement mark to a plurality of detection points within the effective field of the projection optical system PL.

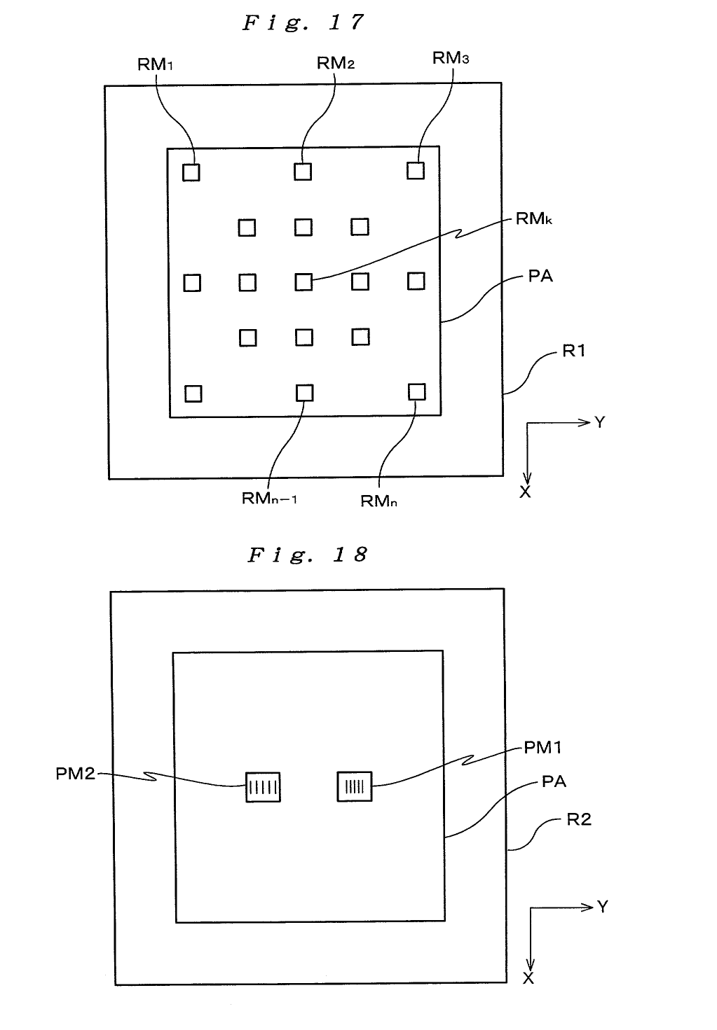

In addition, in the case of detecting the image plane shape using a reticle, a measurement reticle R1 on which measurement marks RM₁ to RM₁ that have the same size and same period as the measurement marks PM are formed within the pattern area PA is used, as is shown as an example in FIG. 17.

Firstly, the reticle R1 is loaded onto the reticle stage RST by the reticle loader (not shown in FIGS.). The main controller 20 then moves the reticle stage RST, so that the measurement mark RMₖ located at the center of the reticle R1 almost coincides with the optical axis of the projection optical system PL. And, the main controller 20 drives and controls the movable reticle blind 12 so that the illumination light IL is irradiated only on the portion of the measurement mark RM₁ and sets the illumination area. In this state, the main controller 20 irradiates the illumination light IL on the reticle R1, and likewise with the previous description, aerial image measurement of the measurement mark RM₁ and detection of the best focal position of the projection optical system PL are performed using the aerial image measurement unit 59 based on the slit-scan method, and the results stored in the internal memory unit.

When the detection of the best focal position using the measurement mark RM₁ is completed, the main controller 20 then drives and controls the movable reticle blind 12 to set the illumination area so that the illumination light IL is irradiated only on the portion of the measurement mark RM₂. In this state, similar as above, aerial image measurement of the measurement mark RM₂ and detection of the best focal position of the projection optical system PL are performed based on the slit-scan method, and the results are stored in the internal memory unit.

Subsequently, the main controller 20 repeatedly performs measurement of the aerial image of the measurement marks RM₃ to RMₙ and detection of the best focal position of the projection optical system PL.

And, based on each best focal position Z₁, Z₂, . . . , and Zₙ, a predetermined statistical processing is performed to calculate the image plane shape of the projection optical system PL.

The image plane of the projection optical system PL, that is, the best image forming plane, is a plane consisting of a group of best focal points in innumerable points where the distance from the optical axis is different (that is, innumerable points where the so-called image height differs) Therefore, by the method described above, the image plane shape can be obtained both easily and accurately.

The astigmatism of the projection optical system PL can also be measured by using the two L/S patterns arranged in the same pitch, respectively, in the X-axis direction (or the sagittal direction) and the Y-axis direction (or the meridional direction) as the measurement mark PM, and detecting the best focal position referred to above by sequentially irradiating the illumination light IL onto the two L/S patterns at a predetermined point within the field of the projection optical system PL.

Thus, as is described, item A. detecting the best focal position of the projection optical system PL and detecting the best image forming plane (image plane) which was previously referred to can be achieved.

Also, spherical aberration measurement of the projection optical system PL can be performed in the following manner.

The case when using the reticle mark plate RFM will be described first. In this case, on detecting the spherical aberration, for example, a plurality of L/S marks are used as measurement marks PM. The measurement marks PM have the same line width with different periods arranged in the Y-axis direction at a predetermined interval, and are arranged within the AIS mark block 62₁ which is located along the center in the X-axis direction on the reticle mark plate RFM. For example, two L/S marks in the Y-axis direction, to be more specific, a first L/S mark that has a line width of 1 μn and a period of 2 μm in the Y-axis direction and a second L/S mark that has a line width of 1 μm and a period of 4 μm in the Y-axis direction are used as the measurement marks PM.

First of all, the main controller 20, for example, moves the reticle stage RST to set the position of the first L/S mark on the optical axis of the projection optical system PL. And, the illumination area is set using the movable reticle blind 12 only in the vicinity of the first L/S mark positioned on the optical axis, and detection of the best focal position described earlier is performed on the first L/S mark. The detection result is stored in the memory unit.

Next, the main controller 20 moves the reticle stage RST until the second L/S mark is at a position where the illumination light can illuminate the second L/S mark. Then, detection of the best focal position is performed on the second L/S mark likewise as above, and the result is stored in the memory unit.

And, based on the difference of the best focal position of each measurement mark obtained in the manner above and stored in memory, the main controller 20 performs a predetermined calculation in order to obtain the spherical aberration.

In addition, in the case of using a reticle to detect the spherical aberration, a measurement reticle R2 is used that has two measurement marks PM1 and PM2 arranged at a predetermined interval in the Y-axis direction formed around the center in the X-axis direction within the pattern area PA, as shown in FIG. 18. The measurement mark PM1 is a L/S pattern that has the same size and same period as the first L/S mark referred to earlier. And the measurement mark PM2 is a L/S pattern of the same size as the measurement mark PM1 but has a period of a different line pattern (for example, around 1.5-2 times wider than the period (mark pitch) of the measurement mark PM1 ) arranged in the Y-axis direction.

To begin with, the reticle R2 is loaded onto the reticle stage RST by the reticle loader (not shown in FIGS.). The main controller 20 then moves the reticle stage RST, so that the measurement mark PM₁ formed on the reticle R2 almost coincides with the optical axis of the projection optical system PL. And, the main controller 20 drives and controls the movable reticle blind 12 so that the illumination light IL is irradiated only on the portion of the measurement mark PM₁ and sets the illumination area. In this state, the main controller 20 irradiates the illumination light IL on the reticle R2, and likewise with the previous description, aerial image measurement of the measurement mark PM₁ and detection of the best focal position of the projection optical system PL are performed using the aerial image measurement unit 59 based on the slit-scan method, and the results stored in the internal memory unit.

When the detection of the best focal position using the measurement mark PM₁ is completed, the main controller 20 then moves the reticle stage RST a predetermined distance in the +X direction so that the illumination light IL is irradiated on the portion of the measurement mark PM2 . In this state, similar as above, aerial image measurement of the measurement mark PM₂ and detection of the best focal position of the projection optical system PL are performed based on the slit-scan method, and the results are stored in the internal memory unit.

Thus, the best focal position Z₁ and Z₂ are obtained in this manner, and based on the difference, the spherical aberration of the projection optical system PL is obtained by calculation.

The spherical aberration is one of an aperture aberration of the optical system, and is a phenomenon where in the case beams having various types of apertures from the object point of the optical axis are incident on the optical system the corresponding image point is not formed at one point. Accordingly, the detection of the best focal position in the optical axis of the projection optical system can be repeatedly performed on a plurality of L/S patterns having different pitches, and the spherical aberration can be easily obtained by calculation based on the difference of the best focal position corresponding to each pattern. In this case, it is substantially necessary for the measurement accuracy of the difference of the best focal position to be around 3σ<20 nm.

Detection of the Image Forming Position of the Pattern Image

The respective purposes for detecting the image forming position of the pattern image are as follows: C. measuring the magnification and distortion of the projection optical system, D. measuring the coma of the projection optical system, E. measuring the telecentricity (illumination telecentricity) of the projection optical system.

The measurement marks (the marks subject to measurement) differ depending on the purpose of measurement. Table 2, is a classification according to each purpose. Since it is preferable for the measurement result of the image forming characteristics of the projection optical system based on aerial image measurement to basically match the measurement result of the image forming characteristics by the exposure method previously described, in Table 2, the aerial image measurement mark is indicated, along with the exposure measurement mark.

TABLE 2

| | Exposure | Aerial Image |
|---|---|---|
| Purpose | Measurement Mark | Measurement Mark |
| C. Projection Lens | Box in Box Mark | Box in Box Mark |
| Magnification/Distortion | Large L/S Mark | Large L/S Mark |
| Measurement | | |
| D. Projection Lens | Line in Box Mark | Line in Box Mark |
| Coma Measurement | L/S Mark | L/S Mark, Large and |
| | | Small L/S Mark |
| E. Illuminance | Box in Box Mark | Box in Box Mark |
| Telecentricity Measurement | Large L/S Mark | Large L/S Mark |

Following is a description on the magnification and the distortion measurement of the projection optical system PL.

To begin with, the case of using a reticle mark plate RFM will be described. On measuring the magnification and the distortion of the projection optical system PL, the BOX mark PM₂₁, which is a 120 square μm (30 μm on the surface of a wafer with a ¼ magnification) mark arranged in each AIS mark block 62 on the reticle mark plate RFM, is used as the measurement mark PM.

The main controller 20 first of all moves the reticle stage RST, so that measurement marks such as the measurement mark PM₂₁ are respectively arranged at a plurality of points within the effective field of the projection optical system PL.

The main controller 20 then limits the illumination area with the movable reticle blind 12 so that the illumination light IL irradiates only a predetermined area that includes the measurement mark PM₂₁ at the first detection point within the effective field of the projection optical system PL. In this state, the main controller 20 irradiates the illumination light IL onto the measurement mark PM₂₁. With this operation, an aerial image PM₂₁′ of the measurement mark PM₂₁, that is, a square-shaped pattern image of about 30 square μ is formed, as is shown in FIG. 19.

And, the main controller 20 performs aerial image measurement based on the slit-scan method, by driving the wafer stage WST in the direction indicated with the arrow A so that the slit 22a on the slit plate 90 is scanned in the Y-axis direction with respect to the aerial image PM₂₁′. The light intensity signal m(y) obtained by the measurement, is stored in the memory unit. The main controller then calculates the image forming position of the aerial image PM₂₁′ of the measurement mark PM₂₁ by the well known phase detection method, based on the obtained light intensity signal m(y). As the phase detection method, a common method can be used where, for example, the product is obtained, of the first order frequency component (this can be regarded as a sinusoidal wave) obtained by performing Fourier transform on the light intensity signal m(y) and the reference sinusoidal wave having the same frequency as the first order frequency component. This product is summed by one period, while the product is also obtained, of the first order frequency component and the reference cosine wave having the same period as the first order frequency component. This product is also summed by one period. And by calculating the arc tangent of the quotient obtained by dividing both sums, the phase difference of the first order frequency component with respect to the reference signal can be obtained, and based on this phase difference, the Y coordinate value of the image forming position of the aerial image PM₂₁′ can be obtained.

Then, the main controller 20 performs aerial image measurement based on the slit-scan method, by driving the wafer stage WST so that the slit 22b on the slit plate 90 is scanned in the X-axis direction with respect to the aerial image PM₂₁′. The light intensity signal m(x) is obtained by the measurement, and the results are stored in the memory unit. And, the X coordinate value of the image forming position of the aerial image PM₂₁′ is obtained by the phase detection method, in the manner likewise as above.

Similarly, the main controller 20 limits the illumination area with the movable reticle blind 12 so that the illumination light IL irradiates only a predetermined area that includes the measurement mark PM₂₁ located at the second detection point, and at the respective detection points which follow, within the effective field of the projection optical system PL. The main controller 20 then performs aerial image measurement at each point based on the slit-scan method, and calculates the image forming position (X, Y coordinate values) of the measurement marks at each measurement point. And, based on the (X, Y coordinate values) of the measurement marks at each measurement point, the main controller 20 calculates at least either of the magnification or the distortion of the projection optical system PL.

Meanwhile, when a reticle is used on measuring the magnification and distortion of the projection optical system PL, a measurement reticle R3 is used. On the measurement reticle R3, a total of five measurement marks BM₁-BM₅ are formed in the pattern area PA. The measurement marks are square-shaped and of 120 square μm (30 μm on the surface of a wafer with a ¼ magnification) in size, and are arranged in the middle and in the four corners of the pattern area PA.

Firstly, the reticle R3 is loaded onto the reticle stage RST by the reticle loader (not shown in FIGS.). Then, the main controller 20 moves the reticle stage RST so that the center of the measurement mark BM₁ located in the middle of the reticle R3 almost coincides with the optical axis of the projection optical system PL. Next, the main controller 20 controls and drives the movable reticle blind 12 to set the illumination area, so that the illumination light IL illuminates only a rectangular area portion including the measurement mark BM₁, the area being one size larger than the measurement mark BM₁. In this state, the main controller 20 irradiates the illumination light IL on the reticle 3. Thus, the aerial image of the measurement mark BM₁ is formed.

In this state, the main controller 20 performs aerial image measurement based on the slit-scan method, by driving the wafer stage WST so that the slit 22a on the slit plate 90 is scanned in the Y-axis direction with respect to the aerial image BM₁, and the light intensity signal obtained by this measurement is stored in the memory unit. Then, the main controller 20 performs aerial image measurement based on the slit-scan method, by driving the wafer stage WST so that the slit 22b on the slit plate 90 is scanned in the X-axis direction with respect to the aerial image BM₁, and the light intensity signal obtained by this measurement is stored in the memory unit. And, the main controller 20 calculates the image forming position of the measurement mark BM₁ in the manner likewise as above by the phase detection method, based on the light intensity signal obtained, then corrects the positional deviation of the reticle R3 with respect to the center of the optical axis, based on the coordinate values (x₁, y₁) of the image forming position.

When correction of the positional deviation of the reticle R3 is completed, the main controller 20 then controls and drives the movable reticle blind 12 to set the illumination area, so that the illumination light IL illuminates only a rectangular area portion including the measurement mark BM₂, the area being one size larger than the measurement mark BM₂. In this state, likewise as above, the aerial image measurement and the measurement of the XY position of the measurement mark BM2 are performed based on the slit-scan method, and the results are stored in the memory unit.

Hereinafter, similarly as above, the main controller 20 repeatedly performs the aerial image measurement and the measurement of the XY position of the measurement marks BM₃-BM₅, while changing the illumination area.

And, based on the coordinate values (x₂, y₂), (x₃, y₃), (x₄, ₄), and (x₅, y₅) of the measurement marks BM₂ to BM₅ obtained from the measurements, a predetermined calculation is performed to obtain at least either the magnification or the distortion of the projection optical system PL.

Distortion refers to an aberration of the projection optical system PL where an image of a line originally straight turns out to be a distorted image, and due to this distortion, the mark image formed on the image plane is shifted (laterally) from the predetermined position, similar to the case when there is a magnification error.

Accordingly, by the measurement method of magnification and distortion described above, the positional shift of the aerial image of each measurement mark projected at different positions within the image field of the projection optical system PL can be respectively obtained with good accuracy using the phase detection method. As a consequence, at least either the distortion or the magnification can be measured with good accuracy.

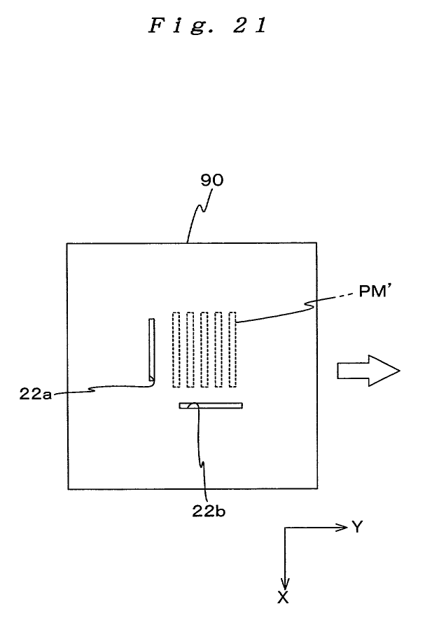

There are cases, however, when a sufficient measurement accuracy cannot be obtained when slit-scanning a single 30 square μm mark image PM₂₁′ (or the measurement mark BMₙ (n=1, 2, . . . , 5) since the image only has two edges. In such a case, an L/S mark large enough so that it is hardly affected by the coma may be used as the measurement mark PM, such as the L/S mark PM₁ or the like having a line width of 4 μm and over (the aerial image will be an L/S mark image having a line width of 1 μm). FIG. 21 shows a view of a state where the aerial image PM′ of the measurement mark PM is formed on the slit plate 90, when this kind of aerial image measurement of the measurement mark PM is performed.

In the description above, the positional shift of the aerial image of the measurement mark is measured by the phase detection method. The present invention is not limited to this, however, and aerial image measurement based on the slit-scan method can be repeatedly performed on the aerial image of the measurement mark (PM₂₁, BMₙ or PM) projected at different positions within the image field of the projection optical system PL. And, based on the intersection point of a plurality of light intensity signals (photoelectric conversion signals) obtained by the measurements and a predetermined slice level, the position of the aerial image (edge position) corresponding to each photoelectric conversion signal can be respectively calculated. And, at least either the distortion or the magnification of the projection optical system PL may be obtained, based on the calculation results. In such a case, according to the edge detection method using the slice method, the position of the aerial image projected at different positions within the image field of the projection optical system PL can respectively be obtained with good accuracy, and as a result, at least either the distortion or the magnification can be measured with good accuracy. In this case, when each light intensity signal is processed in binary at the predetermined slice level and the slice level is set appropriately, for example, as can be surmised from the relation between the waveform P2 and P3 in FIG. 11, this state becomes equivalent to measuring the edge position of the resist image that can be actually obtained by exposure.

In the case of measuring the distortion of the projection optical system PL from the image forming position (X, Y coordinate positions) of the plurality of measurement marks located at the plurality of detection points within the effective field of the projection optical system PL, as is described above, it is preferable to obtain the distortion of the projection optical system PL by setting an arbitrary detection point from the plurality of detection points as a reference point, detecting the positional relation between the image forming position (X, Y coordinate positions) of the measurement mark at the reference point and the image forming position (X, Y coordinate positions) of the measurement mark at a point other than the reference point within the XY plane, and obtaining the distortion from the positional relation detected. In this case, the illumination area may be sequentially changed by the movable blind 12 in the area including the measurement marks arranged at the reference point and a detection point other than the reference point, and aerial image measurement and detection of the positional relation of the image forming position (X, Y coordinate positions) of the measurement mark within the XY plane may be performed. With this operation, even if a drift or the like occurs to the wafer interferometer 31 that measures the position of the wafer stage WST (slit 22a and 22b), since the measurement result of the image forming position (X, Y coordinate positions) of the measurement mark at the reference position and the measurement result of the measurement mark at a point other than the reference point both include a similar measurement error due to the drift or the like, it turns out that the positional relation referred to above is hardly affected y the drift or the like. Accordingly, the influence of the drift or the like of the interferometer during measurement can be minimized. In addition, since the movable reticle blind 12 limits the illumination area of the illumination light at each detection point each time measurement is performed, the incident amount of the illumination light on the projection optical system PL during measurement can be suppressed.

With the current exposure apparatus, distortion (including magnification) control of the projection optical system is performed in the following manner, using a reference wafer. Reference wafer, here, refers to a wafer, on which an outer BOX mark of 30 square μm is transferred within the exposure area by the projection optical system, developed, and etched, and after the etching process the position of the edge of the outer BOX mark is measured in advance with equipments such as the optical interferometric coordinate measurement unit. And, when distortion is measured, a resist image of a 10 square μm inner BOX mark is exposed in the center of the outer BOX mark of 30 square μm made in the etching process, and the positional relation between the two marks is measured with the registration measurement unit and the like.

Accordingly, if distortion measurement is performed, by detecting the aerial image of the 10 square μm BOX mark on the wafer (on the image plane) with the edge detection method, the influence of the coma becomes similar to when distortion measurement is performed as above using the reference wafer. Therefore, a relative difference does onto occur. This allows distortion to be measured from the aerial image, with the accuracy equivalent to distortion measurement described above using the reference wafer.

To achieve this measurement, consideration can be made of forming an inner BOX mark of 40 square μm (10 square μm on the wafer) on the device reticle or the reticle mark plate referred to earlier. However, the mark of 10 square μm cannot be formed on the wafer because of dishing occurring in the recent CMP process.

Therefore, after diligent study, the inventor (Hagiwara) reached a conclusion that the aerial image measurement is to be performed using a BOX mark of 10 square μm on the wafer subdivided into strips in the non-measurement direction (the length not necessarily being 10 μm) (the mark hereinafter referred to appropriately as an “artificial BOX mark”). The reason for this, is because the artificial BOX mark is a type of the so-called L/S pattern, and if aerial image measurement is performed based on the slit-scan method by scanning the aerial image measurement unit in the direction perpendicular to the periodic direction, the signal waveform that can be obtained turns out to be similar to the signal waveform obtained from the aerial image of the BOX mark.

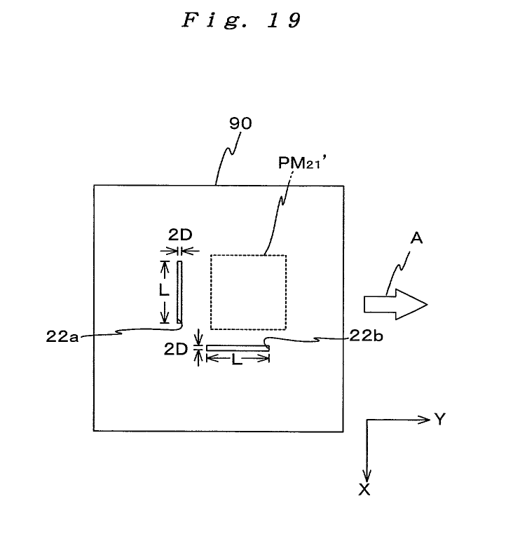

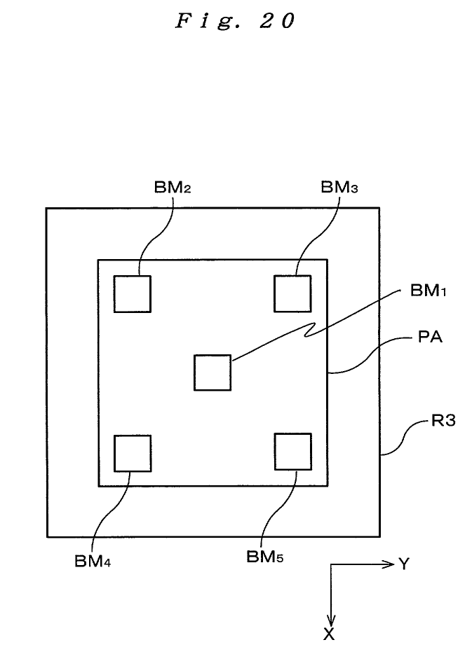

The inventor (Hagiwara) performed distortion measurement of the projection optical system PL by the edge detection method in the procedure previously described, using a measurement reticle on which an artificial BOX mark subdivided in strips in regard to the Y direction is formed, instead of using the measurement marks BM₁-BM₅ of the measurement reticle R3 shown in FIG. 20. As a consequence, it was confirmed that the X position of each measurement mark was the same as the X position of the measurement mark BMₙ. According to this confirmation, distortion measurement can be performed by preparing a measurement reticle on which an artificial BOX mark subdivided in strips in regard to the Y direction and an artificial BOX mark subdivided in strips in regard to the X direction are formed, and by relatively scanning the respective measurement marks with the slit 22a and 22b.

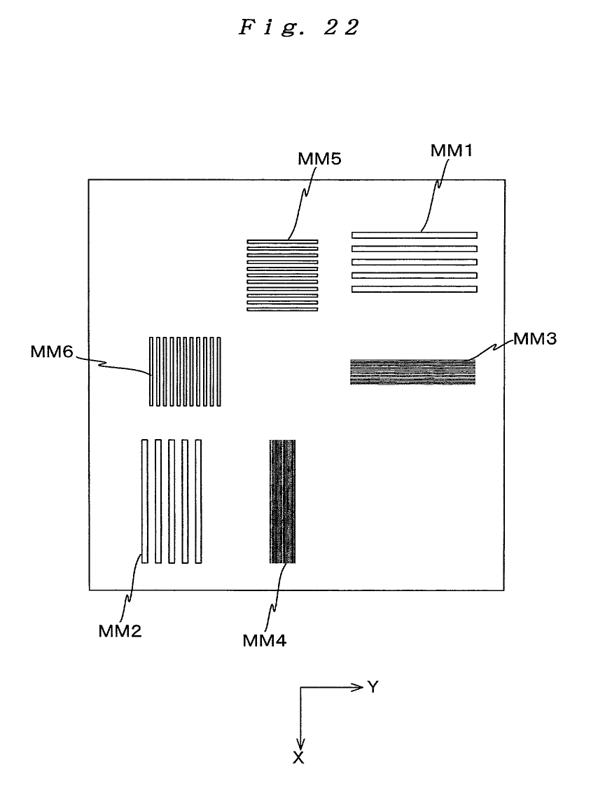

FIG. 22 shows an example of a mark block (240 square or 300 square μm) on which the artificial BOX mark subdivided in strips in regard to the Y direction, the artificial BOX mark subdivided in strips in regard to the X direction described above, and other measurement marks are formed. In FIG. 22, the marks MM1 and MM2 are, for example, magnification measurement marks made up of five 5 μm L/S marks, the marks MM3 and MM4 are, for example, focus measurement marks made up of twenty-nine 1 μm L/S marks, and the marks MM5 and MM6 are, for example, artificial-BOX marks made up of eleven 2.5 μm L/S marks. This mark block, in FIG. 22, is formed, for example, on the device reticle or the reticle mark plate. Incidentally, on subdivision of the artificial-BOX mark, it is preferable for the L/S mark to be around 2 μm and under (the L/S to be around 0.5 μm and under on the wafer).

Next, the measurement method of the coma of the projection optical system will be described. The following two methods are typical in the measurement of the coma, the first method of using the L/S mark as the measurement mark, and the second method of using the Line in Box mark as the measurement mark.

The First Method

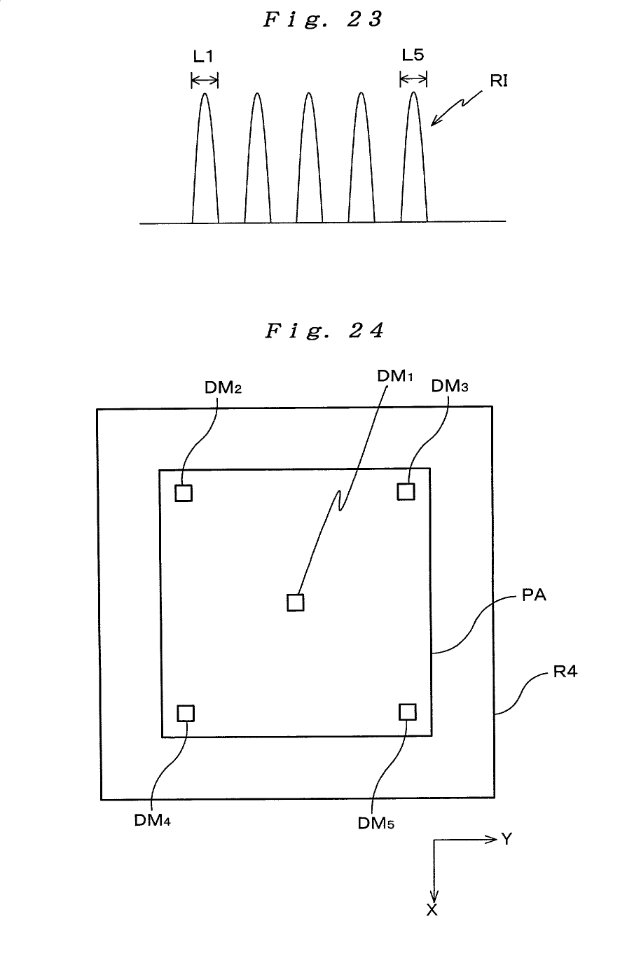

In the case of measuring the coma by exposure, the method using the line width abnormal value of the small L/S mark image around the limit of resolution is known. The line width abnormal value, here, is a value serving as an indicator to indicate the asymmetrical degree of the resist image formed by exposure. For example, in the case of a resist image of a 0.2 μm L/S mark (design value) as is shown in FIG. 23, the line width abnormal value A can be defined as in the following equation (4), using the line widths L1 and L5 on both edges.

$$A = \frac{L1 - L5}{L1 + L5} \qquad ( 4 )$$

The desirable performance of the projection optical system (the projection lens) is for the value A to normally be less than 3%.

The line width abnormal value of the L/S mark image can also be directly measured on aerial image measurement. In this case, the edge detection method by the slice method may be used, however, on setting the slice level, a simple resist image simulation of processing the light intensity signal corresponding to the aerial image in binary at an appropriate threshold value (threshold level) to make the processed light intensity signal become closer to the line width of the resist image is preferably performed. Accordingly, it is desirable to set the threshold value as the slice level.

The measurement method of the coma by the line width abnormal value is explained in the following description. The case when the reticle mark plate is used will be described first. On measuring the coma, for example, an L/S negative mark having a line width of 0.8 μm (0.2 μm on the wafer surface) with a 1:1 duty ratio and a period in the Y-axis direction, which is arranged within each AIS mark block 62 on the reticle mark plate RFM, is used as the measurement mark PM.

In this case, in the procedure same as the magnification and distortion measurement previously described, the main controller 20 sequentially measures the aerial image of each measurement mark arranged at a plurality of detection points within the effective field of the projection optical system, and respectively obtains the intersection points of the light intensity signals and the slice level. From the Y coordinate (or the X coordinate) of the intersection points obtained, the line width of each line of the respective aerial image PM′ is obtained, and based on the line width the line width abnormal values are respectively calculated, based on equation (4). And, the coma of the projection optical system PL is obtained based on the calculation result.

Meanwhile, in the case of using a reticle when measuring the coma, for example, as is shown in FIG. 24, a measurement reticle R4 is used. On the reticle R4, measurement marks DM₁-DM₅ are formed at a total of five points, in the center and in the four corners of the pattern area PA. As the measurement marks DM₁-DM₅, an L/S pattern having a line width of 0.8 μm (0.2 μm on the wafer surface) with a 50% duty ratio and a period in the Y-axis direction, is used.

In this case, in the procedure same as the magnification and distortion measurement previously described, the main controller 20 performs reticle alignment and aerial image measurement and obtains the light intensity signal m(y), which corresponds to the aerial image (DM₂′-DM₅′ ) of the measurement marks DM₂-DM₅.

And the intersection points of each light intensity signal m(y) obtained and a predetermined slice level are respectively obtained, and from the Y coordinate of the intersection points obtained, the line width of each line of the respective aerial images DM₂′-DM₅′ is obtained, and based on the line width the line width abnormal values are respectively calculated, based on equation (4). And, the coma of the projection optical system PL is obtained based on the calculation result.

The coma, is an aberration of the lens due to different magnifications in various zones of the lens, and occurs at portions far from the main axis within the image field of the projection optical system PL. Accordingly, at a position far from the optical axis, the line width of each line pattern becomes different depending on the coma in the aerial image of the L/S pattern. Therefore, with the method described above by using the slice method and detecting the line width abnormal value of each line pattern with the edge detection method, it becomes possible to measure the coma with high accuracy, in a simple manner.

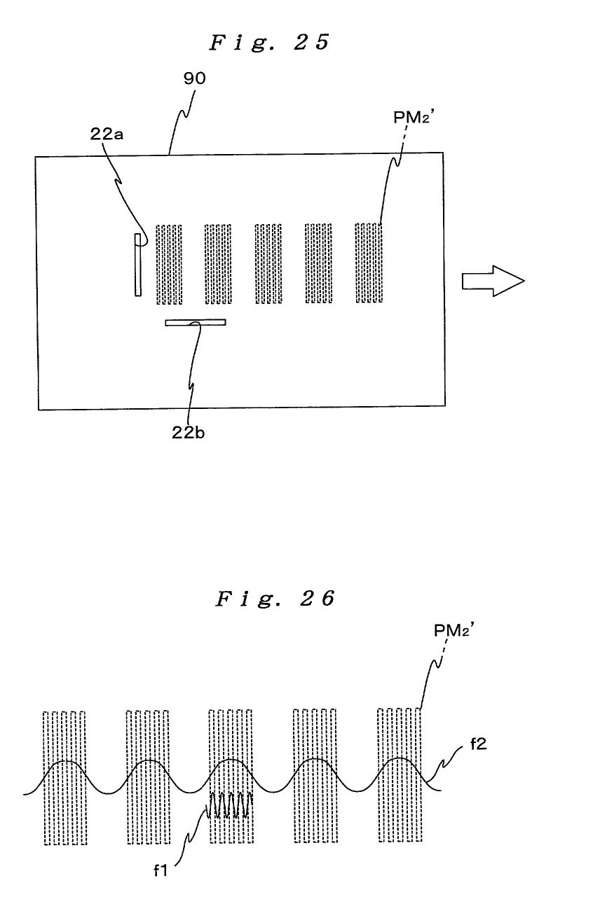

In the case each measurement mark PM (or DM₁-DM₅), for example, is a single L/S pattern including five line patterns, and the measurement accuracy of the line width abnormal value is not sufficient enough, a combined mark pattern that has an arrangement of a plurality of L/S patterns with five lines combined in a predetermined period may be used as the measurement mark PM (or DM₁-DM₅), such as the applied measurement mark PM₂ previously described. FIG. 25 indicates a state where an aerial image PM₂′ of the applied measurement mark PM₂ is formed on the slit plate 90, when the applied measurement mark PM₂ is used.

As is shown in FIG. 26, the aerial image PM₂′ has two fundamental frequency components. That is, for example, a frequency component (a first fundamental frequency component) fl that corresponds to the pitch of each line pattern of the photoelectric conversion signal and has a 0.4 μm pitch, and a frequency component f2 that corresponds to the repetition period of each L/S pattern (the arrangement pitch of a mark group, which consists of five lines), such as a pitch of 3.6 μm, in other words, a second fundamental frequency component corresponding to the entire width of each L/S pattern.

Accordingly, the main controller 20 may perform aerial image measurement in the procedure same as the magnification and distortion measurement previously described. And, when the light intensity signal corresponding to the aerial image PM₂′ of the measurement mark PM₂ is obtained, the main controller 20 may calculate the phase difference between the first fundamental frequency component and the second fundamental frequency component of each light intensity signal based on the phase detection method, and based on the calculation results may obtain the coma of the projection optical system PL.

When the width of the pattern subject to aerial image measurement in the scanning direction is narrower, the influence of the coma is more apparent. Therefore, the influence of coma on the aerial image of each line pattern of the L/S line pattern is different from the influence of coma on the aerial image of a pattern when the entire L/S pattern is regarded as a single pattern. Accordingly, the phase difference of the first fundamental frequency component corresponding to the pitch of each line pattern of the photoelectric conversion signals and the second fundamental frequency component corresponding to the entire width of the L/S pattern can be calculated. And, based on the calculation result, according to the method described above of obtaining the coma of the projection optical system, the coma of the projection optical system PL can be obtained with high accuracy with the phase detection method. In this case, it is preferable to set the ratio of the arrangement pitch of the mark (0.4 μm in the example above) and the arrangement pitch of the mark group consisting of five lines (3.6 μm in the example above) multiplied in integer, from the signal processing point of view.

The Second Method

The second method of measuring the coma will be described next. With this method, as the measurement mark PM, the Line in Box mark PM₂₂ referred to earlier, which is arranged on the reticle mark plate RFM, is to be used. As shown in FIG. 27, the mark PM₂₂ is a mark of a square-shaped pattern with a side length D1 (for example, D1=120 μm), which has a square-shaped space pattern (width D3) that is concentric with the square-shaped pattern and with a side length D2 (for example, D2=80 μm) formed in the interior. When the mark PM₂₂ is exposed on the wafer and is developed, a narrow groove of 20 square μm is formed at the same time in the center of a resist mark of 30 square μm. The width of the narrow groove is preferably around (λ/N.A.)/2 and under, therefore, D3 is preferably around 4 times and under. For example, D3 may be 0.4 μm.

When the image of the Line In Box mark PM₂₂ is formed with a projection optical system having a coma, since the lateral shift of the narrow line is greater than the wide line, the narrow groove turns out to be eccentric and loses its symmetry. Accordingly, by measuring the eccentric amount of the narrow groove, in other words, the degree of the symmetry lost, the influence of the coma can be acknowledged.

Therefore, with a procedure similar to the magnification and distortion measurement previously described, the main controller 20 sequentially measures the aerial image of each measurement mark PM₂₂ arranged at a plurality of detection points within the effective field of the projection optical system, and obtains the light intensity signals respectively corresponding to the images. And based on the intersection point of each light intensity signal and the predetermined slice level, the symmetric shift of the aerial image of each mark PM₂₂ is calculated, and the coma of the projection optical system PL is obtained based on the calculation results.

In this manner, with the edge detection method using the slice method, the symmetric shift of the aerial image of the mark PM₂₂ can be calculated, and with the method described above of obtaining the coma of the projection optical system PL based on the calculation results, the coma of the projection optical system PL can be obtained with high accuracy.

In the case described above, the situation may occur where the slit in the non-measurement direction interferes with the aerial image, due to the arrangement of the slit 22a and 22b on the slit plate 90. In such a case, instead of using the mark PM₂₂ as above, a linear mark laterally symmetric that has, for example, a wide line pattern with a line width of 4 μm and a narrow line pattern with a line width of 0.4-0.6 m arranged at a predetermined interval (for example, 40 μm) in the measurement direction, such as the mark PM₆ (or PM₅) previously described, may be used as the measurement mark.

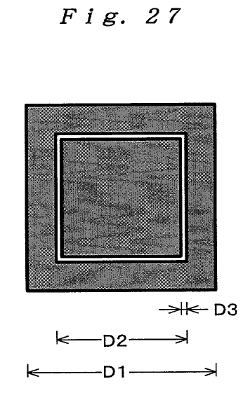

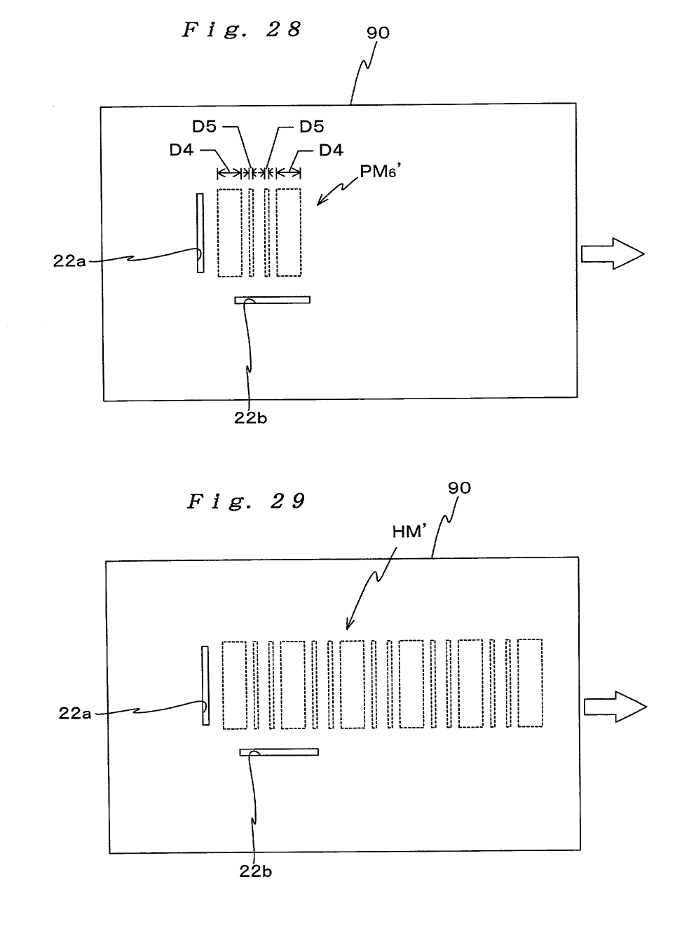

FIG. 28 shows the state of an aerial image PM₆′ of such a measurement mark PM₆ formed on the slit plate 90. In FIG. 28, D4 is 10 μm, and D5 is 0.1-0.15 μm. The coma of the projection optical system PL may be detected, by detecting the light intensity signal corresponding to such an aerial image PM₆′ with the edge detection method using the slice method.

The positional shift due to the effect of the coma is greater in the aerial image of a line pattern having narrow width in the scanning direction (measurement direction). As a consequence, the symmetry of the aerial image of a symmetric mark pattern having various types of line patterns with different line widths arranged at a predetermined interval in the direction corresponding to the scanning direction, such as the measurement mark (PM₆), is greatly deformed, when the coma becomes large.

Thus, according to the method of detecting the symmetric shift of the aerial image PM₆′ described above, the coma of the projection optical system PL can be detected with high accuracy.

In this case, also, as a matter of course, in order to improve the measurement reproduction, the aerial image HM′ of the measurement mark repeatedly arranged as in FIG. 29, may be detected.

On the other hand, in the case of using a reticle, as is shown in FIG. 30, a measurement reticle R5 on which a total of five measurement marks FM₁-FM₅ are formed in the center and in the four corners of the pattern area PA is to be used. As the measurement mark FMₙ (n=1, 2, . . . , 5), a Line in Box mark similar to the mark PM₂₂ described earlier, is used.

Accordingly, the main controller 20 performs reticle alignment and aerial image measurement in the procedure same as the magnification and distortion measurement previously described, and obtains the light intensity signal m(y), which corresponds to the aerial image (FM₂′-FM₅′) of the measurement marks FM₂-FM₅.

And based on the intersection points of each light intensity signal obtained and a predetermined slice level, the symmetric shift of the aerial image of the measurement marks FM₂-FM₅ are respectively calculated, and from the calculation results the coma of the projection optical system PL is obtained.

Next, the method of measuring the illumination telecentricity (telecentricity of the projection optical system) will be described.

The illumination telecentricity is set, by measuring the changing amount of the image position that changes due to defocus. As the measurement mark, a large measurement mark that is not affected by the coma is used, likewise with the magnification and distortion measurement. In the case of the exposure method, a Box in Box Mark or a large L/S mark is used, and exposure is respectively performed at three points; the best focal position, the defocus position of around +1 μm, and the defocus position of around −1 μm. Then, the relation between the image position and the focus position is measured, and the illumination telecentricity (=(lateral shift amount of the image/defocus amount)) is calculated. In the case of aerial image measurement, a large measurement mark that is not affected by the coma is used, similar to the case of the exposure method, and the absolute position (image forming position) of the aerial image is measured at each focus position. Thus, the illumination telecentricity is calculated.

More particularly, the measurement mark is positioned at the first detection point within the effective field of the projection optical system PL to form the aerial image of the measurement mark, and the measurement mark PM is measured based on the slit-scan method at a first position with respect to the optical axis direction (Z-axis direction) of the projection optical system PL. That is, the slit 22 is relatively scanned with respect to the aerial image, and the light that has passed through the slit 22 is photo-electrically converted with the optical sensor 24 to measure the light intensity corresponding to the aerial image. Then, the measurement mark PM is positioned at the second detection point within the effective field of the projection optical system PL, the aerial image of the measurement mark formed, and the aerial image of the measurement mark PM is measured based on the slit-scan method at a second position with respect to the optical axis direction (Z-axis direction). And, the positional relationship between the image forming position of the aerial image within the XY plane of the aerial image measurement result when the slit 22 (slit plate 90) is at the first position in the Z-axis direction and the image forming position of the aerial image within the XY plane of the aerial image measurement result when the slit 22 (slit plate 90) is at the second position in the Z-axis direction is obtained. Thus, the telecentricity of the projection optical system PL is calculated based on this positional relationship.

In this case, the telecentricity of the projection optical system PL is calculated based on the positional relationship between: the image forming position (the first image forming position) within the XY plane of the aerial image which is obtained from the measurement result of measuring the aerial image of the measurement mark positioned at the first detection point in the effective field of the projection optical system PL within the plane corresponding to the first position in the Z-axis direction; and the image forming position (the second image forming position) within the XY plane of the aerial image which is obtained from the measurement result of measuring the aerial image of the measurement mark positioned at the second detection point in the effective field of the projection optical system PL within the plane corresponding to the second position in the Z-axis direction. That is, the telecentricity of the projection optical system PL is calculated based on the relative distance between the first image forming position and the second image forming position, and the distance between the first position and the second position in the Z-axis direction. So, for example, on measuring the first image forming position and the second image forming position, even when drift or the like occurs in the wafer interferometer 31, since the measurement results of the first image forming position and the second image forming position contain a similar error, as a result, a highly precise measurement of telecentricity, which is hardly affected by measurement errors due to the drift or the like of the interferometer, becomes possible.

In this case, when the aerial image of the measurement marks positioned at three or more detection points within the effective field of the projection optical system PL is measured based on the slit-scan method while changing the Z position of the slit plate 90 and the absolute position of the aerial image (image forming position) is measured on each focus position, an arbitrary focus position among a plurality of focus positions may be set as the reference focal position, and the relative position between the position of the aerial image of the measurement mark within the XY plane at the reference focal position and the position of the aerial image of the measurement mark within the XY plane at points other than the reference focal position may be measured. And, the illumination telecentricity of the projection optical system may be measured based on this positional relationship.

In such a case, when the reference focal position is set in the vicinity of the best focal position, the position of the aerial image within the XY plane of the measurement marks arranged at a plurality of detection points within the effective area of the projection optical system PL, may be measured respectively on the +Z side and −Z side, at least at one point at each Z position.

On measuring the illumination telecentricity, the measurement may be performed by using a single measurement mark on the reticle mark plate RFM (or the reticle), sequentially setting the measurement mark to a plurality of detection points within the effective field of the projection optical system PL, and sequentially measuring the image forming position of the measurement mark at each detection point while changing the Z position of the slit plate 90. Or, the measurement may be performed by using a plurality of measurement marks arranged on the reticle mark plate RFM (or the reticle), which are simultaneously set at a plurality of detection points within the effective field of the projection optical system PL, and sequentially measuring the image forming position of the measurement mark at each detection point while changing the Z position of the slit plate 90.

As is described in detail so far, with the exposure apparatus 100 related to the first embodiment, the exposure apparatus 100 comprises an aerial image measurement unit 59 that has a slit plate 90 which slit width is, 2D=n·(λ/N.A.), n≦=0.8. Therefore, by performing aerial image measurement of the measurement mark arranged on the reticle or the reticle fiducial mark plate using this aerial image measurement unit, aerial image measurement with high precision becomes possible where the image profile hardly deteriorates when converting the aerial image to the aerial image intensity signal. In this case, the signal processing system arranged downstream of the optical sensor 24 (photoconversion element) will not require a large dynamic range.

In addition, according to the exposure apparatus 100, the reticle stage RST can position any of the variety of measurement marks PM₁-PM₂₂ and the like used for various self-measurements formed on the reticle mark plate RFM, in the vicinity of the focal plane position on the object side of the projection optical system PL where the illumination light IL is capable of illuminating. Therefore, by irradiating the illumination light IL on the measurement marks PM₁-PM₂₂, forming images of these measurement marks PM₁-PM₂₂ in the vicinity of the focal plane on the image side of the projection optical system, and detecting these images, various self-measurement becomes possible without preparing any masters used only for self-measurement.

To be more concrete, the main controller 20 is capable of performing self-measurement on best focal position of the projection optical system PL, image plane shape (including field curvature), spherical aberration, distortion, magnification, coma, optical properties such as illumination telecentricity, and base line measurement of the alignment system ALG1, and the like previously described. This self-measurement is performed by driving the slit plate 90, in other words, the wafer stage WST, so that the aerial image formed and the slit 22 is relatively scanned, when, for example, at least a part of the reticle mark plate RFM is illuminated with the illumination light IL and an aerial image of the measurement mark illuminated by the illumination light IL is formed in the vicinity of the focal plane on the image side of the projection optical system PL with the projection optical system PL. As is obvious from this, in this embodiment, the main controller 20 structures the driving unit.

As can be seen, in this embodiment, it is possible to measure the optical properties of the projection optical system PL by aerial image measurement, without performing exchanging operation of the reticle for device manufacturing and the master for self-measurement. Accordingly, the downtime of the apparatus can be reduced, thus, it becomes possible to improve the productivity of the device, as an end item.

In addition, with the exposure apparatus 100, the main controller 20 can perform aerial image measurement based on the slit-scan method using the aerial image measurement unit 59, and by using the measurement results, measurement of various optical properties of the projection optical system PL described earlier, for example, various aberrations such as field curvature, distortion, magnification, coma, can be performed with high precision. Therefore, for example, at the startup operation of the exposure apparatus in the factory while the exposure apparatus is being made, measurement on various optical properties of the projection optical system may be performed as is previously described, and adjustment of the optical properties of the projection optical system PL may be performed based on the measurement results. The making method of the exposure apparatus will be referred to, later in the description.

For example, based on the measurement results of the best focal position and the image plane shape, the main controller 20 can perform a highly precise calibration, such as setting the offset of the detection output of each focus sensor (photodetection element) structuring the multiple focal position detection system (60a, 60b), or re-setting the origin position.

In addition, on various aberrations such as distortion, magnification, coma, and field curvature, the main controller 20 performs periodical measurement, and based on the measurement results, self adjustment of the aberration to correct various aberrations of the projection optical system PL described above becomes possible with the image forming characteristics correction unit (not shown in FIGS.) (for example, a unit to drive a specific lens element structuring the projection optical system in the tilt direction with respect to a surface perpendicular to the optical axis direction and the optical axis or a unit to adjust the internal pressure of a sealed chamber arranged in between the specific lens elements structuring the projection optical system) provided in the projection optical system PL. The adjustment in magnification by the image forming characteristics correction unit referred to above, is performed especially on the magnification in the non-scanning direction during scanning exposure. The correction of magnification in the scanning direction during scanning exposure is preformed, for example, by adjusting the scanning velocity of at least either the reticle or the wafer during scanning exposure.

Also, the main controller 20 is capable of automatically correcting the illumination telecentricity by driving the relay lens (not shown in FIGS.) in the illumination system 10, based on the illumination telecentricity measurement results described above.

As is described, with the exposure apparatus 100, for example, due to the initial adjustment of the optical properties (including the image forming characteristics) of the projection optical system or adjustment of the optical properties of the projection optical system prior to starting exposure, exposure is performed using a projection optical system PL which optical properties are adjusted to high precision. As a consequence, the exposure accuracy can be improved.

In addition, with the exposure apparatus 100, the main controller 20 detects the baseline amount of the alignment system ALG1 serving as a mark detection system with high accuracy using the aerial image measurement unit 59. Thus, by using the baseline amount and controlling the position of the wafer W during exposure or the like, it becomes possible to improve the overlay accuracy of the reticle and the wafer. From this viewpoint as well, exposure accuracy can be improved.

With the exposure apparatus 100 according to this embodiment, due to the baseline measurement described above, by using the alignment system ALG1 which baseline is automatically corrected, operations such as the wafer alignment (EGA) is performed with high accuracy. In addition, during scanning exposure, automatic focusing and automatic leveling of the wafer W is performed with high precision to make the surface of the wafer W substantially coincide with the measured image plane using the multiple focal position detection system (60a, 60b). While this is being performed, the circuit pattern of the reticle R is overlaid and transferred onto each shot area on the wafer W via the projection optical system PL which aberrations are adjusted with high precision. Therefore, exposure which exposure accuracy (including overlay accuracy and focusing accuracy) is highly maintained becomes possible.

In this embodiment, on aerial image measurement, the main controller 20 may move the reticle stage RST (reticle mark plate RFM) while the wafer stage WST (slit plate 90) is stationary. Or, the main controller 20 may move both the wafer stage WST (slit plate 90) and the reticle stage RST at the same time in opposite directions.

Since the magnification error of the projection optical system PL affects the overlay accuracy of the circuit pattern of the reticle R and the shot area on the wafer W, the magnification measurement and the automatic correction based on the measurement results are preferably performed with high frequency. However, the aerial image measurement based on the slit-scan method previously described requires a certain period of time, therefore, if this is frequently performed, then it becomes a cause of reducing the throughput.

So, on exposing the wafer W by the lot, the main controller 20 performs aerial image measurement of the measurement marks on the reticle mark plate RFM using the aerial image measurement unit 59 when the first wafer W of each lot is exposed. And, based on the measurement results, the magnification of the projection optical system PL is calculated. Meanwhile, when the wafers other than the first wafer of the lot are exposed, the main controller 20 observes the alignment mark on either the reticle mark plate RFM or the reticle R and the image of the reference mark (not shown in FIGS.) on the wafer stage WST via the projection optical system PL using the RA microscopes 28, and based on the observation results the magnification of the projection optical system PL is calculated. These operations prevent unnecessary reduction in throughput, as well as maintain the magnification of the projection optical system PL at a desired value, resulting in maintaining a high overlay accuracy.

In addition, in the embodiment, since aerial image measurement is performed using the illumination system 10 that structure the exposure apparatus 100, it becomes possible to perform aerial image measurement combining various illumination conditions (such as conventional illumination, annular illumination, and modified illumination) and types of reticles (halftone reticle, ordinary reticle). Accordingly, it becomes possible to perform various self-measurements using the reticle mark plate RFM under the same or similar conditions as when exposure is performed.

Various items that can be combined such as the type of reticles, difference in the subject line width and type of lines such as isolated lines and dense lines, and illumination conditions are reciprocally controlled with different process programs, even when it is within the same exposure apparatus. Accordingly, for example, it is preferable to prepare as many offset values of the measurement value and the optimum condition as possible, which is essential to focus calibration, so as to cope with the combination referred to above.

Normally, the adjustment of the aberration or the like of the projection optical system PL is performed under different illumination conditions, and the marks used are isolated lines or dense lines of a specific line width. Therefore, it is not of any inconvenience to assume that when the illumination condition is set, then the measurement marks used for aerial image measurement is also set. So, the total of offsets corresponding to a plurality of process programs is equivalent to the total of illumination conditions. On the reticle mark plate RFM in this embodiment, the positive marks mainly used for measurement by exposure are arranged near the respective negative marks that are used for aerial image measurement (refer to FIG. 8). Accordingly, the optical properties of the projection optical system PL can be measured by using the positive marks on the reticle mark plate RFM with the exposure method, and immediately after the projection optical system PL is adjusted based on the measurement results, aerial image measurement can be performed using the negative marks on the reticle mark plate RFM and the offset referred to above can be easily obtained based on the results.

Moreover, the error due to the difference of shape between the reticle for device manufacturing and the reticle mark plate RFM (difference of bended amount and the like) needs to be controlled as an offset. This offset can be obtained easily, by comparing the measurement results of the aerial image of the marks formed on the reticle for device manufacturing and the marks formed on the reticle mark plate RFM. In this sense, it is preferable to form the same type of various measurement marks on the reticle for device manufacturing as the reticle mark plate RFM previously described.

In the embodiment above, the case has been described where the slit width 2D is set in consideration of both the wavelength λ of the illumination light and the numerical aperture N.A of the projection optical system PL, however, the present invention is not limited to this.

That is, the slit width 2D may be set in consideration of only the wavelength λ or the numerical aperture N.A. Even in the case of using an aerial image measurement unit comprising a slit plate having a slit such as this slit width 2D, likewise with the embodiment above, measurement of the aerial image (image intensity distribution) of a predetermined pattern based on the slit-scan method is possible with high precision.

Next, the setting of the slit width (2D) will be further described. As an example, a suitable setting method of the slit width will be described, referring to the case of focus measurement.

As is previously described, the measurement of the best focal position of the projection optical system is obtained, by repeating the aerial image measurement a plurality of times while changing the position of the slit plate 90 in the Z-axis direction (optical axis direction) based on the slit-scan method, and detecting the Z position (the Z coordinate of the contrast peak) of the slit plate 90 where the contrast (or other evaluation amounts) being the amplitude ratio of the light intensity signal (first order/zero order) obtained by the aerial image measurement is at a maximum (or at the peak) Usually, when the best focus is detected, the slit plate 90 is changed at a pitch interval of 0.15μm in approximately 15 stages (steps).

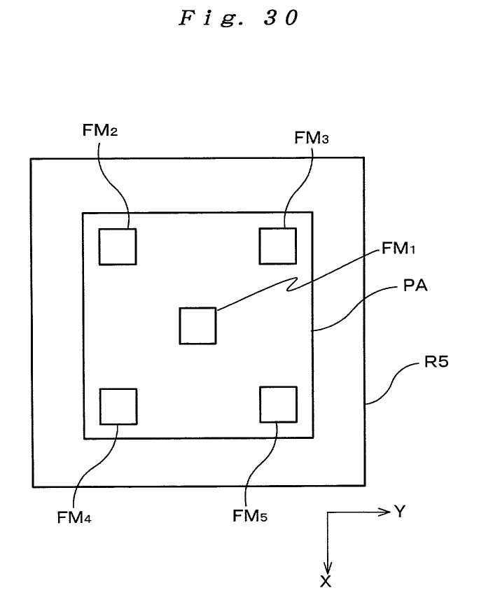

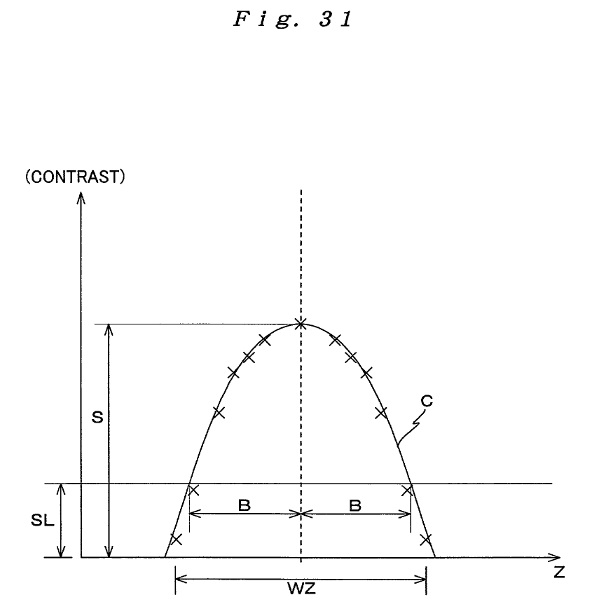

An example of best focal detection referred to above will now be described, using FIG. 31. FIG. 31 shows the measurement values of the contrast (the mark x in FIG. 31) obtained at 13 points, when the slit plate 90 is changed in the Z-axis direction in 13 stages (steps), with the horizontal axis as the Z-axis. Based on the contrast measurement values at the 13 points indicated with the mark x in FIG. 31, the approximation curve C of around the fourth order is obtained by the least squares method. The intersection points of the approximation curve C and an appropriate threshold value (threshold level) SL is obtained, and the midpoint of the distance between the intersection points =2B, is set as the Z coordinate value corresponding to the best focus.

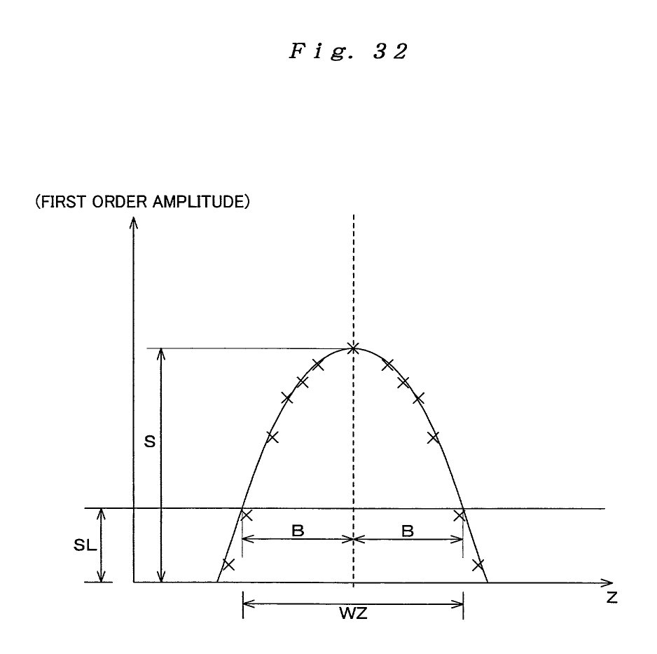

FIG. 32 shows a line graph similar to FIG. 31. In FIG. 32, however, the vertical axis indicates the amplitude (or the first order, which will be described later) of the first order frequency component (hereinafter abbreviated as “first component” as appropriate). The focus detection accuracy will now be considered, when the range of WZ (=step pitch x the number of data) in FIG. 32 is fixed. (1) In the case shot noise is dominant:

When the amplitude of the first component is expressed as S, the shot noise is proportional to S^{½} The average tilt of the curve related to the amplitude of the first component Z is inversely proportional to the depth of focus (DOF), therefore, when the noise of the amplitude of the respective first components that randomly fluctuates the data in the Z direction is expressed as noise N, then the relationship can be indicated as follows,

N∝S^{½}·DOF∝λ·S^{½}/(N.A.)² (5)

In this case, N.A. is the numerical aperture.

So, when the line width of the subject pattern is set as P, since P∝λ/N.A., the relation in the following equation (6) is valid.

S/N∝(N.A.)²·S^{½}λ∝λ·S^{½}/P (6)

S/N, in this case, is the S/N ratio, which is the ratio of the amplitude of the first component and the noise amplitude. (2) In the case dark noise is dominant:

Dark noise is not dependent on the amplitude S of the first component. The average tilt of the curve related to the amplitude of the first component Z is inversely proportional to the depth of focus (DOF), therefore, when the noise of the amplitude of the respective first components that randomly fluctuates the data in the Z direction is expressed as noise N, then the relationship can be indicated as follows,

N∝DOF∝λ/(N.A.)² (7)

Accordingly, when the line width of the subject pattern is set as P, the relation in the following equation (8) is valid.

S/N∝(N.A.)²·S/λ∝λ·S/P (8)

When the slit width (2D) is optimized with the equations (6) and (8), if the wavelength and the pitch of the subject pattern in set, attention is required only on the amplitude S of the first component, and it is obvious that the S/N ratio is proportional to the 0.5^{th}-1^{st} power of the first order amplitude S, depending on the noise properties.

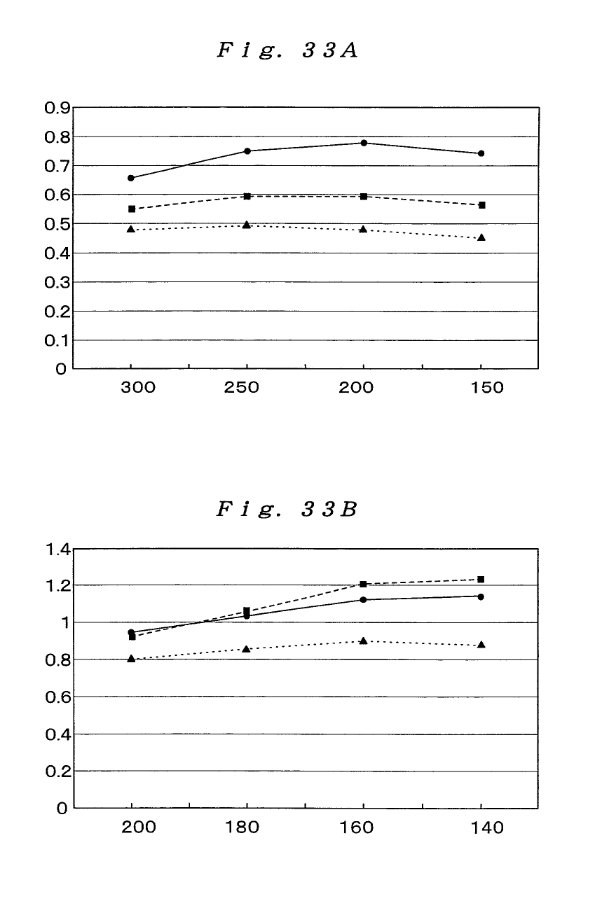

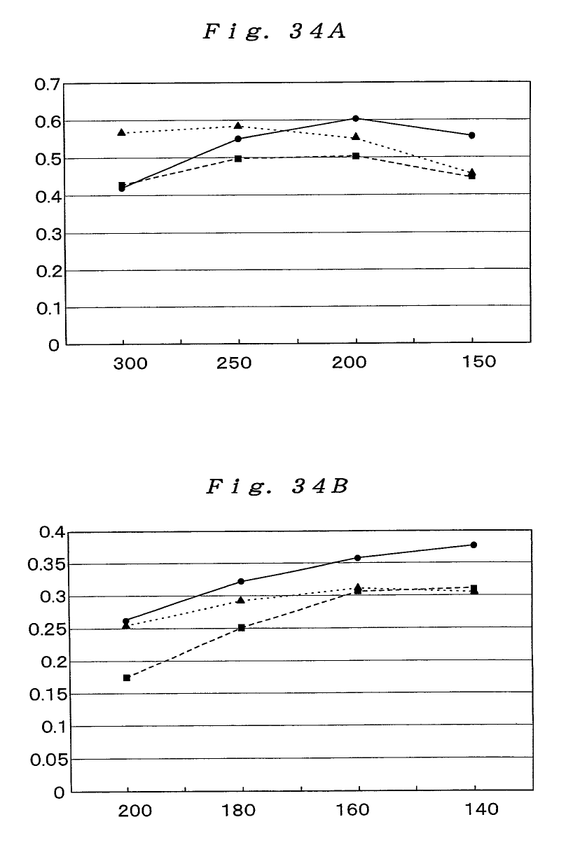

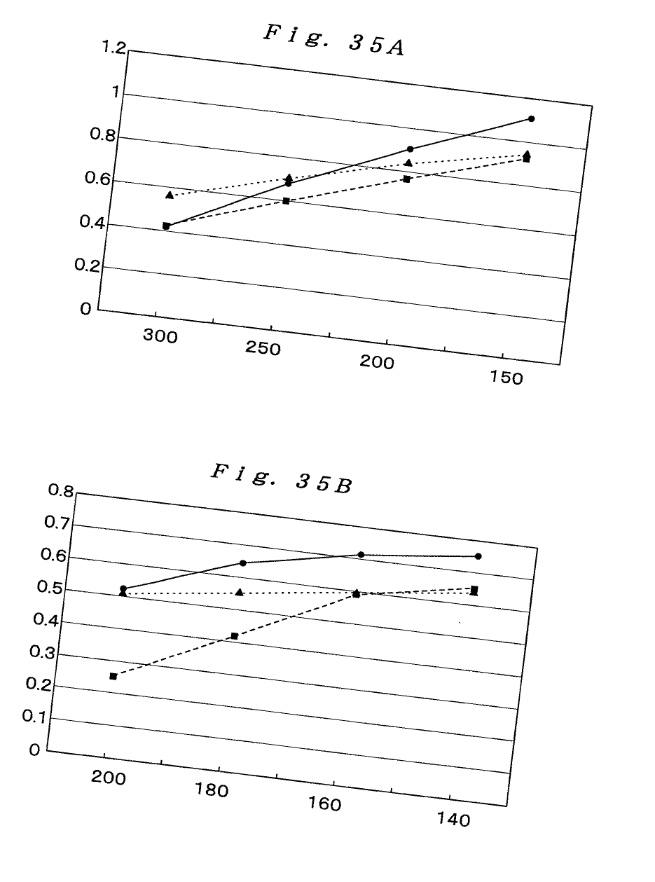

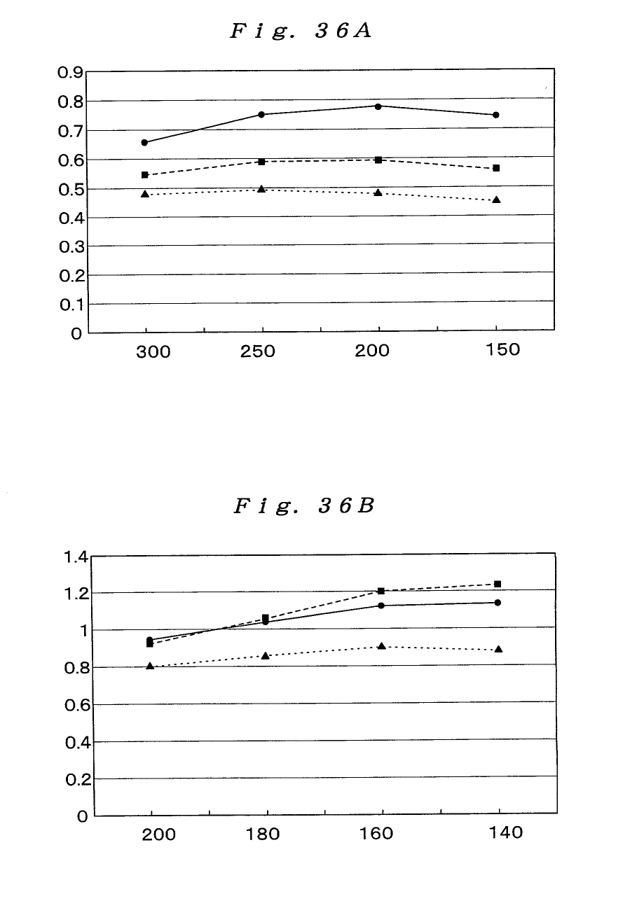

In FIGS. 33A to 36B, simulation results to obtain a suitable range of the slit width (2D) are exemplified. Of these figures, FIG. 33A, FIG. 34A, FIG. 35A, and FIG. 36A are results under the condition of N.A=0.68, λ=248 nm, and σ=0.85. Whereas, FIG. 33B, FIG. 34B, FIG. 35B, and FIG. 36B are results under the condition of N.A=0.85, λ=193 nm, and ∝=0.85.

FIG. 33A and FIG. 33B show the S/N ratio related to focus detection, in the case of applying the equation (6) when assuming an example of using a photo multiplier tube. In FIG. 33A, the solid line (●), the broken line (▪), and the dotted line (▴) respectively indicate the case when the L/S pattern is used having the line width L respectively of 200 nm, 220 nm, and 250 nm, and the duty ratio of 50% in all cases, as the measurement mark. And, in FIG. 33B, the solid line (●), the broken line (▪), and the dotted line (▴) respectively indicate the case when the L/S pattern is used as the measurement mark, that have the line width L respectively of 120 nm, 130 nm, and 140 nm, and the duty ratio of 50% in all cases.

FIG. 34A and FIG. 34B indicate the contrast that respectively correspond to FIG. 33A and FIG. 33B. The contrast becomes larger, when the slit width becomes smaller. Since the amplitude of zero order is proportional to the silt width, the first order (1^{st} Order) is the result of the contrast taken to the slit width ratio power, with 0.3 μm as a reference of the slit width ratio. The first order is proportional to he amplitude of the first component.

FIG. 35A and FIG. 35B indicate the first order that respectively correspond to FIG. 33A and FIG. 33B.

From FIG. 33A and FIG. 33B, consequently, it is obvious that in all wavelengths and line widths, the optimum slit width (2D) for focus detection is the length the same as half the pattern pitch (=2L). As for the pitch, the smaller the better, however, as a matter of course, it essentially has to be within the limit of resolution. Accordingly, the optimum value of the slit width is to be about half the limit of resolution pitch of the exposure apparatus.

FIG. 36A and FIG. 36B indicate the S/N ratio related to focus detection when applying the equation (8) under the same conditions as FIG. 33A and FIG. 33B.

Optimization of the slit width 2D will now be described, from a different point of view.

When the slit width of the aerial image measurement unit is expressed as 2D and the intensity distribution of the aerial image i(y), then the slit transmittance intensity m(y) can be expressed as in the following equation (9) by generalizing the equation (1) previously described.

$$m ( y ) = {\int }_{y - D}^{y + D} i ( t ) ⅆ t \qquad ( 9 )$$

The focus detection is calculated from the zero order and first order ratio (contrast) of the intensity image of the L/S in the limit of resolution. When the intensity of the zero order component included in the intensity image of the aerial image is expressed as a, and the intensity of the first order component b·sin (ω₁·y), the slit transmittance light intensity m₀(y), m₁(y) observed can be expressed as in the following equations (10) and (11). ω₁, in this case, is the spacial frequency in the limit of resolution.

$$\begin{matrix}{m}_{0} ( y ) = a {\int }_{y - D}^{y + D} ⅆ t = 2 aD & ( 10 ) \\ \begin{matrix}{m}_{1} ( y ) = b {\int }_{y - D}^{y + D} sin ( {ω}_{1} t ) ⅆ t \\ = \frac{2 b}{{ω}_{1}} sin ( {ω}_{1} y ) \cdot sin ( {ω}_{1} D )\end{matrix} & ( 11 )\end{matrix}$$

From equation (10), it can be seen that the zero order component is simply proportional to the slit width, and as for equation (11), the first order component becomes maximum when it satisfies the conditions of the following equation (12).

ω₁D=π/2·(2n−1) (12)

(provided that n=1, 2, 3, . . . )

When equation (12) is satisfied, in the case D=π/(2ω₁) is multiplied by odd numbers, the gain of the first order component becomes maximum (the contrast becomes maximum). Therefore, when the slit width 2D is π/ωᵢ multiplied by an odd number, that is, the slit width 2D is preferably half the minimum mark pitch (hereinafter referred to as “minimum half-pitch” as appropriate) multiplied by an odd number.

In addition, the setting of the dynamic range of the electric system becomes easier when the first order component gain is high and the zero order component gain is low. So, ultimately, in the case of n=1 in equation (12), that is, when the slit width 2D is π/ω₁, in other words, when slit width 2D coincides with the minimum half-pitch, the slit width 2D is at the optimum.

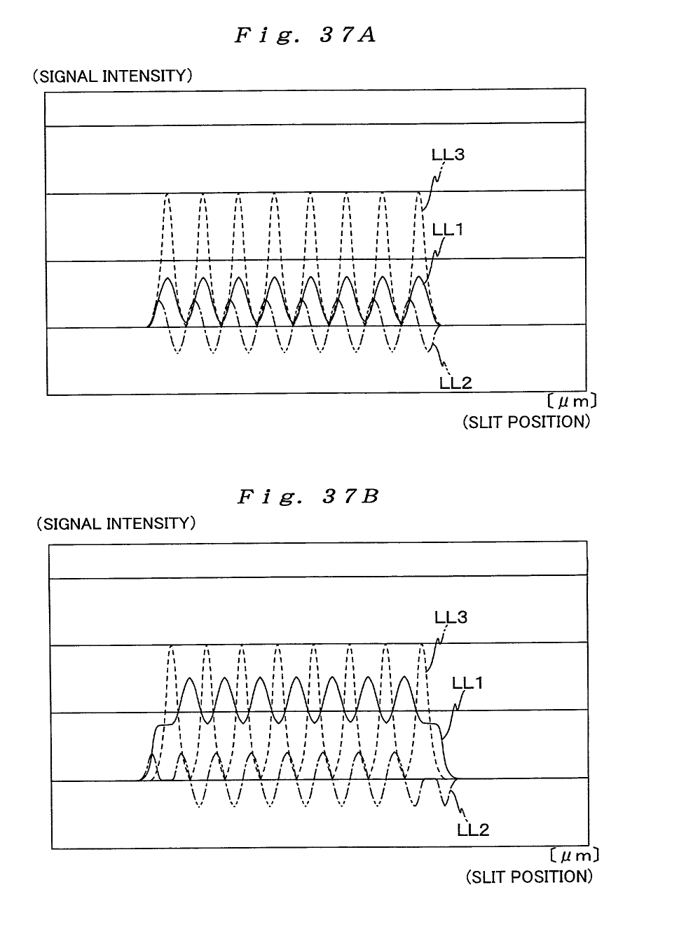

FIG. 37A and FIG. 37B respectively indicate the simulation data when the slit width 2D is of equal magnification and is of three times the minimum half-pitch. In these drawings, the solid line curve LL1 shows the intensity signal of the light transmitting the slit, the dashed-dotted line LL2 shows the differential signal of the light, and the broken line LL3 shows the aerial image. In these drawings, the horizontal axis shows the slit position, and the vertical axis shows the signal intensity.

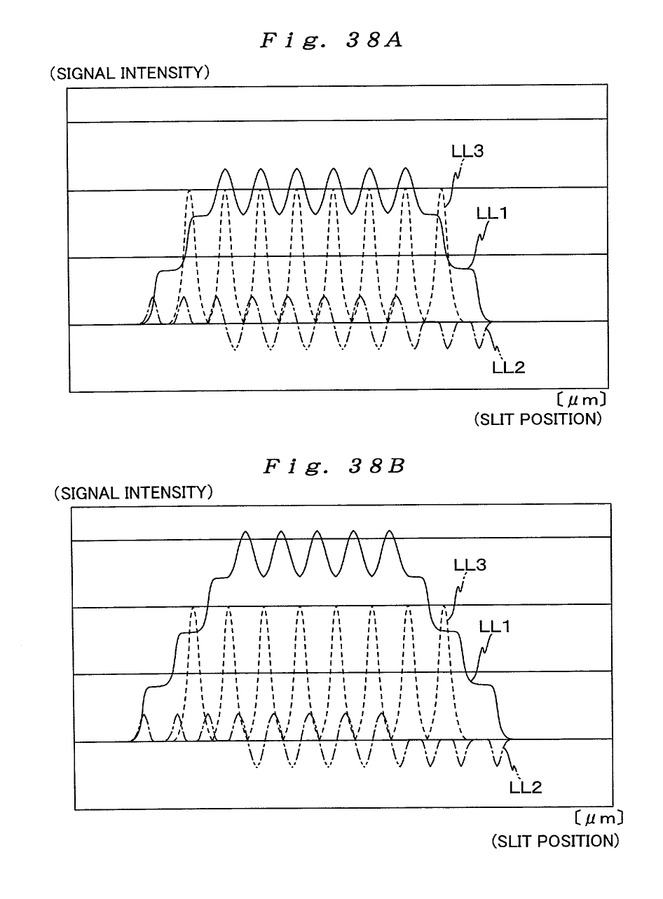

FIG. 38A and FIG. 38B respectively indicate the simulation data when the slit width 2D is five times and is seven times the minimum half-pitch. In these drawings, the solid line curve LL1 shows the intensity signal of the light transmitting the slit, the dashed-dotted line LL2 shows the differential signal of the light, and the broken line LL3 shows the aerial image. In these drawings, the horizontal axis shows the slit position, and the vertical axis shows the signal intensity.

From FIG. 37A and FIG. 37B, and from FIG. 38A and FIG. 38B, it can be seen that the amplitude of the differential signal LL1 is the same. However, when the n, in the equation slit width 2D=minimum half-pitch x n, increases by 1, 3, 5, and 7, the signal processing system (the processing system arranged further downstream of the optical sensor) obviously requires a greater dynamic range. This shows, that the slit width 2D is at the optimum when the slit width 2D coincides with the minimum half-pitch.

In addition, when the Fourier Transform is performed on equations (1) and (2), the frequency characteristic of the averaging effect by the slit is ascertained.

$$\begin{matrix}p ( u ) = {\int }_{∞}^{∞} p ( y ) \cdot exp ( - 2 π uy ) ⅆ y \\ = 2 D \frac{sin ( 2 π uD )}{2 π uD} = 2 D \frac{sin ( ω D )}{ω D}\end{matrix} \qquad ( 13 )$$

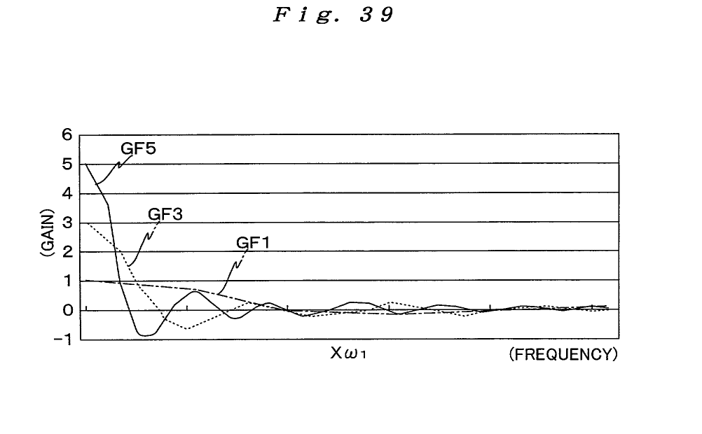

FIG. 39 shows the frequency characteristics when the slit width 2D is equal, three times, and five times the half-pitch of the limit of resolution, with ω₁ being the spacial frequency in the limit of resolution. In FIG. 39, the reference marks GF5, GF3, and GF1 respectively show the frequency characteristic line graph when the slit width is five times, three times, or equal to the minimum half-pitch. As is obvious from FIG. 39, from the aspect of stability in the gain, the slit width is at the optimum in the case the slit width coincides with the minimum half-pitch (GF1).

The Second Embodiment

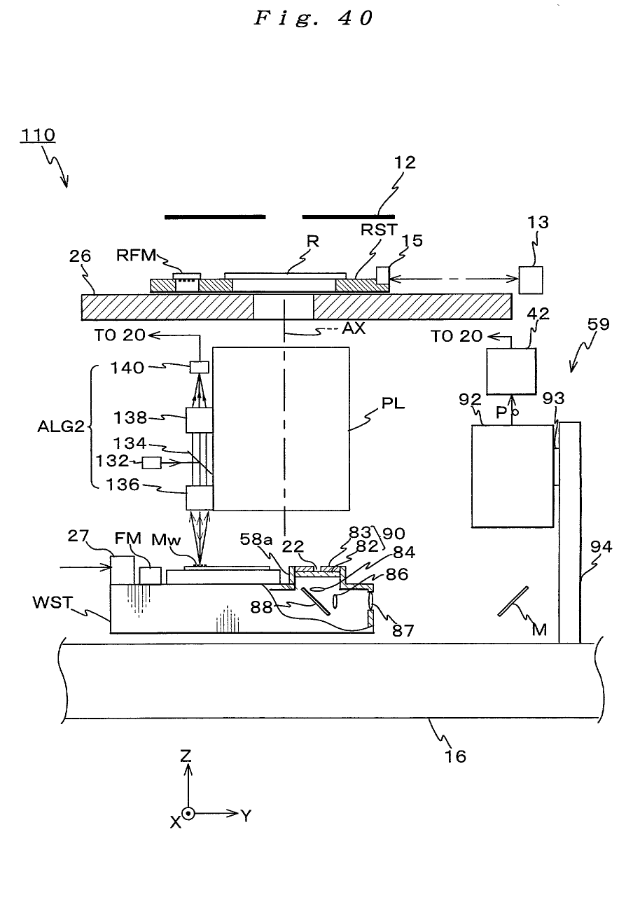

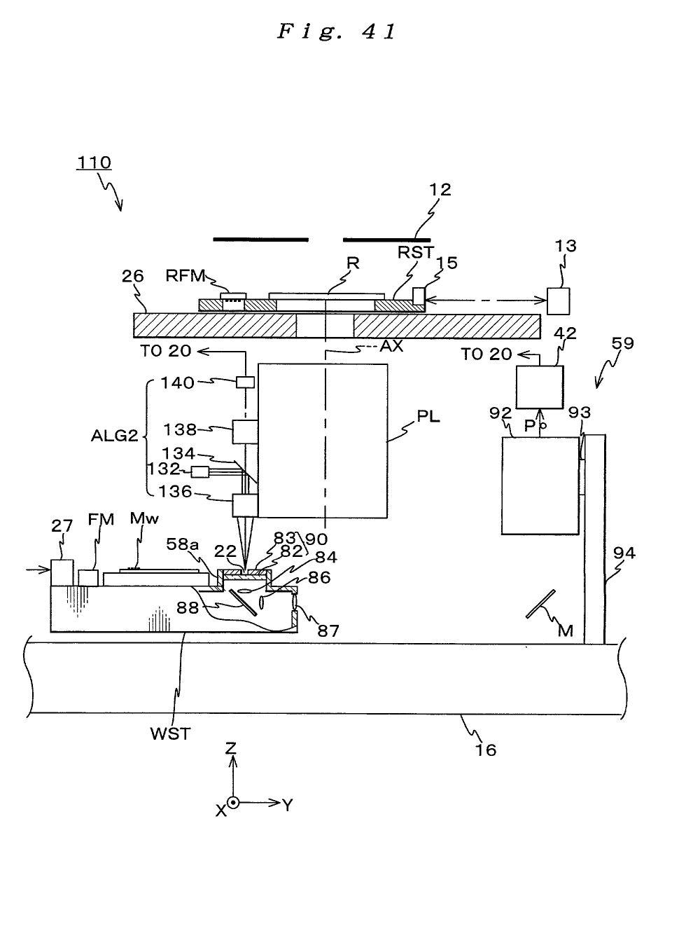

Next, the second embodiment related to the present invention will be described, based on FIG. 40 and FIG. 41. Structures and components that are identical or equivalent to the exposure apparatus 100 related to the first embodiment previously described, are designated with the same reference numerals, and the description thereabout is briefly made or is entirely omitted.

FIG. 40 shows the arrangement of an exposure apparatus related to the second embodiment, with a part of the arrangement omitted. The exposure apparatus 110 differs from the exposure apparatus 100 only on the point that the arrangement of the alignment system ALG2 serving as a mark detection system is different. Therefore, hereinafter, this difference will be mainly focused in this description.

As is shown in FIG. 40, the alignment system ALG2 is a laser scanning alignment sensor based on the off-axis method, arranged on the side surface of the projection optical system PL.

The alignment system ALG2, as is shown in FIG. 40, is structured including: an alignment light source 132; a half mirror 134; a first objective lens 136; a second objective lens 138; a silicon photodiode (SPD) 140, and the like. In this case, as the light source 132, a helium-neon laser is used. With the alignment system ALG2, as is shown in FIG. 40, the laser beam emitted from the light source 132 forms a laser beam spot to illuminate the alignment mark Mw on the wafer W via the half mirror 134 and the first object lens 136. The laser beam is normally fixed, and by scanning the wafer stage WST, the laser beam and the alignment mark MW are relatively scanned.

The scattered light generated from the alignment mark Mw is concentrated and photo-detected on the silicon photodiode SPD 140 via the first objective lens 136, the half mirror 134, and the second objective lens 138. A zero order optical filter is inserted in the alignment system ALG2 to create a darkfield, and the scattered light is detected only at the position where the alignment mark Mw is located. The light photo-detected by the SPD 140 is transformed into photoelectric conversion signals, which are sent to the main controller 20 from the SPD 140. And, based on the photoelectric conversion signals and the positional information of the wafer stage WST upon detection, which is the output of the wafer interferometer 31, the coordinate position of the alignment mark Mw is calculated, in the stage coordinate system that is set by the optical axes of the interferometer.

The baseline stability of such a stage scan type laser scanning alignment sensor is set by the stability of the beam position of the laser, the stability of interferometer, and the stability of the gain in the SPD-electric system.

The baseline measurement of the alignment system ALG2 will now be described. As a premise, the reticle R is to be mounted on the reticle stage RST.

First of all, likewise as is previously described, the main controller 20 measures the projected image of the reticle alignment mark (not shown in FIGS.) formed on the reticle R using the aerial image measurement unit 59, and obtains the projection position of the reticle pattern image. That is, the reticle alignment is performed.

Next, the main controller 20 moves the wafer stage WST, and as is shown in FIG. 41, scans the slit 22 of the aerial image measurement unit 59 with respect to the laser beam spot, simultaneously takes in the light intensity signal of the laser beam passing through the slit and the measurement values of the wafer interferometer 31, obtains the profile of the laser beam, and based on the profile, obtains the position of the beam spot. With this operation, the positional relation between the projection position of the pattern image of the reticle R and the laser spot irradiation position of the alignment system ALG2, that is, the baseline amount of the alignment system ALG2 is obtained.

According to the exposure apparatus 110 related to the second embodiment described so far, effects similar to the exposure apparatus 100 in the first embodiment described earlier can be obtained. Furthermore, in this case as well, the main controller 20 detects the baseline amount of the alignment system ALG2 using the aerial image measurement unit 59, and upon detecting the baseline amount, since the projection position of the reticle pattern image and the position of the alignment system ALG2 can be measured more directly by the aerial image measurement unit 59, measurement of the baseline amount becomes possible with high precision.

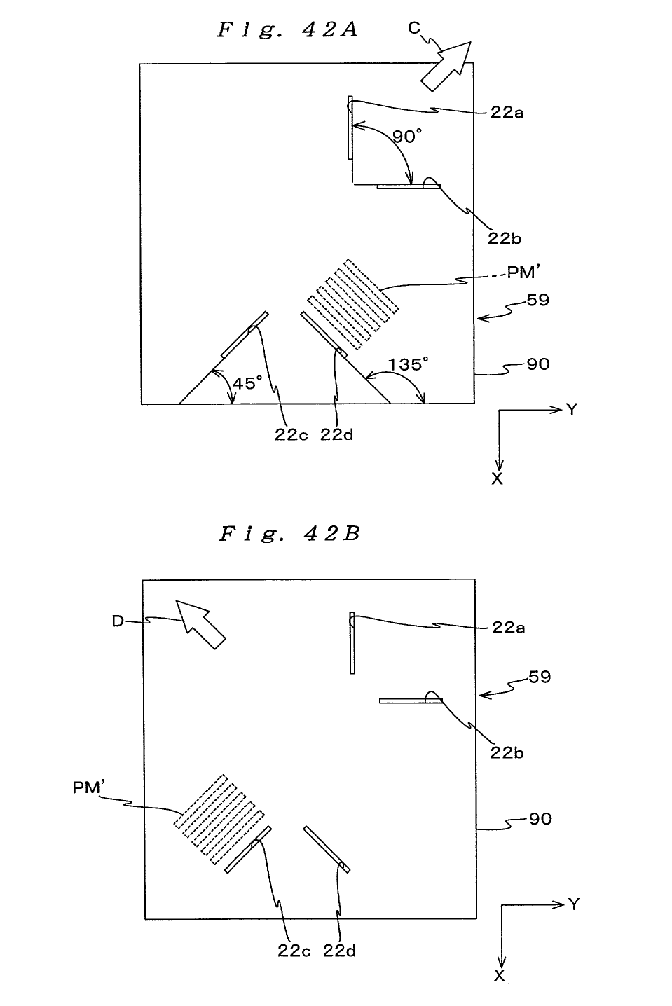

The arrangement of the slit on the slit plate 90 of the aerial image measurement unit 59 is not limited to those previously described. For example, as is shown in FIG. 42A, a set of slits 22c 22d respectively extending in the direction of 45° and 135° with respect to the X-axis, may be added to the set of slits 22a and 22b referred to earlier. As a matter of course, the slit width 2D, which is perpendicular to the longitudinal direction of the slits 22c and 22d, is set according to the same reference in the same size as the slits 22a and 22b.

In this case, as is shown in FIG. 42A, for example, when the slit 22d is scanned with respect to the aerial image PM′ in FIG. 42A while the aerial image measurement unit 59 is being scanned in the direction indicated by the arrow C, the light intensity signal corresponding to the aerial image can be detected with high precision. In addition, as is shown in FIG. 42B, for example, when the slit 22c is scanned with respect to the aerial image PM′ in FIG. 42B while the aerial image measurement unit 59 (wafer stage WST) is being scanned in the direction indicated by the arrow D, the light intensity signal corresponding to the aerial image can be detected with high precision.

In the case of arranging the two sets of slits (22a, 22b)(22c, 22d) described above on the slit plate 90, since these slits in the respective sets are arranged apart from one another to a certain extent, as the arrangement of the photodetection optical system and the optical sensor within the wafer stage WST, the arrangement may be employed where the slit in each set can be selectively chosen by an optical or an electrical selection mechanism. To be more specific, a photodetection system, which optical path can be changed with a shutter, and a single photoconversion element may be combined, or a photodetection system and a photoconversion element may be respectively provided in the slits of each set.

Following is a description on image recovery.

From the equations (1) and (2) previously described, by the averaging of the slit scan, when the Fourier Transform is performed on the p(y) the type of spectrum is clarified in terms of spacial frequency. This is generally referred to as the instrumental function P (u). The instrumental function is expressed by equation (13), referred to earlier.

The P_inv(u), as a filter with an inverse characteristic of the frequency characteristic in equation (13), is expressed as in the following equation (14), and when this is multiplied by the Fourier spectrum of the light intensity signal m(y) of the aerial image observed and then an inverse Fourier Transform performed, image recovery is thus performed.

P_{—}inv(u)=1/P(u) (14)

For a complete image recovery, since the upper limit of the optical transfer function (OTF) of the incoherent image forming is 2N.A./λ, the following equation (15) needs to be satisfied.

$$D < \frac{λ}{2 N . A .} \qquad ( 15 )$$

By using such a method of image recovery, it also becomes possible to recover an image profile having extremely thin isolated lines. Isolated lines include various frequency components, and when the aerial image of the isolated lines is measured at a plurality of focuses, measurement of the wavefront aberration of the lens can also be considered using these results.

In addition, by performing image recovery on the L/S mark, which is a repetition pattern, measurement of the wavefront aberration of the discrete frequency component of the lens can also be considered.

When aerial image measurement is performed upon these wavefront aberration measurements, it is preferable to use a unit, for example, like the aerial image measurement unit 59 in FIG. 42A, which is capable of aerial image measurement in the four directions shown in FIG. 42A.

In each embodiment above, the case has been described when the present invention is applied to a projection exposure apparatus based on the step-and-scan method. The present invention, however, is not limited to this, and can be suitably applied to an exposure apparatus of the step-and-repeat type, which transfers a mask pattern onto a substrate when both the mask and substrate are in a stationary state, and sequentially moves the mask with stepping operations.

In addition, in each embodiment above, the case has been described when the present invention is applied to an exposure apparatus used for manufacturing a semiconductor. The present invention, however, is not limited to this, and can be broadly applied to, for example, an exposure apparatus for liquid crystals to transfer a liquid crystal display device pattern onto a square-shaped glass plate, or an exposure apparatus to produce a thin-film magnetic head, a pick-up device, a micromachine, a DNA chip, and a reticle or a mask, and the like.

Also, in each embodiment above, the case has been described when the illumination light for exposure used, is a KrF excimer laser beam (248 nm), an ArF excimer laser beam (193 nm), or the like. The present invention, however, is not limited to this, and a g-line (436 nm), an i-line (365 nm), an F2 laser beam (157 m), a copper vapor laser, a harmonic such as a YAG laser, and the like may be used as the illumination light for exposure.

In addition, in each embodiment above, the case has been described when the projection optical system used is a reduction system and a refraction system. The present invention, however, is not limited to this, and a projection optical system of an equal magnification or a magnification system may be used, or any one of a refraction system, a reflection refraction system, or a reflection system may be used.

Also, in the case of using a linear motor (refer to U.S. Pat. No. 5,623,853, or the U.S. Pat. No. 5,528,118) for the wafer stage or the reticle stage, either of the air levitation type using air bearings or the magnetic levitation type using the Lorentz force or the reactance force may be used.

In addition, the stage may be a type that moves along a guide, or it may be a guideless type that does not require a guide.

The reaction force generated by the movement of the wafer stage may be released to the floor (ground) using a frame member, as is disclosed, for example, in Japanese Patent Laid Open No. 08-166475 and the corresponding U.S. Pat. No. 5,528,118. The disclosures cited above, are fully incorporated by reference herein.

And, the reaction force generated by the movement of the reticle stage may be released to the floor (ground) using a frame member, as is disclosed, for example, in Japanese Patent Laid Open No. 08-330224 and the corresponding U.S. Pat. No. 5,874,820. The disclosures cited above, are fully incorporated by reference herein.

The Making Method of the Exposure Apparatus

Next, the making method of the exposure apparatus 10 will be described.

On making the exposure apparatus 10, first of all, a plurality of lenses, an illumination optical system including optical elements such as a mirror, a projection optical system PL, a reticle stage system and a wafer stage system made up of various mechanical components, and the like are respectively built as units, and adjustment operations such as optical adjustment, mechanical adjustment, and electrical adjustment are performed so that the units respectively show the desired performance as a sole unit.

Next, the illumination optical system, the projection optical system PL, and the like are incorporated into the main body of the exposure apparatus, then the wafer stage system, the reticle stage system, and the like are assembled into the main body of the exposure apparatus and the wiring and piping connected.

Then further optical adjustment is performed on the illumination optical system and the projection optical system PL. This is because in these optical systems, especially in the projection optical system PL, the optical properties change subtly before and after the systems are assembled into the main body of the exposure apparatus. In this embodiment, on the optical adjustment of the projection optical system PL performed after the system is incorporated into the main body of the exposure apparatus, measurement of the optical properties of the projection optical system PL is performed in the procedure previously described, using the reticle mark plate RFM (or the measurement reticle). And, based on the measurement results of the optical properties, correction of the Seidel aberration and the like is performed, likewise with when the maintenance operation referred to earlier is performed. In addition, for example, the wavefront aberration of the projection optical system may be measured with the method previously described, and based on the measurement results, the assembly of the lenses and the like is re-adjusted, when necessary. In the case such as when the desired performance cannot be obtained by the re-adjustment, some of the lenses may require re-processing.

After these operations, total adjustment (electrical adjustment, operational adjustment) is further performed. With this adjustment, the exposure apparatus used in each embodiment above that transfers the pattern of the reticle R with high precision onto the wafer W, using the projection optical system PL which optical properties are adjusted with high precision, can be made. Incidentally, the exposure apparatus is preferably made in a clean room in which temperature, degree of cleanliness, and the like are controlled.

Device Manufacturing Method

A device manufacturing method using the exposure apparatus in each embodiment above in a lithographic process will be described next.

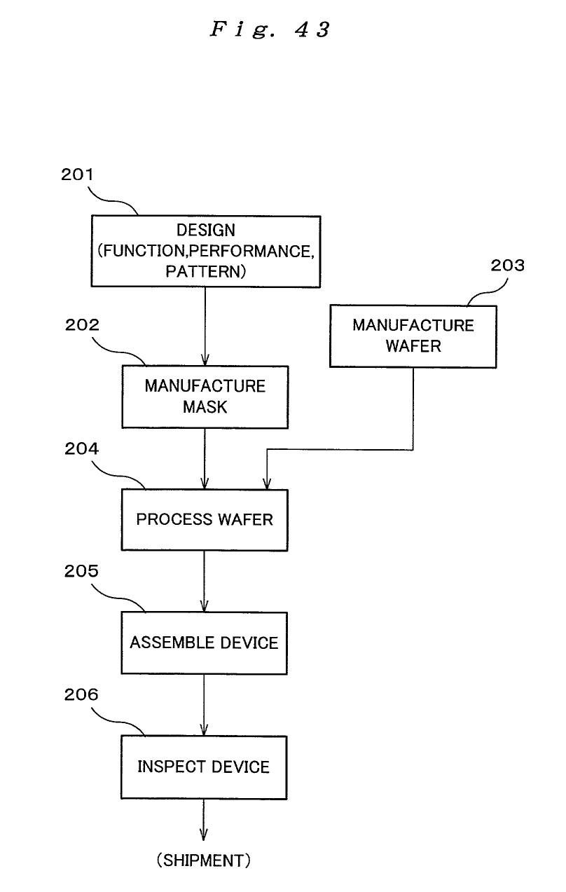

FIG. 43 is a flow chart showing an example of manufacturing a device (a semiconductor chip such as an IC or LSI, a liquid crystal panel, a CCD, a thin magnetic head, a micromachine, or the like). As shown in FIG. 43, in step 201 (design step), function/performance is designed for a device (e.g., circuit design for a semiconductor device) and a pattern to implement the function is designed. In step 202 (mask manufacturing step), a mask on which the designed circuit pattern is formed is manufactured. In step 203 (wafer manufacturing step), a wafer is manufacturing by using a silicon material or the like.

Next, in step 204 (wafer processing step), an actual circuit and the like is formed on the wafer by lithography or the like using the mask and wafer prepared in steps 201 to 203, as will be described later. Instep205 (device assembly step), a device is assembled using the wafer processed in step 204. In step 205, processes such as dicing, bonding, and packaging (chip encapsulation) are included, depending on the requirements.

Finally, in step 206 (inspection step), a test on the operation of the device, durability test, and the like are performed. After these steps, the device is completed and shipped out.

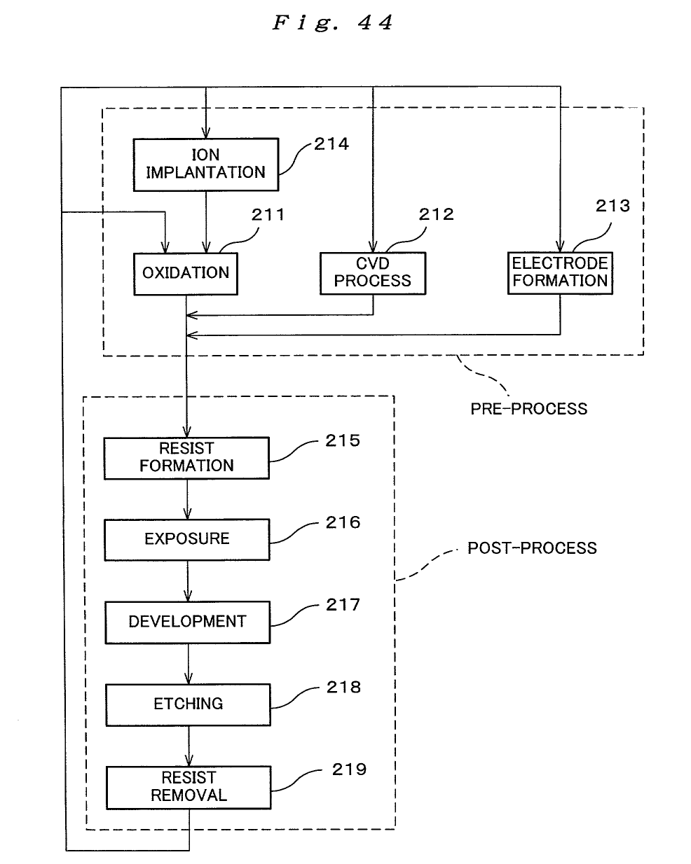

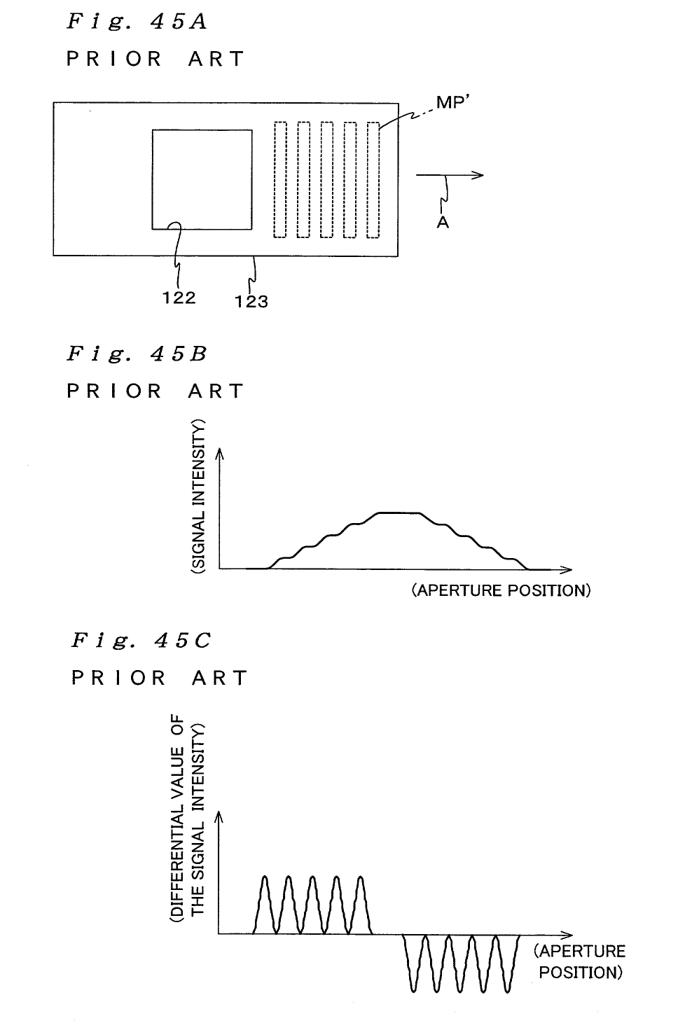

FIG. 44 is a flow chart showing a detailed example of step 204 described above in manufacturing the semiconductor device. Referring to FIG. 44, in step 211 (oxidation step), the surface of the wafer is oxidized. In step 212 (CVD step), an insulating film is formed on the wafer surface. In step 213 (electrode formation step), an electrode is formed on the wafer by vapor deposition. In step 214 (ion implantation step), ions are implanted into the wafer. Steps 211 to 214 described above constitute a pre-process for the respective steps in the wafer process and are selectively executed in accordance with the processing required in the respective steps.

When the above pre-process is completed in the respective steps in the wafer process, a post-process is executed as follows. In this post-process, first, in step 215 (resist formation step), the wafer is coated with a photosensitive agent. Next, as in step 216 (exposure step), the circuit pattern on the mask is transferred onto the wafer by the above exposure apparatus and method. In step 218 (etching step), an exposed member on a portion other than a portion where the resist is left is removed by etching. Finally, in step 219 (resist removing step), the unnecessary resist after the etching is removed.

By repeatedly performing these pre-process and post-process steps, multiple circuit patterns are formed on the wafer.

By using the device manufacturing method described so far in this embodiment, the exposure apparatus described in each embodiment above is to be used in the exposure process (step 216). Therefore, the pattern of the reticle can be transferred onto the wafer with good overlay accuracy, and becomes possible to improve the yield of the device. In addition, by using the reticle mark plate RFM on measuring the optical properties of the projection optical system, the work efficiency of the apparatus can be improved. Accordingly, improving the productivity (including yield) of the device with high integration becomes possible.

While the above-described embodiments of the present invention are the presently preferred embodiments thereof, those skilled in the art of lithography systems will readily recognize that numerous additions, modifications, and substitutions may be made to the above-described embodiments without departing from the spirit and scope thereof. It is intended that all such modifications, additions, and substitutions fall within the scope of the present invention, which is best defined by the claims appended below.

What is claimed is:

1. An aerial image measurement method to measure an aerial image of a predetermined mark formed by a projection optical system, said measurement method including:
illuminating said mark with an illumination light and forming an aerial image of said mark on an image plane via said projection optical system; and
scanning a pattern forming member, which has at least one slit-shaped aperture pattern extending in a first direction within a two dimensional plane perpendicular to an optical axis of said projection optical system which width perpendicular to said first direction within said two dimensional plane serving as a second direction is set in consideration of at least one of a wavelength λ of said illumination light and a numerical aperture N.A. of said projection optical system, in said second direction within a surface close to said image plane parallel to said two dimensional plane, and photo-electrically converting said illumination light having passed through said aperture pattern and obtaining a photoelectric conversion signal which corresponds to an intensity of said illumination light having passed through said aperture pattern.

2. The aerial image measurement method according to claim 1, wherein
said width of said aperture pattern in said second direction is set in consideration of both said wavelength λ of said illumination light and said numerical aperture N.A. of said projection optical system.

3. The aerial image measurement method according to claim 1, wherein
said width of said aperture pattern in said second direction is greater than zero, and equal to and under said wavelength λ of said illumination light divided by said numerical aperture N.A. of said projection optical system (λ/N.A.).

4. The aerial image measurement method according to claim 3, wherein
said width of said aperture pattern in said second direction is equal to and under said (λ/N.A.) multiplied by 0.8.

5. The aerial image measurement method according to claim 1, wherein
said width of said aperture pattern in said second direction is half a minimum pitch multiplied by an odd number, said minimum pitch being a pitch of a line and space pattern in a limit of resolution set by illumination conditions including properties of said illumination light and the type of said pattern.

6. The aerial image measurement method according to claim 1, wherein
when a wavelength of said illumination light is expressed as λ and a numerical aperture of said projection optical system is expressed as N.A, said width of said aperture pattern in said second direction is set as {λ/(2N.A.) } multiplied by an odd number.

7. The aerial image measurement method according to claim 1, said measurement method further including:
obtaining a spacial frequency distribution by performing a Fourier Transform on said photoelectric conversion signal;
converting said spacial frequency distribution into a spectrum distribution of its original aerial image by dividing said spacial frequency distribution with a frequency spectrum of said aperture pattern that is already known; and
recovering said original aerial image by performing an inverse Fourier Transform on said spectrum distribution.

8. An optical properties measurement method to measure optical properties of a projection optical system, said measurement method including:
illuminating a predetermined mark with an illumination light and forming an aerial image of said mark on an image plane via said projection optical system;
scanning a pattern forming member, which has at least one slit-shaped aperture pattern with a predetermined slit width extending in a first direction within a two dimensional plane perpendicular to an optical axis of said projection optical system, within a surface close to said image plane parallel to said two dimensional plane in a second direction which is perpendicular to said first direction, and photo-electrically converting said illumination light having passed through said aperture pattern and obtaining a photoelectric conversion signal which corresponds to an intensity of said illumination light having passed through said aperture pattern; and
obtaining optical properties of said projection optical system based on said photoelectric conversion signal.

9. The optical properties measurement method according to claim 8, wherein
said mark consists of a line and space mark that has a periodicity in a direction corresponding to said second direction,
detection of said photoelectric conversion signal is repeated a plurality of times while changing a position of said pattern forming member in a direction of said optical axis, and
a predetermined evaluation amount that changes in accordance with a position of said pattern forming member in a direction of said optical axis is obtained, based respectively on a plurality of photoelectric conversion signals obtained in said detection repeated, and a best focal position of said projection optical system is obtained based on a largeness of said evaluation amount.

10. The optical properties measurement method according to claim 9, wherein
said evaluation amount is a contrast which is an amplitude ratio of a first order frequency component and a zero order frequency component of respective signals obtained by performing Fourier Transform respectively on said plurality of photoelectric conversion signals, and
a best focal position is to be a position of said pattern forming member in a direction of said optical axis which corresponds to a photoelectric conversion signal with said contrast maximized.

11. The optical properties measurement method according to claim 9, wherein said method further includes detecting an image plane shape of said projection optical system by repeatedly performing detection of said best focal position on a plurality of points distanced differently from an optical axis of said projection optical system.

12. The optical properties measurement method according to claim 9, said measurement method further including:
performing detection of said best focal position along an optical axis of said projection optical system repeatedly on a plurality of line and space patterns having a different pitch, and
obtaining a spherical aberration of said projection optical system based on a difference of said best focal position corresponding to each of said line and space patterns.

13. The optical properties measurement method according to claim 8, wherein
forming of said aerial image and detection of said photoelectric conversion signal are repeatedly performed on an aerial image of said mark projected at different positions within an image field of said projection optical system, and
based on a plurality of photoelectric conversion signals obtained in said detection repeated, a position of an aerial image individually corresponding to said plurality of photoelectric conversion signals are respectively calculated, and at least one of a distortion and a magnification of said projection optical system is obtained based on said calculation results.

14. The optical properties measurement method according to claim 13, wherein said mark includes at least one rectangular pattern which width in said second direction is larger than a width of said aperture pattern in said second direction.

15. The optical properties measurement method according to claim 14, wherein a phase detection is performed so as to respectively detect a phase of said plurality of photoelectric conversion signals, and a position of each of said aerial images is calculated based on a result of said phase detection.

16. The optical properties measurement method according to claim 14, wherein a position of each of said aerial images is calculated based on an intersection point of each of said plurality of photoelectric conversion signals and a predetermined slice level.

17. The optical properties measurement method according to claim 13, wherein said mark is a rectangular shape as a whole, and consists of a line and space pattern having a periodicity in said first direction.

18. The optical properties measurement method according to claim 17, wherein a position of each of said aerial images is calculated based on an intersection point of said plurality of photoelectric conversion signals respectively and a predetermined slice level.

19. The optical properties measurement method according to claim 8, wherein
said mark consists of a line and space pattern having a periodicity in a direction corresponding to said second direction, and
a coma of said projection optical system is obtained based on said photoelectric conversion signals.

20. The optical properties measurement method according to claim 19, wherein said coma is calculated based on a calculation result, said calculation result on an abnormal line width value of each line pattern based on an intersection point of said photoelectric conversion signals and a predetermined slice level.

21. The optical properties measurement method according to claim 19, wherein said coma is calculated based on a calculation result, said calculation result on a phase difference between a first fundamental frequency component of said photoelectric conversion signals corresponding to a pitch of each said line and space pattern and a second fundamental frequency component of said photoelectric conversion signals corresponding to an entire width of said line and space pattern.

22. The optical properties measurement method according to claim 8, wherein
said mark is a symmetric mark having at least two types of a line pattern with a different line width arranged in a predetermined interval in a direction corresponding to said second direction, and
a coma of said projection optical system is obtained based on a calculation result, said calculation result on a deviation of symmetry of an aerial image of said mark calculated based on an intersection point of said photoelectric conversion signals and a predetermined slice level.

23. The optical properties measurement method according to claim 8, wherein a width of said aperture pattern in said second direction is set in consideration of at least one of a wavelength λ of said illumination light and a numerical aperture N.A of said projection optical system.

24. An optical properties measurement method to measure optical properties of a projection optical system, said measurement method including:
illuminating a first mark in a state where said first mark is positioned at a first detection point within an effective field of said optical projection system to form an aerial image of said first mark, and measuring a light intensity distribution corresponding to said aerial image by relatively scanning a measurement pattern with respect to said aerial image of said first mark at a first position related to an optical axis direction of said projection optical system and photo-electrically converting light via said measurement pattern;
illuminating a second mark in a state where said second mark is positioned at a second detection point within an effective field of said optical projection system to form an aerial image of said second mark, and measuring a light intensity distribution corresponding to said aerial image by relatively scanning said measurement pattern with respect to said aerial image of said second mark at second position related to an optical axis direction of said projection optical system and photo-electrically converting light via said measurement pattern; and
obtaining a positional relationship between a first image forming position of said aerial image of said first mark within a plane perpendicular to said optical axis obtained by a result of said measurement of said aerial image of said first mark when said measurement pattern is at said first position of said optical axis and a second image forming position of said aerial image of said second mark within a plane perpendicular to said optical axis obtained by a result of said measurement of said aerial image of said second mark when said measurement pattern is at said second position of said optical axis, and calculating a telecentricity of said projection optical system based on said positional relationship.

24. The optical properties measurement method according to claim 23, wherein said first mark and said second mark are the same.

25. The optical properties measurement method according to claim 23, wherein said measurement pattern is an aperture pattern which width in said scanning direction is set in consideration of at least one of a wavelength λ of said illumination light and a numerical aperture N.A of said projection optical system.

26. An aerial image measurement unit that measures an aerial image of a predetermined mark formed by a projection optical system, said measurement unit comprising:
an illumination unit which illuminates said mark to form an aerial image of said mark onto an image plane via said projection optical system;
a pattern forming member, which has at least one slit-shaped aperture pattern extending in a first direction within a two dimensional plane perpendicular to an optical axis of said projection optical system which width in a second direction being perpendicular to said first direction is greater than zero, and equal to and under said wavelength λ of said illumination light divided by said numerical aperture N.A. of said projection optical system (λ/N.A.);
a photoelectric conversion element which photo-electrically converts said illumination light having passed through said aperture pattern, and outputs a photoelectric conversion signal corresponding to an intensity of said illumination light; and
a processing unit which scans said pattern forming member in said second direction within a surface parallel to said two dimensional plane in the vicinity of said image plane in a state where said mark is illuminated by said illumination unit and said aerial image is formed on said image plane, and measures a light intensity distribution corresponding to said aerial image based on said photoelectric conversion signal output from said photoelectric conversion element.

27. An optical properties measurement unit that measures optical properties of a projection optical system, which projects a pattern on a first surface onto a second surface, said unit comprising;
an aerial image measurement unit according to claim 26; and
a calculation unit which calculates said optical properties of said projection optical system based on a photodetection conversion signal obtained upon measurement of a light intensity distribution by said aerial image measurement unit.

28. An exposure apparatus that transfers a circuit pattern formed on a mask onto a substrate via a projection optical system, said exposure apparatus comprising:
a substrate stage which holds said substrate; and
an aerial image measurement unit according to claim 26 which has an arrangement of said pattern forming member being integrally movable with said substrate stage.

29. The exposure apparatus according to claim 28, wherein said exposure apparatus further comprises a control unit which measures a light intensity distribution corresponding to aerial images of various mark patterns using said aerial image measurement unit and obtains optical properties of said projection optical system based on data of said light intensity distribution measured.

30. The exposure apparatus according to claim 28, said exposure apparatus further comprising:
a mark detection system which detects a position of a mark on said substrate stage; and
a control unit which detects a positional relationship between a projected position of said mask pattern by said projection optical system and said mark detection system using said aerial image measurement unit.

31. An exposure apparatus that illuminates a predetermined pattern with an illumination light to transfer said pattern onto a substrate via a projection optical system, said exposure apparatus comprising:
a self-measurement master on which a plurality of types of measurement marks used for self-measurement are formed; and
a self-measurement master mounting stage on which said self measurement master is mounted, and which can move said self-measurement master close to a focal position on an object side of said projection optical system where said illumination light can illuminate.

32. The exposure apparatus according to claim 31, said exposure apparatus further comprising:
an aerial measurement unit that includes a pattern forming member arranged within a two dimensional plane perpendicular to an optical axis of said projection optical system on which a measurement pattern is formed and a photoelectric conversion element which photo-electrically converts said illumination light via said measurement pattern; and
a driving unit which drives at least one of said self-measurement master mounting stage and said pattern forming member when at least a part of said self-measurement master is illuminated by said illumination light and an aerial image of said measurement mark illuminated by said illumination light is formed in a vicinity of a. focal position on an image side of said projection optical system by said projection optical system, so that said aerial image and said measurement pattern are relatively scanned.

33. The exposure apparatus according to claim 32, wherein said measurement pattern includes at least one slit-shaped aperture pattern which width in a direction of said relative scanning is greater than zero, and equal to and under said wavelength λ of said illumination light divided by said numerical aperture N.A. of said projection optical system (λ/N.A.).

34. The exposure apparatus according to claim 31, wherein said self-measurement master mounting stage is a mask stage on which a mask having said predetermined pattern formed is mounted.

35. The exposure apparatus according to claim 34, said exposure apparatus further comprising:
a substrate stage where said substrate is mounted and a reference mark is provided;
an observation microscope to observe a mark located on said mask stage; and
a control unit which performs aerial image measurement of a measurement mark on said self-measurement master using said self-measurement master, said aerial image measurement unit, and said driving unit and calculates a magnification of said projection optical system based on said aerial image measurement on exposing a first substrate of each lot, whereas on exposing a substrate besides said first substrate of each lot, said control unit observes a mark on one of said self-measurement master and said mask and an image of a reference mark on said substrate stage via said projection optical system using said observation microscope and calculates a magnification of said projection optical system based on a result of said observation, when said substrate is exposed by lot.

36. The exposure apparatus according to claim 31, wherein said self-measurement master is a mask on which said predetermined pattern is formed.

37. The exposure apparatus according to claim 31, wherein measurement marks formed on said self-measurement master include at least one of a distortion measurement mark of said projection optical system, a repetition mark for best focus measurement, an artificial isolated line mark for best focus measurement, an alignment mark for overlay error measurement with said substrate.

38. The exposure apparatus according to claim 31, wherein measurement marks formed on said self-measurement master include an isolated line mark and a line and space mark having a predetermined pitch.

39. An adjustment method of a projection optical system that projects a pattern on a first surface onto a second surface, said adjustment method including:
measuring optical properties of said projection optical system by an optical properties measurement method according to claim 8; and
adjusting said projection optical system based on a result of said measurement.

40. An exposure method to transfer a pattern formed on a mask onto a substrate via a projection optical system, said exposure method including:
adjusting said projection optical system by an adjustment method of a projection optical system according to claim 39; and
transferring said pattern onto said substrate using said projection optical system which optical properties have been adjusted.

41. A making method of an exposure apparatus that transfers a pattern formed on a mask onto a substrate via a projection optical system, said making method including:
measuring optical properties of said projection optical system by an optical properties measurement method according to claim 8; and
adjusting said projection optical system based on a result of said measurement.

42. A device manufacturing method including a lithographic process, wherein exposure is performed using said exposure apparatus according to claim 28 in said lithographic process.

43. A device manufacturing method including a lithographic process, wherein exposure is performed using said exposure apparatus according to claim 31 in said lithographic process.
